SEQUENCE LISTING (30 sequences)

SEQ ID NO: 1 - DNA, 667 bp, Trichoderma reesei
cacattcactcaactcctctttctcaactctccaaacacaaacattctttgttgaataccaaccatcaccacctttcaagatgcagttcttcgccgtcgccctcttcgccaccagcgccctggctgctgtctgccctaccggcctcttctccaaccctctgtgctgtgccaccaacgtcctcgacctcattggcgttgactgcaagacccgtatgttgaattccaatctctgggcatcctgacattggacgatacagttgacttacacgatgctttacagctaccatcgccgtcgacactggcgccatcttccaggctcactgtgccagcaagggctccaagcctctttgctgcgttgctcccgtggtaagtagtgctcgcaatggcaaagaagtaaaaagacatttgggcctgggatcgctaactcttgatatcaaggccgaccaggctctcctgtgccagaaggccatcggcaccttctaaagcaatggcttgctttactgccggcagtctttgagaactctgggctcacaaaagacgacttgcatgtatcatgggggctcgcaaatgggaggatttggaggggattgaggctgggtttggcctattagaggattgcataatggaagatttgcgagcaggacatagacgtatctagagttctagt

SEQ ID NO: 2 - protein, 86 aa, Trichoderma reesei
MQFFAVALFATSALAAVCPTGLFSNPLCCATNVLDLIGVDCKTPTIAVDTGAIFQAHCASKGSKPLCCVAPVADQALLCQKAIGTF

SEQ ID NO: 3 - DNA, 2868 bp, Trichoderma reesei
tttgtatggctggatctcgaaaggcccttgtcatcgccaagcgtggctaatatcgaatgagggacaccgagttgcatatctcctgatcattcaaacgacaagtgtgaggtaggcaatcctcgtatcccattgctgggctgaaagcttcacacgtatcgcataagcgtctccaaccagtgcttaggtgacccttaaggatacttacagtaagactgtattaagtcagtcactctttcactcgggctttgaatacgatcctcaatactcccgataacagtaagaggatgatacagcctgcagttggcaaatgtaagcgtaattaaactcagctgaacggcccttgttgaaagtctctctcgatcaaagcaaagctatccacagacaagggttaagcaggctcactcttcctacgccttggatatgcagcttggccagcatcgcgcatggccaatgatgcacccttcacggcccaacggatctcccgttaaactcccctgtaacttggcatcactcatctgtgatcccaacagactgagttgggggctgcggctggcggatgtcggagcaaaggatcacttcaagagcccagatccggttggtccattgccaatggatctagattcggcaccttgatctcgatcactgagacatggtgagttgcccggacgcaccacaactccccctgtgtcattgagtccccatatgcgtcttctcagcgtgcaactctgagacggattagtcctcacgatgaaattaacttccagcttaagttcgtagccttgaatgagtgaagaaatttcaaaaacaaactgagtagaggtcttgagcagctggggtggtacgcccctcctcgactcttgggacatcgtacggcagagaatcaacggattcacacctttgggtcgagatgagctgatctcgacagatacgtgcttcaccacagctgcagctacctttgcccaaccattgcgttccaggatcttgatctacatcaccgcagcacccgagccaggacggagagaacaatccggccacagagcagcaccgccttccaactctgctcctggcaacgtcacacaacctgatattagatatccacctgggtgattgccattgcagagaggtggcagttggtgataccgactggccatgcaagacgcggccgggctagctgaaatgtccccgagaggacaattgggagcgtctatgacggcgtggagacgacgggaaaggactcagccgtcatgttgtgttgccaatttgagattgttgaccgggaaaggggggacgaagaggatggctgggtgaggtggtattgggaggatgcatcattcgactcagtgagcgatgtagagctccaagaatataaatatcccttctctgtcttctcaaaatctccttccatcttgtccttcatcagcaccagagccagcctgaacacctccagtcaacttcccttaccagtacatctgaatcaacatccattctttgaaatctcaccacaaccaccatcttcttcaaaatgaagttcttcgccatcgccgctctctttgccgccgctgccgttgcccagcctctcgaggaccgcagcaacggcaacggcaatgtttgccctcccggcctcttcagcaacccccagtgctgtgccacccaagtccttggcctcatcggccttgactgcaaagtccgtaagttgagccataacataagaatcctcttgacggaaatatgccttctcactcctttacccctgaacagcctcccagaacgtttacgacggcaccgacttccgcaacgtctgcgccaaaaccggcgcccagcctctctgctgcgtggcccccgttgtaagttgatgccccagctcaagctccagtctttggcaaacccattctgacacccagactgcaggccggccaggctcttctgtgccagaccgccgtcggtgcttgagatgcccgcccggggtcaaggtgtgcccgtgagaaagcccacaaagtgttgatgaggaccatttccggtactgggaaagttggctccacgtgtttgggcaggtttgggcaagttgtgtagatattccattcgtacgccattcttattctccaatatttcagtacacttttcttcataaatcaaaaagactgctattctctttgtgacatgccggaagggaacaattgctcttggtctctgttatttgcaagtaggagtgggagattcgccttagagaaagtagagaagctgtgcttgaccgtggtgtgactcgacgaggatggactgagagtgttaggattaggtcgaacgttgaagtgtatacaggatcgtctggcaacccacggatcctatgacttgatgcaatggtgaagatgaatgacagtgtaagaggaaaaggaaatgtccgccttcagctgatatccacgccaatgatacagcgatatacctccaatatctgtgggaacgagacatgacatatttgtgggaacaacttcaaacagcgagccaagacctcaatatgcacatccaaagccaaacattggcaagacgagagacagtcacattgtcgtcgaaagatggcatcgtacccaaatcatcagctctcattatcgcctaaaccacagattgtttgccgtcccccaactccaaaacgttactacaaaagacatgggcgaatgcaaagacctgaaagcaaaccctttttgcgactcaattccctcctttgtcctcggaatgatgatccttcaccaagtaaaagaaaaagaagattgagataatacatgaaaagcacaacggaaacgaaagaaccaggaaaagaataaatctatcacgcaccttgtccccacactaaaagcaacagggggggtaaaatgaaat

SEQ ID NO: 4 - protein, 97 aa, Trichoderma reesei
MKFFAIAALFAAAAVAQPLEDRSNGNGNVCPPGLFSNPQCCATQVLGLIGLDCKVPSQNVYDGTDFRNVCAKTGAQPLCCVAPVAGQALLCQTAVGA

SEQ ID NO: 5 - DNA, 945 bp, Schizophyllum commune
agtcgaacaccccagttcaactaccccagcccttccttccttcgctatccttccttacaacctgctcgccatgttcgcccgtctccccgtcgtgttcctctacgccttcgtcgcgttcggcgccctcgtcgctgccctcccaggtggccacccgggcacgacgtacgtcgacctctcaccgtcctctaatgtcttgctgatgaagccccgtatagcacgccgccggttacgacgacggtgacggtgaccacggtgagtagctttctcgccgtcgacgactcgaacgcattggctaatttttgctcatagccgccctcgacgacgaccatcgccgccggtggcacgtgtactacggggtcgctctcttgctgcaaccaggttcaatcggtacgtacatcaaagcggcacgaccaggcatctcagctgacggccacatcgtacaggcgagcagcagccctgttaccgccctcctcggcctgctcggcattgtcctcagcgacctcaacgttctcgttggcatcagctgctctcccctcactgtgagatctttttgttcactgtcccaattactgcgcactgacagactttgccaggtcatcggtgtcggaggcagcggctgttcggcgcagaccgtctgctgcgaaaacacccaattcgtatgtatactttccatgcgtgtccctttctccgctaatcatctgtagaacgggctgatcaacatcggttgcacccccatcaacatcctctgagcaggtgaacgcgcctgtcggtgggatattcgggcgacgggagcctcgggcaatctgagcctcgttactgcctagcaaattcggaatcccttcgatgtcatagggtcgcggacaagtgatcgtcttgctacatactccaaggtgttgactcattccctcagataatgaacattgttgttgttgttgtttgttctct

SEQ ID NO: 6 - protein, 136 aa, Schizophyllum commune
MFARLPVVFLYAFVAFGALVAALPGGHPGTTTPPVTTTVTVTTPPSTTTIAAGGTCTTGSLSCCNQVQSASSSPVTALLGLLGIVLSDLNVLVGISCSPLTVIGVGGSGCSAQTVCCENTQFNGLINIGCTPINIL

SEQ ID NO: 7 - DNA, 776 bp, Neurospora crassa
atcatcagcatcaacatcttcacttcacaacatcttctcaaccttccaactcaccttccaaaccaccttcaaaaccaactcccagcttctttcagcaaacccccaaccgccaaaatgcagttcaccagcgtcttcaccatcctcgccattgccatgaccgccgctgcggccccggctgaggttgttccccgcgccaccaccatcggccccaacacctgctccatcgacgactacaagccttactgctgccagtctatgtccggccccgccggctcccctggtctcctcaacctcatccccgtcgacctcagcgcctcgctcggctgcgttgtcggtgtcatcggctcccaatgtggtgccagcgtcaagtgctgcaaggacgatgttaccaacaccggcaactccttcctcatcatcaacgctgccaactgcgttgcctaagtgtttacgcggcaacagcgcaaagtctaggcaatgccttgttctcaacgctgctgccagtccagcaccccccttctgcagcaaggagcccccttctgctggactggcagcacaacgagctgctactacaacacaagcatcatgcctggacgcaacagaagccgataatcttggggtttggttttgggggatgaaggtgatgagttgatggattggatcgatatcttacaatgcgtgtctcttcctgttaagatctgctttactattttcctattttcttttacacatagctatgtatcactaaggcctggtgattaatacactctcttaaccct

SEQ ID NO: 8 - protein, 108 aa, Neurospora crassa
MQFTSVFTILAIAMTAAAAPAEVVPRATTIGPNTCSIDDYKPYCCQSMSGPAGSPGLLNLIPVDLSASLGCVVGVIGSQCGASVKCCKDDVTNTGNSFLIINAANCVA

SEQ ID NO: 9 - DNA, 453 bp, Talaromyces thermophilus
atgaagttcgccggtgtcttgcttgctgtcgccgctgcggcgactgccctgccaaacgtcggtcccagtgggaagacggctcacaagccgcaccaggagcctttctggcctgtgcagcaggacgtgaccgtggaacaggccaaggctatctgtggtgaaggcaaccaggtcgcttgctgcaacgaggtcagctacgcgggcgacaccaccgaaatcgcgaccggccccctggctggcaccctcaaggacctgctcggcggcaagaacggcgccaagggcctgggtctcttcgacaagtgctcgcgtctcaatgtcgatctcctgcttggcctgtcgagcctcatcaaccaagaatgcaagcagcacattgcctgctgccagggcaacgaggccgattcctccaacgacctcatcggtctcaacattccttgcattgcccttggctcgctgctg

SEQ ID NO: 10 - protein, 151 aa, Talaromyces thermophilus
MKFAGVLLAVAAAATALPNVGPSGKTAHKPHQEPFWPVQQDVTVEQAKAICGEGNQVACCNEVSYAGDTTEIATGPLAGTLKDLLGGKNGAKGLGLFDKCSRLNVDLLLGLSSLINQECKQHIACCQGNEADSSNDLIGLNIPCIALGSLL

SEQ ID NO: 11 - protein, 269 aa, Artificial Sequence
  Mature amino acid sequence of Lipex
EVSQDLFNQFNLFAQYSAAAYCGKNNDAPAGTNITCTGNACPEVEKADATFLYSFEDSGVGDVTGFLALDNTNKLIVLSFRGSRSIENWIGNLNFDLKEINDICSGCRGHDGFTSSWRSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVPVRRRDIVKIEGIDATGGNNQPNIPDIPAHLWYFGLIGTCL

SEQ ID NO: 12 - protein, 289 aa, Streptomyces pristinaespiralis
MLPWKRALRPLSALMLAVAVALTPAATATADTTTAAPSSGWNDYDCKPSAAHPRPVVLVHGTLGNSVDNWLVLAPYLVKRGYCVFSLDYGQLPGVPFFHGLGPVDKSAEQLDAYVDKVLAATGAPEADIVGHSQGGMMPRYYLKFLGGAAKVNALVGIAPSNHGTDLNGFTALLPYFPGAADLLGRHTPALADQVTGSAFLTRLNADGDTVAGVRYTVIATRYDEVVTPWRSQYLSGPNVRNVLLQDLCPLDLSEHVAIGVFDLIAYHEVANALDPAHATPTTCASVFG

SEQ ID NO: 13 - protein, 275 aa, Fusarium heterosporum
AVGVTSTDFTNFKFYIQHGAAAYCNSGTAAGAKITCSNNGCPTIESNGVTVVASFTGSKTGIGGYVSTDSSRKEIVVAIRGSSNIRNWLTNLDFDQSDCSLVSGCGVHSGFQNAWAEISAQASAAVAKARKANPSFKVVATGHSLGGAVATLSAANLRAAGTPVDIYTYGAPRVGNAALSAFISNQAGGEFRVTHDKDPVPRLPPLIFGYRHTTPEYWLSGGGGDKVDYAISDVKVCEGAANLMCNGGTLGLDIDAHLHYFQATDACNAGGFSWR

SEQ ID NO: 14 - protein, 270 aa, Artificial Sequence
  Mature amino acid sequence of Lipase 3
SVSTSTLDELQLFAQWSAAAYCSNNIDSKDSNLTCTANACPSVEEASTTMLLEFDLTNDFGGTAGFLAADNTNKRLVVAFRGSSTIENWIANLDFILEDNDDLCTGCKVHTGFWKAWESAADELTSKIKSAMSTYSGYTLYFTGHSLGGALATLGATVLRNDGYSVELYTYGCPRIGNYALAEHITSQGSGANFRVTHLNDIVPRVPPMDFGFSQPSPEYWITSGNGASVTASDIEVIEGINSTAGNAGEATVSVVAHLWYFFAISECLL

SEQ ID NO: 15 - protein, 243 aa, Artificial Sequence
  Mature amino acid sequence of Lipomax
VYITEVSQLNTSELRGEELLEQVEEIAAISGKGKVNLVGHSHGGPTVRYVAAVRPDLVASVTSVGAPHKGSDTADFIRQIPPGSAGEAIVAGIVNGLGALINFLSGSSSTSPQNALGALESLNSEGAAAFNAKYPQGIPTSACGEGAYKVNGVSYYSWSGTSPLTNVLDVSDLLLGASSLTFDEPNDGLVGRCSSHLGKVIRDDYRMNHLDEVNQTFGLTSLFETDPVTVYRQQANRLKLAGL

SEQ ID NO: 16 - protein, 261 aa, Artificial Sequence
  Mature amino acid sequence of TfuLip2
ANPYERGPNPTDALLEASSGPFSVSEENVSRLSASGFGGGTIYYPRENNTYGAVAISPGYTGTEASIAWLGERIASHGFVVITIDTITTLDQPDSRAEQLNAALNHMINRASSTVRSRIDSSRLAVMGHSMGGGGTLRLASQRPDLKAAIPLTPWHLNKNWSSVTVPTLIIGADLDTIAPVATHAKPFYNSLPSSISKAYLELDGATHFAPNIPNKIIGKYSVAWLKRFVDNDTRYTQFLCPGPRDGLFGEVEEYRSTCPF

SEQ ID NO: 17 - protein, 259 aa, Streptomyces pristinaespiralis
DTTTAAPSSGWNDYDCKPSAAHPRPVVLVHGTLGNSVDNWLVLAPYLVKRGYCVFSLDYGQLPGVPFFHGLGPVDKSAEQLDAYVDKVLAATGAPEADIVGHSQGGMMPRYYLKFLGGAAKVNALVGIAPSNHGTDLNGFTALLPYFPGAADLLGRHTPALADQVTGSAFLTRLNADGDTVAGVRYTVIATRYDEVVTPWRSQYLSGPNVRNVLLQDLCPLDLSEHVAIGVFDLIAYHEVANALDPAHATPTTCASVFG

SEQ ID NO: 18 - protein, 291 aa, Artificial Sequence
  Full amino acid sequence of Lipex
MRSSLVLFFVSAWTALASPIRREVSQDLFNQFNLFAQYSAAAYCGKNNDAPAGTNITCTGNACPEVEKADATFLYSFEDSGVGDVTGFLALDNTNKLIVLSFRGSRSIENWIGNLNFDLKEINDICSGCRGHDGFTSSWRSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVPVRRRDIVKIEGIDATGGNNQPNIPDIPAHLWYFGLIGTCL

SEQ ID NO: 19 - protein, 313 aa, Artificial Sequence
  Full amino acid sequence of Lipomax
MNNKKTLLALCIGSSLLLSGPAEAGLFGSTGYTKTKYPIVLTHGLLGFDSILGVDYWYGIPSSLRSDGASVYITEVSQLNTSELRGEELLEQVEEIAAISGKGKVNLVGHSHGGPTVRYVAAVRPDLVASVTSVGAPHKGSDTADFIRQIPPGSAGEAIVAGIVNGLGALINFLSGSSSTSPQNALGALESLNSEGAAAFNAKYPQGIPTSACGEGAYKVNGVSYYSWSGTSPLTNVLDVSDLLLGASSLTFDEPNDGLVGRCSSHLGKVIRDDYRMNHLDEVNQTFGLTSLFETDPVTVYRQQANRLKLAGL

SEQ ID NO: 20 - protein, 301 aa, Artificial Sequence
  Full amino acid sequence of TfuLip2
MAVMTPRRERSSLLSRALQVTAAAATALVTAVSLAAPAHAANPYERGPNPTDALLEASSGPFSVSEENVSRLSASGFGGGTIYYPRENNTYGAVAISPGYTGTEASIAWLGERIASHGFVVITIDTITTLDQPDSRAEQLNAALNHMINRASSTVRSRIDSSRLAVMGHSMGGGGTLRLASQRPDLKAAIPLTPWHLNKNWSSVTVPTLIIGADLDTIAPVATHAKPFYNSLPSSISKAYLELDGATHFAPNIPNKIIGKYSVAWLKRFVDNDTRYTQFLCPGPRDGLFGEVEEYRSTCPF

SEQ ID NO: 21 - protein, 279 aa, Fusarium heterosporum
EAEAAVGVTSTDFTNFKFYIQHGAAAYCNSGTAAGAKITCSNNGCPTIESNGVTVVASFTGSKTGIGGYVSTDSSRKEIVVAIRGSSNIRNWLTNLDFDQSDCSLVSGCGVHSGFQNAWAEISAQASAAVAKARKANPSFKVVATGHSLGGAVATLSAANLRAAGTPVDIYTYGAPRVGNAALSAFISNQAGGEFRVTHDKDPVPRLPPLIFGYRHTTPEYWLSGGGGDKVDYAISDVKVCEGAANLMCNGGTLGLDIDAHLHYFQATDACNAGGFSWR

SEQ ID NO: 22 - DNA, 777 bp, Artificial Sequence
  Synthetic SprLip2 gene
gacaccacgaccgcggcaccctcctcgggctggaacgactacgactgcaagccgtccgccgcgcacccccgccccgtggtcctcgtccacggcacgctcggcaacagcgtggacaactggctggtcctggccccgtacctcgtcaagcgcggctactgcgtgttctccctggactacggccagctgccgggcgtgcccttcttccacggcctgggcccggtggacaagagcgccgagcagctggacgcctacgtggacaaggtgctcgccgccaccggcgccccggaggcggacatcgtcgggcactcgcaggggggcatgatgccccggtactacctgaagttcctcggcggggcggccaaggtcaacgccctggtgggcatcgccccctcgaaccacgggacggacctcaacggcttcaccgccctcctgccgtacttcccgggcgccgccgacctcctcggccggcacaccccggcgctggccgaccaggtcaccgggagcgcgttcctgacccgcctgaacgcggacggcgacacggtcgcgggggtccgctacaccgtcatcgccacgcgctacgacgaggtcgtcaccccctggcggtcccagtacctgagcggcccgaacgtccggaacgtgctgctccaggacctgtgccccctcgacttgagcgaacacgtggccatcggcgtgttcgacctcatcgcataccacgaggtcgccaacgccctggacccggcgcacgccacccccacgacctgcgcgtccgtcttcggc

SEQ ID NO: 23 - DNA, 915 bp, Artificial Sequence
  SprLip2 gene from expression plasmid pZQ205
atgggctttgggagcgctcccatcgcgttgtgtccgcttcgcacgaggaggaacgctttgaaacgccttttggccctgctcgcgaccggcgtgtcgatcgtcggcctgactgcgctagccggccccccggcacaggccgacaccacgaccgcggcaccctcctcgggctggaacgactacgactgcaagccgtccgccgcgcacccccgccccgtggtcctcgtccacggcacgctcggcaacagcgtggacaactggctggtcctggccccgtacctcgtcaagcgcggctactgcgtgttctccctggactacggccagctgccgggcgtgcccttcttccacggcctgggcccggtggacaagagcgccgagcagctggacgcctacgtggacaaggtgctcgccgccaccggcgccccggaggcggacatcgtcgggcactcgcaggggggcatgatgccccggtactacctgaagttcctcggcggggcggccaaggtcaacgccctggtgggcatcgccccctcgaaccacgggacggacctcaacggcttcaccgccctcctgccgtacttcccgggcgccgccgacctcctcggccggcacaccccggcgctggccgaccaggtcaccgggagcgcgttcctgacccgcctgaacgcggacggcgacacggtcgcgggggtccgctacaccgtcatcgccacgcgctacgacgaggtcgtcaccccctggcggtcccagtacctgagcggcccgaacgtccggaacgtgctgctccaggacctgtgccccctcgacttgagcgaacacgtggccatcggcgtgttcgacctcatcgcataccacgaggtcgccaacgccctggacccggcgcacgccacccccacgacctgcgcgtccgtcttcggc

SEQ ID NO: 24 - protein, 305 aa, Artificial Sequence
  SprLip2 produced from plasmid pZQ205
MGFGSAPIALCPLRTRRNALKRLLALLATGVSIVGLTALAGPPAQADTTTAAPSSGWNDYDCKPSAAHPRPVVLVHGTLGNSVDNWLVLAPYLVKRGYCVFSLDYGQLPGVPFFHGLGPVDKSAEQLDAYVDKVLAATGAPEADIVGHSQGGMMPRYYLKFLGGAAKVNALVGIAPSNHGTDLNGFTALLPYFPGAADLLGRHTPALADQVTGSAFLTRLNADGDTVAGVRYTVIATRYDEVVTPWRSQYLSGPNVRNVLLQDLCPLDLSEHVAIGVFDLIAYHEVANALDPAHATPTTCASVFG

SEQ ID NO: 25 - protein, 416 aa, Geobacillus stearothermophilus
MKCCRIMFVLLGLWFVFGLSVPGGRTEAASLRANDAPIVLLHGFTGWGREEMFGFKYWGGVRGDIEQWLNDNGYRTFTLAVGPLSSNWDRACEAYAQLVGGTVDYGAAHAAKHGHARFGRTYPGLLPELKRGGRIHIIAHSQGGQTARMLVSLLENGSQEEREYAKAHNVSLSPLFEGGHHFVLSVTTIATPHDGTTLVNMVDFTDRFFDLQKAVLEAAAVASNVPYTSQVYDFKLDQWGLRRQPGESFDHYFERLKRSPVWTSTDTARYDLSVSGAEKLNQWVQASPNTYYLSFSTERTYRGALTGNHYPELGMNAFSAVVCAPFLGSYRNPTLGIDDRWLENDGIVNTVSMNGPKRGSSDRIVPYDGTLKKGVWNDMGTYNVDHLEIIGVDPNPSFDIRAFYLRLAEQLASLQP

SEQ ID NO: 26 - protein, 705 aa, Artificial Sequence
  BCE-GeoT1 fusion protein
DDYSVVEEHGQLSISNGELVNERGEQVQLKGMSSHGLQWYGQFVNYESMKWLRDDWGITVFRAAMYTSSGGYIDDPSVKEKVKETVEAAIDLGIYVIIDWHILSDNDPNIYKEEAKDFFDEMSELYGDYPNVIYEIANEPNGSDVTWDNQIKPYAEEVIPVIRDNDPNNIVIVGTGTWSQDVHHAADNQLADPNVMYAFHFYAGTHGQNLRDQVDYALDQGAAIFVSEWGTSAATGDGGVFLDEAQVWIDFMDERNLSWANWSLTHKDESSAALMPGANPTGGWTEAELSPSGTFVREKIRESASDNNDPIPDPDDEASLRANDAPIVLLHGFTGWGREEMFGFKYWGGVRGDIEQWLNDNGYRTFTLAVGPLSSNWDRACEAYAQLVGGTVDYGAAHAAKHGHARFGRTYPGLLPELKRGGRIHIIAHSQGGQTARMLVSLLENGSQEEREYAKAHNVSLSPLFEGGHHFVLSVTTIATPHDGTTLVNMVDFTDRFFDLQKAVLEAAAVASNVPYTSQVYDFKLDQWGLRRQPGESFDHYFERLKRSPVWTSTDTARYDLSVSGAEKLNQWVQASPNTYYLSFSTERTYRGALTGNHYPELGMNAFSAVVCAPFLGSYRNPTLGIDDRWLENDGIVNTVSMNGPKRGSSDRIVPYDGTLKKGVWNDMGTYNVDHLEIIGVDPNPSFDIRAFYLRLAEQLASLQP

SEQ ID NO: 27 - protein, 212 aa, Bacillus subtilis [sequence omitted]

SEQ ID NO: 28 - protein, 498 aa, Artificial Sequence
  BCE-LipA fusion protein
DDYSVVEEHGQLSISNGELVNERGEQVQLKGMSSHGLQWYGQFVNYESMKWLRDDWGITVFRAAMYTSSGGYIDDPSVKEKVKETVEAAIDLGIYVIIDWHILSDNDPNIYKEEAKDFFDEMSELYGDYPNVIYEIANEPNGSDVTWDNQIKPYAEEVIPVIRDNDPNNIVIVGTGTWSQDVHHAADNQLADPNVMYAFHFYAGTHGQNLRDQVDYALDQGAAIFVSEWGTSAATGDGGVFLDEAQVWIDFMDERNLSWANWSLTHKDESSAALMPGANPTGGWTEAELSPSGTFVREKIRESASDNNDPIPDPDDEAEHNPVVMVHGIGGASFNFAGIKSYLVSQGWSRDKLYAVDFWDKTGTNYNNGPVLSRFVQKVLDETGAKKVDIVAHSMGGANTLYYIKNLDGGNKVANVVTLGGANRLTTGKALPGTDPNQKILYTSIYSSADMIVMNYLSRLDGARNVQIHGVGHIGLLYSSQVNSLIKEGLNGGGQNTN

SEQ ID NO: 29 - protein, 297 aa, Artificial Sequence
  Full amino acid sequence of Lipase 3
MFSGRFGVLLTALAALGAAAPAPLAVRSVSTSTLDELQLFAQWSAAAYCSNNIDSKDSNLTCTANACPSVEEASTTMLLEFDLTNDFGGTAGFLAADNTNKRLVVAFRGSSTIENWIANLDFILEDNDDLCTGCKVHTGFWKAWESAADELTSKIKSAMSTYSGYTLYFTGHSLGGALATLGATVLRNDGYSVELYTYGCPRIGNYALAEHITSQGSGANFRVTHLNDIVPRVPPMDFGFSQPSPEYWITSGNGASVTASDIEVIEGINSTAGNAGEATVSVVAHLWYFFAISECLL

SEQ ID NO: 30 - DNA, 18 bp, Artificial Sequence
  NsiI-MluI-HpaI enzyme restriction sites
atgcatacgcgtgttaac

(19) United States
(12) Patent Application Publication
(10) Pub. No.: US 2014/0031272 A1
(43) Pub. Date: Jan. 30, 2014

(54) COMPOSITIONS

(71) Applicants: Stepan Shipovskov, Ega (DK); Lene Bojsen Jensen, Hojbjerg (DK); Zhen Qian, Shanghai (CN)

(72) Inventors: Stepan Shipovskov, Ega (DK); Lene Bojsen Jensen, Hojbjerg (DK); Zhen Qian, Shanghai (CN)

(73) Assignee: DANISCO US INC., Palo Alto, CA (US)

(21) Appl. No.: 14/110,481

(22) PCT Filed: Apr. 4, 2012
(86) PCT No.: PCT/IB2012/051660

§ 371 Date: Oct. 8, 2013

Related U.S. Application Data
(60) Provisional application No. 61/561,044, filed on Nov. 17, 2011.

(30) Foreign Application Priority Data
Apr. 8, 2011 (CN) PCT/CN2011/000614

(51) Int. Cl. C11D 3/386

(52) U.S. Cl. CPC C11D 3/38627
USPC 510/320

(57) ABSTRACT

A composition comprising: (a) a lipolytic enzyme; (b) a hydrophobin, as defined herein; and optionally (c) a detergent; is provided. The composition is useful as a cleaning composition for removing lipid-based stains from surfaces.

### FIELD OF THE INVENTION

This invention relates to a composition, particularly although not exclusively for use as a detergent. The invention also relates to methods of cleaning surfaces and items, such as clothing items and tableware items, using the composition.

### BACKGROUND TO THE INVENTION

As described in Wösten, Annu. Rev. Microbiol. 2001, 55, 625646, hydrophobins are proteins generally of fungal origin that play a broad range of roles in the growth and development of filamentous fungi. For example, they are involved in the formation of aerial structures and in the attachment of hyphae to hydrophobic surfaces.

The mechanisms by which hydrophobins perform their function are based around their property to self-assemble at hydrophobic-hydrophilic interfaces (particularly air-water interfaces) into an amphipathic film.

Typically, hydrophobins are divided into Classes I and II. As described in more detail herein, the assembled amphipathic films of Class II hydrophobins are capable of redissolving in a range of solvents (particularly although not exclusively an aqueous ethanol) at room temperature. In contrast, the assembled amphipathic films of Class I hydrophobins are much less soluble, redissolving only in strong acids such as trifluoroacetic acid or formic acid.

Detergent compositions containing hydrophobins are known in the art. For example, US 2009/0101167 (corresponding to WO 2007/014897) describes the use of hydrophobins, particularly fusion hydrophobins, for washing textiles and washing compositions containing them.

There remains a need in the art for detergent compositions containing surfactants capable of being used in smaller quantities and thereby minimising impact on the environment.

### SUMMARY OF THE INVENTION

According to one aspect of the invention, there is provided a composition comprising:

(a) a lipolytic enzyme; and
(b) a hydrophobin, as defined herein.

According to another aspect of the invention, there is provided a composition comprising:

(a) a lipolytic enzyme;
(b) a hydrophobin, as defined herein; and
(c) a detergent.

According to one aspect of the invention, there is provided a composition comprising:

(a) a GX lipolytic enzyme, wherein G is glycine and X is an oxyanion hole-forming amino acid residue, wherein the GX lipolytic enzyme belongs to an alpha/beta hydrolase superfamily selected from the group consisting of abH23, abH25, and abH15; and
(b) a hydrophobin, as defined herein.

According to another aspect of the invention, there is provided a composition comprising:

(a) a GX lipolytic enzyme, wherein G is glycine and X is an oxyanion hole-forming amino acid residue;
(b) a hydrophobin, as defined herein; and
(c) a detergent.

According to a yet further aspect of the invention, there is provided a method of removing a lipid-based stain from a surface by contacting the surface with a composition as defined herein.

According to a still further aspect of the invention, there is provided the use of a composition as defined herein to reduce or remove lipid stains from a surface.

According to a further aspect of the invention, there is provided a method of cleaning a surface, comprising contacting the surface with a composition as defined herein.

According to a further aspect of the invention, there is provided a method of cleaning an item, in particular a clothing item or a tableware item, comprising contacting the item with a composition as defined herein,

### Advantages

It has surprisingly been found that the combination of hydrophobin, lipolytic enzyme and, optionally, detergent is capable of removing oily soils from surfaces, such as textile, clothing or tableware surfaces: it is generally problematic to remove such soils using existing commercial detergents. This effect confers the potential for using the combination in washing compositions.

In particular, it has surprisingly been found that the combination of hydrophobin and GX lipolytic enzyme selected from the abH superfamilies referred to above exhibits a greatly improved cleaning effect than would be expected from an additive effect of either of these proteins when used alone. These properties confer the potential for using the combination as a replacement for detergent in washing compositions, thereby minimising the environmental impact of such compositions.

It has also surprisingly been found that the combination of hydrophobin, GX lipolytic enzyme and detergent exhibits a greatly improved cleaning effect than would be expected from an additive effect of any of these three components when used alone. These properties confer the potential for using the combination to minimise the amount of detergent required in washing compositions, thereby minimising the environmental impact of such compositions.

### BRIEF DESCRIPTION OF THE DRAWINGS

FIG. 1a shows the % change in Stain Removal index (SRI) as a function of the detergent concentration at various specified hydrophobin concentrations in the presence of heat-inactivated liquid detergent ARIEL™ Color, but in the absence of a lipolytic enzyme;

FIG. 1b shows the % change in SRI as a function of the hydrophobin concentration at various specified detergent concentrations in the presence of heat-inactivated liquid detergent ARIEL™ Color, but in the absence of a lipolytic enzyme;

FIG. 1 c shows the % change in SRI as a function of the detergent concentration at various specified hydrophobin concentrations in the presence of heat-inactivated powder detergent ARIEL™ Color, but in the absence of a lipolytic enzyme;

FIG. 2a shows the % change in SRI as a function of the detergent concentration at various specified hydrophobin concentrations in the presence of the lipolytic enzyme LIPEX™ and the heat-inactivated liquid detergent ARIEL™ Color;

FIG. 2b shows the % change in SRI as a function of the hydrophobin concentration at various specified detergent concentrations in the presence of the lipolytic enzyme LIPEX™ and the heat-inactivated liquid detergent ARIEL™ Color;

FIG. 2c shows the % change in SRI as a function of the detergent concentration at various specified hydrophobin concentrations in the presence of the lipolytic enzyme LIPEX™ and the heat-inactivated powder detergent ARIEL™ Color;

FIG. 2d shows the % change in SRI as a function of the hydrophobin concentration at various specified detergent concentrations in the presence of the lipolytic enzyme LIPEX™ and the heat-inactivated powder detergent ARIEL™ Color;

FIG. 2e shows the % change in SRI as a function of the hydrophobin concentration in the presence of the lipolytic enzyme LIPEX™ but in the absence of detergent;

FIG. 3a shows the % change in SRI as a function of the detergent concentration at various specified hydrophobin concentrations in the presence of the lipolytic enzyme LIPOMAX™ and the heat-inactivated liquid detergent ARIEL™ Color;

FIG. 3b shows the % change in SRI as a function of the hydrophobin concentration at various specified detergent concentrations in the presence of the lipolytic enzyme LIPOMAX™ and the heat-inactivated liquid detergent ARIEL™ Color;

FIG. 3c shows the % change in SRI as a function of the detergent concentration at various specified hydrophobin concentrations in the presence of the lipolytic enzyme LIPOMAX™ and the heat-inactivated powder detergent ARIEL™ Color;

FIG. 3d shows the % change in SRI as a function of the hydrophobin concentration at various specified detergent concentrations in the presence of the lipolytic enzyme LIPOMAX™ and the heat-inactivated powder detergent ARIEL™ Color;

FIG. 3e shows the % change in SRI as a function of the hydrophobin concentration in the presence of the lipolytic enzyme LIPOMAX™ but in the absence of detergent;

FIG. 4a shows the % change in SRI as a function of the detergent concentration at various specified hydrophobin concentrations in the presence of the lipolytic enzyme SprLip2 and the heat-inactivated liquid detergent ARIEL™ Color;

FIG. 4b shows the % change in SRI as a function of the hydrophobin concentration at various specified detergent concentrations in the presence of the lipolytic enzyme SprLip2 and the heat-inactivated liquid detergent ARIEL™ Color;

FIG. 4c shows the % change in SRI as a function of the detergent concentration at various specified hydrophobin concentrations in the presence of the lipolytic enzyme SprLip2 and the heat-inactivated powder detergent ARIEL™ Color;

FIG. 4d shows the % change in SRI as a function of the hydrophobin concentration at various specified detergent concentrations in the presence of the lipolytic enzyme SprLip2 and the heat-inactivated powder detergent ARIEL™ Color;

FIG. 4e shows the % change in SRI as a function of the hydrophobin concentration in the presence of the lipolytic enzyme SprLip2 but in the absence of detergent;

FIG. 5a shows the % change in SRI as a function of the detergent concentration at various specified hydrophobin concentrations in the presence of the lipolytic enzyme TfuLip2 and the heat-inactivated liquid detergent ARIEL™ Color;

FIG. 5b shows the % change in SRI as a function of the hydrophobin concentration at various specified detergent concentrations in the presence of the lipolytic enzyme TfuLip2 and the heat-inactivated liquid detergent ARIEL™ Color;

FIG. 5c shows the % change in SRI as a function of the detergent concentration at various specified hydrophobin concentrations in the presence of the lipolytic enzyme TfuLip2 and the heat-inactivated powder detergent ARIEL™ Color;

FIG. 5d shows the % change in SRI as a function of the hydrophobin concentration at various specified detergent concentrations in the presence of the lipolytic enzyme TfuLip2 and the heat-inactivated powder detergent ARIEL™ Color;

FIG. 5e shows the % change in SRI as a function of the hydrophobin concentration in the presence of the lipolytic enzyme TfuLip2 but in the absence of detergent;

FIG. 6 shows SEQ ID NO: 1, the DNA sequence encoding the hydrophobin Trichoderma reesei HFBII (Y11894.1);

FIG. 7 shows SEQ ID NO: 2, the amino acid sequence of the hydrophobin Trichoderma reesei HFBII (P79073.1);

FIG. 8 shows SEQ ID NO: 3, the DNA sequence encoding the hydrophobin Trichoderma reesei HFBI (Z68124.1);

FIG. 9 shows SEQ ID NO: 4, the amino acid sequence of the hydrophobin Trichoderma reesei HFBI (P52754.1);

FIG. 10 shows SEQ ID NO: 5, the DNA sequence encoding the hydrophobin Schizophyllum commune SC3 (M32329.1);

FIG. 11 shows SEQ ID NO: 6, the amino acid sequence of the hydrophobin Schizophyllum commune SC3 (AAA96324.1);

FIG. 12 shows SEQ ID NO: 7, the DNA sequence encoding the hydrophobin Neurospora crassa EAS (X67339.1);

FIG. 13 shows SEQ ID NO: 8, the amino acid sequence of the hydrophobin Neurospora crassa EAS (AAB24462.1);

FIG. 14 shows SEQ ID NO: 9, Talaromyces thermophilus TT1 (the DNA sequence encoding the precursor TT1 hydrophobin, SEQ ID NO: 4 of U.S. Pat. No. 7,241,734);

FIG. 15 shows SEQ ID NO: 10, Talaromyces thermophilus TT1 (the amino acid sequence of the precursor TT1 hydrophobin, SEQ ID NO: 3 of U.S. Pat. No. 7,241,734);

FIG. 16 shows SEQ ID NO: 11 the mature amino acid sequence of LIPEX™;

FIG. 17 shows SEQ ID NO: 12 the full amino acid sequence for SprLip2 (Streptomyces pristinaespiralis ATCC 25486 Uniprot B5H9Q8, NCBI: ZP_{—}06912654.1) with the signal sequence shown in bold;

FIG. 18 shows SEQ ID NO: 13 the mature amino acid sequence of the Fusarium heterosporum phospholipase (disclosed in WO 2005/087918 and available from Danisco A/S as GRINDAMYL POWERBAKE 4100™);

FIG. 19 shows SEQ ID NO: 29 the full amino acid sequence of Lipase 3 disclosed in WO 98/45453, residues 1 to 270 comprise the mature sequence referred to herein as SEQ ID NO: 14;

FIG. 19a shows SEQ ID NO: 14 the mature amino acid sequence of Lipase 3;

FIG. 20 shows SEQ ID NO: 15 the mature amino acid sequence of LIPOMAX™;

FIG. 21 shows SEQ ID NO: 16 the mature amino acid sequence of TfuLip2;

FIG. 22 shows SEQ ID NO: 17 the mature amino acid sequence of SprLip2;

FIG. 23 shows SEQ ID NO: 18 the full amino acid sequence of LIPEX, including the signal sequence (amino acid residues 1 to 17), propeptide (amino acid residues 18 to 22) and mature sequence (amino acid residues 23 to 291—shown in FIG. 16 as SEQ ID NO: 11);

FIG. 24 shows SEQ ID NO: 19 the full amino acid sequence of LIPOMAX, including the signal sequence (amino acid residues 1 to 24) and mature sequence (amino acid residues 25 to 313—shown in FIG. 20 as SEQ ID NO: 15);

FIG. 25 shows SEQ ID NO: 20 the full amino acid sequence of TfuLip2, including the signal sequence (amino acid residues 1 to 40) and mature sequence (amino acid residues 41 to 301—shown in FIG. 21 as SEQ ID NO: 16);

FIG. 26 shows a protein preprosequence SEQ ID NO: 21 of a lipolytic enzyme from Fusarium heterosporum CBS 782.83 (wild type) disclosed in WO 2005/087918—the preprosequence undergoes translational modification such that the mature form of the enzyme preferably comprises the enzyme shown in FIG. 18 as SEQ ID NO: 13; in some host organisms the protein may be N-terminally processed such that a number of additional amino acids are added to the N or C terminus;

FIG. 27 shows SEQ ID NO: 22 the nucleotide sequence of the synthesized SprLip2 gene;

FIG. 28 shows SEQ ID NO: 23 the nucleotide sequence of the SprLip2 gene from expression plasmid pZQ205 (celA signal sequence is underlined);

FIG. 29 shows SEQ ID NO: 24 the amino acid sequence of SprLip2 produced from plasmid pZQ205 (signal sequence is underlined);

FIG. 30 shows the plasmid map of pZQ205 expression vector;

FIG. 31 shows pNB hydrolysis by SprLip2;

FIG. 32 shows pNPP hydrolysis by SprLip2;

FIG. 33 shows trioctanoate hydrolysis in the absence of detergent by SprLip2;

FIG. 34 shows trioctanoate hydrolysis in the presence of detergent by SprLip2;

FIG. 35 shows the performance of SprLip2 in the presence and absence of detergent;

FIG. 36 shows SEQ ID NO: 25, the amino acid sequence of a lipase from Geobacillus stearothermophilus strain T1 (GeoT1) which is available on the NCBI database as accession number JC8061 (signal sequence is underlined);

FIG. 37 shows SEQ ID NO: 26 the amino acid sequence of the BCE-GeoT1 fusion protein which is a fusion of SEQ ID NO: 25 and the carboxy-terminus of the catalytic domain of a bacterial cellulase;

FIG. 38 shows SEQ ID NO: 27 the amino acid sequence of a lipase from Bacillus subtilis 168 (LipA) which is available as GENBANK Accession No. P37957 (signal sequence is underlined);

FIG. 39 shows SEQ ID NO: 28 the amino acid sequence of the BCE-LipA fusion protein which is a fusion of SEQ ID NO: 27 and the carboxy-terminus of the catalytic domain of a bacterial cellulase; and

FIG. 40 shows SEQ ID NO: 30 the nucleotide sequence of the Nsil-Mlul-Hpal enzyme restriction sites before the BamHI site.

### DETAILED DESCRIPTION OF PREFERRED EMBODIMENTS

### Hydrophobins

In this specification the term “hydrophobin” is defined as meaning a polypeptide capable of self-assembly at a hydrophilic/hydrophobic interface, and having the general formula (I):

(Y₁)ₙ—B₁-(X₁)ₐ-B₂-(X₂)-B₃-(X₃)-B₄-(X₄)_{d}-(X₅)ₑ-B₆-(X₆)_{f}-B₇-(X₇)_{g}-B₈-(Y₂)ₘ (I)

wherein:
m and n are independently 0 to 2000;
B₁, B₂, B₃, B₄, B₅, B₆, B₇ and B₈ are each independently amino acids selected from Cys, Leu, Ala, Pro, Ser, Thr, Met or Gly, at least 6 of the residues B₁ through B₈ being Cys;
X₁, X₂, X₃, X₄, X₅, X₆, X₇, Y₁ and Y₂ independently represent any amino acid;
a is 1 to 50;
b is 0 to 5;
c is 1 to 100;
d is 1 to 100;
e is 1 to 50;
f is 0 to 5; and
g is 1 to 100.

Suitably, the hydrophobin has a sequence of between 40 and 120 amino acids in the hydrophobin core. More preferably, the hydrophobin has a sequence of between 45 and 100 amino acids in the hydrophobin core. In one embodiment, the hydrophobin has a sequence of between 50 and 90, preferably 50 to 75, and more preferably 55 to 65 amino acids in the hydrophobin core. In this specification the term “the hydrophobin core” means the sequence beginning with the residue B₁ and terminating with the residue B₈.

In the formula (I), at least 6, preferably at least 7, and most preferably all 8 of the residues B₁ through B₈ are Cys.

In the formula (I), in one embodiment m is suitably 0 to 500, preferably 0 to 200, more preferably 0 to 100, still more preferably 0 to 20, yet more preferably 0 to 10, still more preferably 0 to 5, and most preferably 0.

In the formula (I), in one embodiment n is suitably 0 to 500, preferably 0 to 200, more preferably 0 to 100, still more preferably 0 to 20, yet more preferably 0 to 10, and most preferably 0 to 3.

In the formula (I), a is preferably 3 to 25, more preferably 5 to 15. In one embodiment, a is 5 to 9.

In the formula (I), b is preferably 0 to 2, more preferably 0.

In the formula (I), c is preferably 5 to 50, more preferably 5 to 40. In one embodiment, c is 11 to 39.

In the formula (I), d is preferably 2 to 35, more preferably 4 to 23. In one embodiment, d is 8 to 23.

In the formula (I), e is preferably 2 to 15, more preferably 5 to 12. In one embodiment, e is 5 to 9.

In the formula (I), f is preferably 0 to 2, more preferably 0.

In the formula (I), g is preferably 3 to 35, more preferably 6 to 21. In one embodiment, g is 6 to 18.

Preferably, the hydrophobins used in the present invention have the general formula (II):

(Y₁)ₙ-B₁-(X₁)ₐ-B₂-(X₂)_{b}-B₃-(X₃)_{c}-B₄-(X₄)_{d}-B₅-(X₅)ₑ-B₆-(X₆)_{f}-B₇-(X₇)_{g}-B₈-(Y₂)ₘ (II)

wherein:
m and n are independently 0 to 20;
B₁, B₂, B₃, B₄, B₅, B₆, B₇ and B₈ are each independently amino acids selected from Cys, Leu, Ala, Pro, Ser, Thr, Met or Gly, at least 7 of the residues B₁ through Be being Cys;
a is 3 to 25;
b is 0 to 2;
c is 5 to 50;
d is 2 to 35;
e is 2 to 15;
f is 0 to 2; and
g is 3 to 35.

In the formula (II), at least 7, and preferably all 8 of the residues B₁ through B₈ are Cys.

More preferably, the hydrophobins used in the present invention have the general formula (III):

(Y₁)ₙ-B₁-(X₁)ₐ-B₂-B₃-(X₃)_{c}-B₄-(X₄)_{d}-B₅-(X₅)ₑ-B₆-B₇-(X₇)_{g}-B₈-(Y₂)ₘ (III)

wherein:
m and n are independently 0 to 20;
B₁, B₂, B₃, B₄, B₅, B₆, B₇ and B₈ are each independently amino acids selected from Cys, Leu, Ala, Pro, Ser, Thr, Met or Gly, at least 7 of the residues B₁ through B₈ being Cys;
a is 5 to 15;
c is 5 to 40;
d is 4 to 23;
e is 5 to 12; and
g is 6 to 21.

In the formula (III), at least 7, and preferably 8 of the residues B₁ through B₈ are Cys.

In the formulae (I), (II) and (III), when 6 or 7 of the residues B₁ through B₈ are Cys, it is preferred that the residues B₃ through B₇ are Cys.

In the formulae (I), (II) and (III), when 7 of the residues B₁ through B₈ are Cys, it is preferred that: (a) B₁ and B₃ through B₈ are Cys and B₂ is other than Cys; (b) B₁ through 87 are Cys and B₈ is other than Cys, (c) B₁ is other than Cys and B₂ through B₈ are Cys. When 7 of the residues B₁ through B₈ are Cys, it is preferred that the other residue is Ser, Pro or Leu. In one embodiment, B₁ and B₃ through Be are Cys and B₂ is Ser. In another embodiment, B₁ through B₇ are Cys and B₈ is Leu. In a further embodiment, B₁ is Pro and B₂ through B₈ are Cys.

The cysteine residues of the hydrophobins used in the present invention may be present in reduced form or form disulfide (—S—S—) bridges with one another in any possible combination. In one particularly preferred embodiment, when all 8 of the residues B₁ through B₈ are Cys, disulfide bridges may be formed between one or more (preferably at least 2, more preferably at least 3, most preferably all 4) of the following pairs of cysteine residues: B₁ and B₆; B₂ and B₅; B₃ and B₄; B₇ and B₈. In one alternative preferred embodiment, when all 8 of the residues B₁ through B₈ are Cys, disulfide bridges may be formed between one or more (preferably at least 2, more preferably at least 3, most preferably all 4) of the following pairs of cysteine residues: B₁ and B₂; B₃ and B₄; B₅ and B₆; B₇ and B₈.

Examples of specific hydrophobins useful in the present invention include those described and exemplified in the following publications: Linder et al., FEMS Microbiology Rev. 2005, 29, 877-896; Kubicek et al., BMC Evolutionary Biology, 2008, 8, 4; Sunde et al., Micron, 2008, 39, 773-784; Wessels, Adv. Micr. Physiol. 1997, 38, 1-45; Wösten, Annu. Rev. Microbiol. 2001, 55, 625-646; Hektor and Scholtmeijer, Curr. Opin. Biotech. 2005, 16, 434-439; Szilvay et al., Biochemistry, 2007, 46, 2345-2354; Kisko et al. Langmuir, 2009, 25, 1612-1619; Blijdenstein, Soft Matter, 2010, 6, 1799-1808; Wösten et al., EMBO J. 1994, 13, 5848-5854; Hakanpää et al., J. Biol. Chem., 2004, 279, 534-539; Wang et al.; Protein Sci., 2004, 13, 810-821; De Vocht et al., Biophys. J. 1998, 74, 2059-2068; Askolin et al., Biomacromolecules 2006, 7, 1295-1301; Cox et al.; Langmuir, 2007, 23, 7995-8002; Linder et al., Biomacromolecules 2001, 2, 511-517; Kallio et al. J. Biol. Chem., 2007, 282, 28733-28739; Scholtmeijer et al, Appl. Microbiol. Biotechnol., 2001, 56, 1-8; Lumsdon et al., Colloids & Surfaces B: Biointerfaces, 2005, 44, 172-178; Palomo et al., Biomacromolecules 2003, 4, 204-210; Kirkland and Keyhani, J. Ind. Microbiol. Biotechnol., Jul. 17, 2010 (e-publication); Stübner et al., Int. J. Food Microbiol., 30 Jun. 2010 (e-publication); Laaksonen et al. Langmuir, 2009, 25, 5185-5192; Kwan et al. J. Mol. Biol. 2008, 382, 708-720; Yu et al. Microbiology, 2008, 154, 1677-1685; Lahtinen et al. Protein Expr. Purif., 2008, 59, 18-24; Szilvay et al., FEBS Lett., 2007, 5811, 2721-2726; Hakanpää et al., Acta Crystallogr. D. Biol. Crystallogr. 2006, 62, 356-367; Scholtmeijer et al., Appl. Environ. Microbiol., 2002, 68, 1367-1373; Yang et al, BMC Bioinformatics, 2006, 7 Supp. 4, S16; WO 01/57066; WO 01/57528; WO 2006/082253; WO 2006/103225; WO 2006/103230; WO 2007/014897; WO 2007/087967; WO 2007/087968; WO 2007/030966; WO 2008/019965; WO 2008/107439; WO 2008/110456; WO 2008/116715; WO 2008/120310; WO 2009/050000; US 2006/0228484; and EP 2042156A; the contents of which are incorporated herein by reference.

In one embodiment, the hydrophobin is a polypeptide selected from SEQ ID NOs: 2, 4, 6 8 or 10, or a polypeptide having at least 70%, at least 75%, at least 80%, at least 85%, at least 90%, at least 91%, at least 92%, at least 93%, at least 94%, at least 95%, at least 96%, at least 97%, or at least 99% sequence identity in the hydrophobin core to any thereof and retaining the above-described self-assembly property of hydrophobins.

### Sources of Hydrophobins

In one embodiment, the hydrophobin is obtained or obtainable from a microorganism. The microorganism may preferably be a bacteria or a fungus, more preferably a fungus. In a preferred embodiment, the hydrophobin is obtained or obtainable from a filamentous fungus.

In one embodiment, the hydrophobin is obtained or obtainable from fungi of the phyla Basidiomycota or Ascomycota.

In one embodiment, the hydrophobin is obtained or obtainable from fungi of the genera Cladosporium (particularly C. fulvum or C. herbarum), Ophistoma (particularly O. ulmi), Cryphonectria (particularly C. parasitica), Trichoderma (particularly T. harzianum, T. longibrichiatum, T. asperellum, T. Koningiopsis, T. aggressivum, T. stromaticum or T. reesei), Gibberella (particularly G. moniliformis), Neurospora (particularly N. crassa), Maganaporthe (particularly M. grisea), Hypocrea (particularly H. jecorina, H. atroviridis, H. virens or H. lixii), Xanthoria (particularly X. ectanoides and X. parietina), Emericella (particularly E. nidulans), Aspergillus (particularly A. fumigatus, A. oryzae), Paracoccioides (particularly P. brasiliensis), Metarhizium (particularly M. anisoplaie), Pleurotus (particularly P. ostreatus), Coprinus (particularly C. cinereus), Dicotyonema (particularly D. glabratum), Flammulina (particularly F. velutipes), Schizophyllum (particularly S. commune), Agaricus (particularly A. bisporus), Pisolithus (particularly P. tinctorius), Tricholoma (particularly T. terreum), Pholioka (particularly P. nameko), Talaromyces (particularly T. thermophilus) or Agrocybe (particularly A. aegerita).

### Assays

One property of the hydrophobins used in the present invention is the self-assembly property of the hydrophobins at a hydrophilic/hydrophobic interface.

In accordance with the definition of the present invention, self-assembly can be detected by adsorbing the protein to polytetrafluoroethylene (TEFLON®) and using Circular Dichroism (CD) to establish the change in secondary structure exemplified by the occurrence of motifs in the CD spectrum corresponding to a newly formed α-helix) (De Vocht et al., Biophys. J. 1998, 74, 2059-2068). A full procedure for carrying out the CD spectral analysis can be found in Askolin et al. Biomacromolecules, 2006, 7, 1295-1301.

In one embodiment, the hydrophobins used in the present invention are characterised by their effect on the surface properties at an interface, particularly although not exclusively at an air/water interface. The surface property may be surface tension (especially equilibrium surface tension) or surface shear rheology, particularly the surface shear elasticity (storage modulus).

In one embodiment, the hydrophobin may cause the equilibrium surface tension at a water/air interface to reduce to below 45 mN/m, preferably below 40 mN/m, and more preferably below 35 mN/m. In contrast, the surface tension of pure water is 72 mN/m room temperature. Typically, such a reduction in the equilibrium surface tension at a water/air interface may be achieved using a hydrophobin concentration of between 5×10⁻⁸ M and 2×10⁻⁶ M, more preferably between 1×10⁻⁷ M and 1×10⁻⁶ M. Typically such a reduction in the equilibrium surface tension at a water/air interface may be achieved at a temperature ranging from 0° C. to 50° C., especially room temperature. The change in equilibrium surface tension can be measured using a tensiometer following the method described in Cox et al., Langmuir, 2007, 23, 7995-8002.

In another embodiment, the hydrophobin may cause the surface shear elasticity at a water/air interface to increase to 300-700 mN/m, preferably 400-600 mN/m. Typically, such a surface shear elasticity at a water/air interface may be achieved using a hydrophobin concentration of between 1×10⁻⁴ M and 0.01 M, preferably between 5×10⁻⁴ M and 2×10⁻³ M, especially 1×10⁻³ M. Typically, such a surface shear elasticity at a water/air interface may be achieved at a temperature ranging from 0° C. to 50° C., especially room temperature. The change in equilibrium surface tension can be measured using a rheometer following the method described in Cox et al., Langmuir, 2007, 23, 7995-8002.

In some embodiments, the hydrophobins used in the present invention are biosurfactants. Biosurfactants are surface-active substances synthesised by living cells. They have the properties of reducing surface tension, stabilising emulsions, promoting foaming and are generally non-toxic and biodegradable.

Examples of specific hydrophobins useful in the compositions of the present invention are listed in Table 1 below.

TABLE 1

| | Gene, Protein | NCBI accession code and |
|---|---|---|
| Organism | name | version number |
| Agaricus bisporus | ABH3 | Y14602.1 |
| Agaricus bisporus | HYPB | Y15940.1 |
| Aspergillus fumigatus | HYP1/RODA | L25258.1, U06121.1 |
| Aspergillus fumigatus | RODB | AY057385.1 |
| Aspergillus niger | A_NIG1 | XM_001394993.1 |
| Aspergillus oryzae | HYPB | AB097448.1 |
| Aspergillus oryzae | ROLA | AB094496.1 |
| Aspergillus terreus | A_TER | XM_001213908.1 |
| Cladosporium fulvum | HCF-5 | AJ133703.1 |
| Cladosporium fulvum | HCF-6 | AJ251294.1 |
| Cladosporium fulvum | HCF-3 | AJ566186.1 |
| Cladosporium fulvum | HCF-1 | X98578.1 |
| Cladosporium fulvum | HCF-2 | AJ133700.1 |
| Cladosporium fulvum | HCF-4 | AJ566187.1 |
| Cladosporium herbarum | HCH-1 | AJ496190.1 |
| Claviceps fusiformis | CFTH1_I-III | AJ133774.1 |
| Claviceps fusiformis | CLF | CAB61236.1 |
| Claviceps purpurea | CLP | CAD10781.1 |
| Claviceps purpurea | CPPH1_I-V | AJ418045.1 |
| Coprinus cinereus | COH1 | Y10627.1 |
| Coprinus cinereus | COH2 | Y10628.1 |
| Cryphonectria parasitica | CRP | L09559.1 |
| Dictyonema glabratum | DGH3 | AJ320546.1 |
| Dictyonema glabratum | DGH2 | AJ320545.1 |
| Dictyonema glabratum | DGH1 | AJ320544.1 |
| Emericella nidulans | RODA | M61113.1 |
| Emericella nidulans | DEWA | U07935.1 |
| Flammulina velutipes | FVH1 | AB026720.1 |
| Flammulina velutipes | FvHYD1 | AB126686.1 |
| Gibberella moniliformis | HYD5, GIM | AY158024.1 |
| Gibberella moniliformis | HYD4 | AY155499.1 |
| Gibberella moniliformis | HYD1 | AY155496.1 |
| Gibberella moniliformis | HYD2 | AY155497.1 |
| Gibberella moniliformis | HYD3 | AY155498.1 |
| Gibberella zeae | GIZ, FG01831.1 | XP_382007.1 |
| Lentinula edodes | Le.HYD1 | AF217807.1 |
| Lentinula edodes | Le.HYD2 | AF217808.1 |
| Magnaporthe grisea | MGG4 | XM_364289.1 |
| Magnaporthe grisea | MGG2 | XM_001522792.1 |
| Magnaporthe grisea | MHP1, MGG1 | AF126872.1 |
| Magnaporthe grisea | MPG1 | L20685.2 |
| Metarhizium anisopliae | SSGA | M85281.1 |
| Neurospora crassa | NCU08192.1 | AABX01000408.1 |
| Neurospora crassa | EAS | AAB24462.1 |
| Ophiostoma uimi | CU | U00963.1 |
| Paracoccidioides | PbHYD2 | AY427793.1 |
| brasilensis | | |
| Paracoccidioides | PbHYD1 | AF526275.1 |
| brasilensis | | |
| Passalora fulva | PF3 | CAC27408.1 |
| Passalora fulva | PF1 | CAC27407.1 |
| Passalora fulva | PF2 | CAB39312.1 |
| Pholiota nameko | PNH2 | AB079129.1 |
| Pholiota nameko | PNH1 | AB079128.1 |
| Pisolithus tinctorius | HYDPt-1 | U29605.1 |
| Pisolithus tinctorius | HYDPt-2 | U29606.1 |
| Pisolithus tinctorius | HYDPt-3 | AF097516.1 |
| Pleurotus ostreatus | POH2 | Y14657.1 |
| Pleurotus ostreatus | POH3 | Y16881.1 |
| Pleurotus ostreatus | VMH3 | AJ238148.1 |
| Pleurotus ostreatus | POH1 | Y14656.1 |
| Pleurotus ostreatus | FBHI | AJ004883.1 |
| Schizophyllum commune | SC4 | M32330.1 |
| Schizophyllum commune | SC1, 1G2 | X00788.1 |
| Schizophyllum commune | SC6 | AJ007504.1 |
| Schizophyllum commune | SC3 | AAA96324.1 |
| Talaromyces thermophilus | TT1 | |
| Trichoderma harzianum | QID3 | X71913.1 |
| Trichoderma harzianum | SRH1 | Y11841.1 |
| Trichoderma reesei | HFBII | P79073.1 |
| Trichoderma reesei | HFBI | P52754.1 |
| Tricholoma terreum | HYD1 | AY048578.1 |
| Verticillium dahliae | VED | AAY89101.1 |
| Xanthoria ectaneoides | XEH1 | AJ250793.1 |
| Xanthoria parietina | XPH1 | AJ250794.1 |

### Fusion Proteins

The definition of hydrophobin in the context of the present invention includes fusion proteins of a hydrophobin and another polypeptide as well as conjugates of hydrophobin and other molecules such as polysaccharides.

In one embodiment, the hydrophobin is a hydrophobin fusion protein. In this specification the term “fusion protein” means a hydrophobin sequence (as defined and exemplified above) bonded to a further peptide sequence (described herein as “a fusion partner”) which does not occur naturally in a hydrophobin.

In one embodiment, the fusion partner may be bonded to the amino terminus of the hydrophobin core, thereby forming the group (Y₁)ₘ. In this embodiment, m may range from 1 to 2000, preferably 2 to 1000, more preferably 5 to 500, even more preferably 10 to 200, still more preferably 20 to 100.

In one embodiment, the fusion partner may be bonded to the carboxyl terminus of the hydrophobin core, thereby forming the group (Y₂)ₙ. In this embodiment, n may range from 1 to 2000, preferably 2 to 1000, more preferably 5 to 500, even more preferably 10 to 200, still more preferably 20 to 100.

In another embodiment, fusion partners may be bonded to both the amino and carboxyl termini of the hydrophobin core. In this embodiment, the fusion partners may be the same or different, and preferably have amino acid sequences having the number of amino acids defined above by the preferred values of m and n.

In one embodiment, the hydrophobin is not a fusion protein and m and n are 0.

### Class I and II Hydrophobins

In the art, hydrophobins are divided into Classes I and II. It is known in the art that hydrophobins of Classes I and II can be distinguished on a number of grounds, including solubility. As described herein, hydrophobins self-assemble at an interface (especially a water/air interface) into amphipathic interfacial films. The assembled amphipathic films of Class I hydrophobins are generally re-solubilised only in strong acids (typically those having a pKₐ of lower than 4, such as formic acid or trifluoroacetic acid), whereas those of Class II are soluble in a wider range of solvents.

In one embodiment, the hydrophobin is a Class II hydrophobin. In another embodiment, the hydrophobin is a Class I hydrophobin.

In one embodiment, the term “Class II hydrophobin” means a hydrophobin (as defined and exemplified herein) having the above-described self-assembly property at a water/air interface, the assembled amphipathic films being capable of redissolving to a concentration of at least 0.1% (w/w) in an aqueous ethanol solution (60% v/v) at room temperature. In contrast, in this embodiment, the term “Class I hydrophobin” means a hydrophobin (as defined and exemplified herein) having the above-described self-assembly property but which does not have this specified redissolution property.

In another embodiment the term “Class II hydrophobin” means a hydrophobin (as defined and exemplified herein) having the above-described self-assembly property at a water/air interface and the assembled amphipathic films being capable of redissolving to a concentration of at least 0.1% (w/w) in an aqueous sodium dodecyl sulphate solution (2% w/w) at room temperature. In contrast, in this embodiment, the term “Class I hydrophobin” means a hydrophobin (as defined and exemplified herein) having the above-described self-assembly property but which does not have this specified redissolution property.

Hydrophobins of Classes I and II may also be distinguished by the hydrophobicity/hydrophilicity of a number of regions of the hydrophobin protein.

In one embodiment, the term “Class II hydrophobin” means a hydrophobin (as defined and exemplified herein) having the above-described self-assembly property and in which the region between the residues B₃ and B₄, i.e. the moiety (X₃)_{c}, is predominantly hydrophobic. In contrast, in this embodiment, the term “Class I hydrophobin” means a hydrophobin (as defined and exemplified herein) having the above-described self-assembly property but in which the region between the residues B₃ and B₄, i.e. the group (X₃)_{c}, is predominantly hydrophilic.

In one embodiment, the term “Class II hydrophobin” means a hydrophobin (as defined and exemplified herein) having the above-described self-assembly property and in which the region between the residues B₇ and B₈, i.e. the moiety (X₇)_{g}, is predominantly hydrophobic. In contrast, in this embodiment, the term “Class I hydrophobin” means a hydrophobin (as defined and exemplified herein) having the above-described self-assembly property but in which the region between the residues B₇ and B₈, i.e. the moiety (X₇)_{g}, is predominantly hydrophilic.

The relative hydrophobicity/hydrophilicity of the various regions of the hydrophobin protein can be established by comparing the hydropathy pattern of the hydrophobin using the method set out in Kyte and Doolittle, J. Mol. Biol., 1982, 157, 105-132. According to the teaching of this reference, a computer program can be used to progressively evaluate the hydrophilicity and hydrophobicity of a protein along its amino acid sequence. For this purpose, the method uses a hydropathy scale (based on a number of experimental observations derived from the literature) comparing the hydrophilic and hydrophobic properties of each of the 20 amino acid side-chains. The program uses a moving-segment approach that continuously determines the average hydropathy within a segment of predetermined length as it advances through the sequence. The consecutive scores are plotted from the amino to the carboxy terminus. At the same time, a midpoint line is printed that corresponds to the grand average of the hydropathy of the amino acid compositions found in most of the sequenced proteins. The method is further described for hydrophobins in Wessels, Adv. Microbial Physiol. 1997, 38, 1-45.

In one embodiment, the term “Class II hydrophobin” means a hydrophobin (as defined and exemplified herein) having the above-described self-assembly property and in which the region between the residues B₃ and B₄, i.e. the moiety (X₃)_{c}, is predominantly hydrophobic. In contrast, in this embodiment, the term “Class I hydrophobin” means a hydrophobin (as defined and exemplified herein) having the above-described self-assembly property but in which the region between the residues B₃ and B₄, i.e. the group (X₃)_{c}, is predominantly hydrophilic.

In one embodiment, the term “Class II hydrophobin” means a hydrophobin (as defined and exemplified herein) having the above-described self-assembly property and in which the region between the residues B₇ and B₈, i.e. the moiety (X₇)_{g}, is predominantly hydrophobic. In contrast, in this embodiment, the term “Class I hydrophobin” means a hydrophobin (as defined and exemplified herein) having the above-described self-assembly property but in which the region between the residues B₇ and B₈, i.e. the moiety (X₇)_{g}, is predominantly hydrophilic.

The relative hydrophobicity/hydrophilicity of the various regions of the hydrophobin protein can be established by comparing the hydropathy pattern of the hydrophobin using the method set out in Kyte and Doolittle, J. Mol. Biol., 1982, 157, 105-132 and described for hydrophobins in Wessels, Adv. Microbial Physiol. 1997, 38, 1-45.

Class II hydrophobins may also be characterised by their conserved sequences. In one embodiment, the Class II hydrophobins used in the present invention have the general formula (IV):

(Y₁)ₙ-B₁-(X₁)ₐ-B₂-B₃-(X₃)_{c}-B₄-(X₄)_{d}-B₅-(X₅)ₑ-B₆-B₇-(X₇)_{g}-B₈-(Y₂)ₘ (IV)

wherein:
m and n are independently 0 to 200;
B₁, B₂, B₃, B₄, B₅, B₆, B₇ and B₈ are each independently amino acids selected from Cys, Leu, Ala, Ser, Thr, Met or Gly, at least 6 of the residues B₁ through B₈ being Cys;
a is 6 to 12;
c is 8 to 16;
d is 2 to 20;
e is 4 to 12; and
g is 5 to 15.

In the formula (IV), a is preferably 7 to 11.

In the formula (IV), c is preferably 10 to 12, more preferably 11.

In the formula (IV), d is preferably 4 to 18, more preferably 4 to 16.

In the formula (IV), e is preferably 6 to 10, more preferably 9 or 10.

In the formula (IV), g is preferably 6 to 12, more preferably 7 to 10.

In one embodiment, the Class II hydrophobins used in the present invention have the general formula (V):

(Y₁)ₙ-B₁-(X₁)ₐ-B₂-B₃-(X₃)_{c}-B₄-(X₄)_{d}-B₅-(X₅)ₑ-B₆-B₇-(X₇)_{g}-B₈-(Y₂)ₘ (V)

wherein:
m and n are independently 0 to 10;
B₁, B₂, B₃, B₄, B₅, B₆, B₇ and B₈ are each independently amino acids selected from Cys, Leu or Ser, at least 7 of the residues B₁ through B₈ being Cys;
a is 7 to 11;
c is 11;
d is 4 to 18;
e is 6 to 10; and
g is 7 to 10.

In the formulae (IV) and (V), at least 7, and preferably all 8 of the residues B₁ through B₈ are Cys.

In the formulae (IV) and (V), when 7 of the residues B₁ through B₈ are Cys, it is preferred that the residues B₃ through B₇ are Cys.

In the formulae (IV) and (V), when 7 of the residues B₁ through B₈ are Cys, it is preferred that: (a) B₁ and B₃ through B₈ are Cys and B₂ is other than Cys; (b) B₁ through B₇ are Cys and B₈ is other than Cys, or (c) B₁ is other than Cys and B₂ through B₈ are Cys. When 7 of the residues B₁ through B₈ are Cys, it is preferred that the other residue is Ser, Pro or Leu. In one embodiment, B₁ and B₃ through B₈ are Cys and B₂ is Ser. In another embodiment, or B₁ through B₇ are Cys and B₈ is Leu. In a further embodiment, B₁ is Pro and B₂ through B₈ are Cys.

In the formulae (IV) and (V), preferably the group (X₃)_{c} comprises the sequence motif ZZXZ, wherein Z is an aliphatic amino acid; and X is any amino acid. In this specification the term “aliphatic amino acid” means an amino acid selected from the group consisting of glycine (G), alanine (A), leucine (L), isoleucine (I), valine (V) and proline (P).

More preferably, the group (X₃)_{c} comprises the sequence motif selected from the group consisting of LLXV, ILXV, ILXL, VLXL and VLXV. Most preferably, the group (X₃)_{c} comprises the sequence motif VLXV.

In the formulae (IV) and (V), preferably the group (X₃) comprises the sequence motif ZZXZZXZ, wherein Z is an aliphatic amino acid; and X is any amino acid. More preferably, the group (X₃)_{c} comprises the sequence motif VLZVZXL, wherein Z is an aliphatic amino acid; and X is any amino acid.

In one embodiment, the hydrophobin is a polypeptide selected from SEQ ID NOs: 2, 4, 6, 8 or 10, or a polypeptide having at least 70%, at least 75%, at least 80%, at least 85%, at least 90%, at least 91%, at least 92%, at least 93%, at least 94%, at least 95%, at least 96%, at least 97%, or at least 99% sequence identity in the hydrophobin core to any thereof. By “the hydrophobin core” is meant the sequence beginning with the residue B₁ and terminating with the residue B₈.

In one embodiment, the hydrophobin is obtained or obtainable from fungi of the phylum Ascomycota. In one embodiment, the hydrophobin is obtained or obtainable from fungi of the genera Cladosporium (particularly C. fulvum), Ophistoma (particularly O. ulmi), Cryphonectria (particularly C. parasitica), Trichoderma (particularly T. harzianum, T. longibrichiatum, T. asperellum, T. Koningiopsis, T. aggressivum, T. stromaticum or T. reesei), Gibberella (particularly G. moniliformis), Neurospora (particularly N. crassa), Maganaporthe (particularly M. grisea) or Hypocrea (particularly H. jecorina, H. atroviridis, H. virens or H. lixii).

In a preferred embodiment, the hydrophobin is obtained or obtainable from fungi of the genus Trichoderma (particularly T. harzianum, T. longibrichiatum, T. asperellum, T. Koningiopsis, T. aggressivum, T. stromaticum or T. reesei). In a particularly preferred embodiment, the hydrophobin is obtained or obtainable from fungi of the species T. reesei.

In a more preferred embodiment, the hydrophobin is the protein selected from the group consisting of:

(a) HFBII (SEQ ID NO: 2; obtainable from the fungus Trichoderma reesei);
(b) HFBI (SEQ ID NO: 4; obtainable from the fungus Trichoderma reesei);
(c) SC3 (SEQ ID NO: 6; obtainable from the fungus Schizophyllum commune);
(d) EAS (SEQ ID NO: 8; obtainable from the fungus Neurospora crassa); and
(e) TT1 (SEQ ID NO: 10; obtainable from the fungus Talaromyces thermophilus); or a protein having at least 70%, at least 75%, at least 80%, at least 85%, at least 90%, at least 91%, at least 92%, at least 93%, at least 94%, at least 95%, at least 96%, at least 97%, or at least 99% sequence identity in the hydrophobin core to any thereof.

In a more preferred embodiment, the hydrophobin is the protein encoded by the polynucleotide selected from the group consisting of:

(a) HFBII (SEQ ID NO: 1; obtainable from the fungus Trichoderma reesei);
(b) HFBI (SEQ ID NO: 3; obtainable from the fungus Trichoderma reesei);
(c) SC3 (SEQ ID NO: 5; obtainable from the fungus Schizophyllum commune);
(d) EAS (SEQ ID NO: 7; obtainable from the fungus Neurospora crassa); and
(e) TT1 (SEQ ID NO: 9; obtainable from the fungus Talaromyces thermophilus); or the protein encoded by a polynucleotide which is degenerate as a result of the genetic code to the polynucleotides defined in (a) to (e) above.

In an especially preferred embodiment, the hydrophobin is the protein “HFBII” (SEQ ID NO: 2; obtainable from Trichoderma reesei) or a protein having at least 70%, at least 75%, at least 80%, at least 85%, at least 90%, at least 91%, at least 92%, at least 93%, at least 94%, at least 95%, at least 96%, at least 97%, or at least 99% sequence identity in the hydrophobin core thereof.

In one embodiment, the hydrophobin may be present as an initial component of the composition. In another embodiment, the hydrophobin may be generated in situ in the composition (for example, by in situ hydrolysis of a hydrophobin fusion protein).

In an alternative embodiment, the hydrophobin may be replaced wholly or partially with a chaplin. Chaplins are hydrophobin-like proteins which are also capable of self-assembly at a hydrophobic-hydrophilic interface, and are therefore functional equivalents to hydrophobins. Chaplins have been identified in filamentous fungi and bacteria such as Actinomycetes and Streptomyces. Unlike hydrophobins, they may have only two cysteine residues and may form only one disulphide bridge. Examples of chaplins are described in WO 01/74864, US 2010/0151525 and US 2010/0099844 and in Talbot, Curr. Biol. 2003, 13, R696-R698.

### Lipolytic Enzyme

In this specification the term ‘lipolytic enzyme’ is defined as an enzyme capable of acting on a lipid substrate to liberate a free fatty acid molecule. Preferably, the lipolytic enzyme is an enzyme capable of hydrolysing an ester bond in a lipid substrate (particularly although not exclusively a triglyceride, a glycolipid and/or a phospholipid) to liberate a free fatty acid molecule. Examples of possible lipid substrate are described below.

The lipolytic enzyme used in the present invention preferably has activity on both non-polar and polar lipids. The term “polar lipids” as used herein means phospholipids and/or glycolipids. Preferably, the term “polar lipids” as used herein means both phospholipids and glycolipids. Polar and non-polar lipids are discussed in Eliasson and Larsson, “Cereals in Breadmaking: A Molecular Colloidal Approach”, publ. Marcel Dekker, 1993.

In particular, the lipolytic enzyme used in the present invention preferably has activity on the following classes of lipids: triglycerides; phospholipids, particularly but not exclusively phosphatidylcholine (PC) and/or N-acylphosphatidylethanolamine (APE); and glycolipids, particularly although not exclusively digalactosyl diglyceride (DGDG).

In this specification the term ‘free fatty acid’ means a compound of the formula R—C(═O)—OH wherein R is a straight- or branched chain, saturated or unsaturated, hydrocarbyl group, the compound having a total of 4 to 40 carbon atoms, preferably 6 to 40 carbon atoms, such as at least 10 to 40 carbon atoms, for example 12 to 40, such as 14 to 40, 16 to 40, 18 to 40, 20 to 40 or 22 to 40 carbon atoms, more preferably 10 to 24, especially 12 to 22, particularly 14 to 18, for example 16 or 18 carbon atoms. In one particular embodiment, such an acyl group is an alkanoyl group. Alternatively, such an acyl group comprises an alkenoyl group, which may have, for example, 1 to 5 double bonds, preferably 1, 2 or 3 double bonds.

Suitably, the lipolytic enzyme for use in the present invention may have one or more of the following activities selected from the group consisting of: phospholipase activity (such as phospholipase A1 activity (E.C. 3.1.1.32) or phospholipase A2 activity (E.C. 3.1.1.4); glycolipase activity (E.C. 3.1.1.26), triacylglycerol hydrolysing activity (E.C. 3.1.1.3), lipid acyltransferase activity (generally classified as E.C. 2.3.1.x in accordance with the Enzyme Nomenclature Recommendations (1992) of the Nomenclature Committee of the International Union of Biochemistry and Molecular Biology), and any combination thereof. Such lipolytic enzymes are well known within the art.

Suitably, the lipolytic enzyme for use in the present invention may be a phospholipase (such as a phospholipase A1 (E.C. 3.1.1.32) or phospholipase A2 (E.C. 3.1.1.4)); glycolipase or galactolipase (E.C. 3.1.1.26), triacylglyceride lipase (E.C. 3.1.1.3). Such enzyme may exhibit additional side activities such as lipid acyltransferase side activity.

Preferably, the lipolytic enzyme for use in the present invention has triacylglycerol hydrolysing activity (E.C. 3.1.1.3).

A lipolytic enzyme may be categorised as belonging to one of three classes (GX, GGGX or Y) based on structure and sequence analysis of the oxyanion hole of the enzyme.

A “GX lipolytic enzyme” is one where the oxyanion hole-forming residue X of the enzyme is structurally well conserved and is preceded by a strictly conserved glycine.

A “GGGX enzyme” is one where there is a well conserved GGG pattern, followed by a conserved hydrophobic amino acid X and the backbone amide of glycine preceding the residue X forms the oxyanion hole.

A “Y lipolytic enzyme” in one in which the oxyanion hole is not formed by a backbone amide but by the hydroxyl group of a tyrosine side chain.

In one aspect, the present invention relates to the use of a GX lipolytic enzyme.

Suitably, the oxyanion hole forming residue X may be M, Q, F, S, T, A, L or I. Preferably, the oxyanion hole forming residue X may be M, Q, F, S or T.

In one embodiment, the lipolytic enzyme may belong to one of the following alpha/beta hydrolase superfamilies abH23 (preferably abH23.01), abH25 (preferably 25.01), abH16 (preferably 16.01), abH18 (preferably abH18.01) and abH15 (preferably 15.01 or 15.02).

In one embodiment, the lipolytic enzyme may belong to one of the following alpha/beta hydrolase superfamilies abH23 (preferably abH23.01), abH25 (preferably 25.01), abH16 (preferably 16.01) and abH15 (preferably 15.02).

In one embodiment, preferably the lipolytic enzyme is classified as a member of the abH23 superfamily, preferably as a member of the abH23.01 homologous family in the Lipase Engineering Database.

Details regarding these superfamilies may be found on the Lipase Engineering Database (http://www.led.uni-stuttgart.de/). When referring to the Lipase Engineering database herein reference is made to version 3.0 of the database released on 10 Dec. 2009.

In particular, in one embodiment a lipolytic enzyme may be considered to belong to the abH23 superfamily if it is a GX lipolytic enzyme from a filamentous fungus. Preferably, a lipolytic enzyme is a GX lipolytic enzyme if the catalytic triad of the enzyme aligns with that of a lipase from Rhizopus miehei, such as swissprot P19515.

Examples of lipolytic enzymes belonging to the abH23 superfamily include those indicated in Table 2.

TABLE 2

| | | NCBI accession |
|---|---|---|
| | | code and version |
| | | number* OR gi |
| abH23 | Organism | number |
| abH23.01 | Arabidopsis thaliana | NP_197365.1 |
| (Rhizomucor miehei | | AAL24204.1 |
| lipase like) | | 42570528 |
| | | 145362642 |
| | Aspergillus awamori | BAA92937.3 |
| | | 84028205 |
| | Aspergillus clavatus | 121719262 |
| | Aspergillus flavus | 27525628 |
| | Aspergillus fumigatus | 70985264 |
| | | 70987066 |
| | Aspergillus nidulans | 67902118 |
| | | 67537354 |
| | Aspergillus niger | AAK60631.1 |
| | | O42807.1 |
| | | 1UWC_A |
| | | 2HL6_A |
| | | 1USW_A |
| | | 2BJH_A |
| | | 145252728 |
| | | 110431975 |
| | | 145241772 |
| | | 109677003 |
| | | 145251976 |
| | | 110431973 |
| | Aspergillus oryzae | 83766610 |
| | | 169771817 |
| | | 169768448 |
| | | 169780130 |
| | | 169774351 |
| | | BAA12912.1 |
| | Aspergillus parasiticus | 27525626 |
| | Aspergillus tamarii | 124108031 |
| | Aspergillus terreus | 115402833 |
| | | 115385463 |
| | | 115400761 |
| | | 115443274 |
| | Aspergillus tubingensis | O42815.1 |
| | Brugia malayi | 170592511 |
| | Caenorhabditis briggsae | 157761233 |
| | | 157761241 |
| | | 157755883 |
| | | 157771698 |
| | | 157763172 |
| | | 157747253 |
| | | 157759179 |
| | | 157759177 |
| | | 157772997 |
| | | 157773105 |
| | | 157773031 |
| | | 157774613 |
| | | 157774617 |
| | | 157772605 |
| | | 157774619 |
| | | 157774601 |
| | Caenorhabditis elegans | 115534096 |
| | | 17552584 |
| | | 71983228 |
| | | 71983230 |
| | | 71983236 |
| | | 193207843 |
| | | 115534067 |
| | | 158518185 |
| | | 86575143 |
| | | 115534303 |
| | | 72000668 |
| | | AAF60431.2 |
| | | 71994497 |
| | | T27056 |
| | | 71994547 |
| | | CAB61137.3 |
| | | 193247829 |
| | Chaetomium globosum | 116206442 |
| | Cyanobium sp. | 197627310 |
| | Cyanothece sp. | 172037675 |
| | | 177663915 |
| | | 196246404 |
| | Dictyostelium discoideum | 60463496 |
| | | 66825791 |
| | | AAM43784.1 |
| | Dictyostelium discoideum | 66802624 |
| | AX4 | |
| | Fusarium oxysporum | 148791375 |
| | Gibberella zeae | 33621223 |
| | | 46123057 |
| | Magnaporthe grisea | 39978263 |
| | Nectria haematococca | CAC19602.1 |
| | Neosartorya fischeri | 119499143 |
| | | 119480389 |
| | Neurospora crassa | CAC28687.1 |
| | Neurospora crassa OR74A | EAA32130.1 |
| | Oryza sativa | 115463525 |
| | | 125552085 |
| | | 125577937 |
| | | 115486491 |
| | | 115473965 |
| | | 125586239 |
| | | 125543854 |
| | | 125535166 |
| | | 125559538 |
| | | 115442095 |
| | | 115453007 |
| | | BAB64204.1 |
| | | 125529023 |
| | Penicillium allii | 31872092 |
| | Penicillium camemberti | P25234 |
| | | 1TIA |
| | | 1TIA_A |
| | Penicillium cyclopium | 48429006 |
| | | AAF82375.1 |
| | Penicillium expansum | AAG22769.1 |
| | Phaeosphaeria nodorum | 169595748 |
| | | 169606904 |
| | Physcomitrella patens | 168020609 |
| | | 168040480 |
| | | 168037728 |
| | Podospora anserina | 171693635 |
| | Populus trichocarpa | 118482274 |
| | Pyrenophora tritici-repentis | 189192516 |
| | | 189202058 |
| | Rhizomucor miehei | P19515.2 |
| | | 3TGL |
| | | 5TGL |
| | | 4TGL |
| | | 1TGL |
| | | 5TGL_A |
| | | 4TGL_A |
| | | 1TGL_A |
| | | 3TGL_A |
| | Rhizopus arrhizus | 1TIC_A |
| | | AAF32408.1 |
| | | 1TIC_B |
| | Rhizopus javanicus | 73621144 |
| | Rhizopus microsporus | 156470335 |
| | | 166078592 |
| | Rhizopus niveus | P21811 |
| | | 1LGY_A |
| | | BAA31548.1 |
| | | 1LGY_B |
| | | 1LGY_C |
| | Rhizopus oryzae | AAS84458.1 |
| | | P61872.1 |
| | | 1TIC_A |
| | | 94962082 |
| | | 71390109 |
| | Rhizopus stolonifer | AAZ66864.1 |
| | Synechococcus sp. | 87301494 |
| | Thermomyces lanuginosus | O59952.1 |
| | | 1TIB |
| | | 1DTE_A |
| | | 1DT5_D |
| | | 1DU4_B |
| | | 1DT3_A |
| | | 1EIN_B |
| | | 1DT3_B |
| | | 1DT5_E |
| | | 1DT5_B |
| | | 1DT5_G |
| | | 1DT5_F |
| | | 1DT5_H |
| | | 1DT5_A |
| | | 1DT5_C |
| | | 1DTE_B |
| | | 1DU4_A |
| | | 1DU4_D |
| | | 1DU4_C |
| | | 1EIN_C |
| | | 1EIN_A |
| | | 1GT6_A |
| | Triticum aestivum | CAD32696.1 |
| | | CAD32695.1 |
| | Vitis vinifera | 157336329 |
| | Zea mays | 194691896 |
| | | 194690642 |
| | | 194706432 |
| | | 194694588 |
| | | 194694210 |

In this embodiment, preferably the oxyanion hole forming residue is a serine or threonine.

Preferably, the lipolytic enzyme belongs to the Rhizopus miehei like homologous family abH23.01. Suitably, particularly preferred enzymes for use in the present invention may include any lipolytic enzymes classified in homologous family abH23.01 from Thermomyces (preferably, T. lanuginosus), Fusarium (preferably F. hetereosporum), Aspergillus (preferably A. tubiengisis and/or A. fumigatus) and Rhizopus (preferably, R. arrihzus), preferably from Thermomyces (preferably, T. lanuginosus), Fusarium (preferably F. hetereosporum), or Aspergillus (preferably A. tubiengisis). Examples of such lipolytic enzymes include LIPEX™ (a Thermomyces lanuginosus lipolytic enzyme disclosed in WO 94/02617 and shown herein as SEQ ID NO: 11, the Fusarium heterosporum lipolytic enzyme disclosed in WO 2005/087918 and shown herein as SEQ ID NO: 13 (available from Danisco A/S as Grindamyl POWERBAKE 4100™) and Lipase 3 (an Aspergillus tubigensis lipolytic enzyme disclosed in WO 98/45453 and shown herein as SEQ ID NO: 14).

In one embodiment of the present invention, a lipolytic enzyme may be considered to belong to the abH25 superfamily if the catalytic triad aligns with that of the Moraxella lipase 1 like lipolytic enzyme as shown in the swissprot protein knowledge base (http://www.expasy.org/sprot/ and http:/www.ebi.ac.uk/swissprot/) under accession number P19833—version of 26 Jul. 2005.

Examples of lipolytic enzymes belonging to this family include those listed in Table 3.

TABLE 3

| | | NCBI accession code |
|---|---|---|
| | | and version number* |
| abH25 | Organism | OR gi number |
| abH25.01 | Acidovorax delafieldii | BAB86909.1 |
| (Moraxella lipase | Kineococcus radiotolerans | 152967773 |
| 1 like) | Kineococcus radiotolerans | EAM75386.1 |
| | SRS30216 | |
| | Moraxella sp. | P19833.1 |
| | Streptomyces albus | AAA53485.1 |
| | Streptomyces ambofaciens | 117164910 |
| | Streptomyces coelicolor | AAD09315.1 |
| | | CAB69685.1 |
| | Streptomyces exfoliatus | 1JFR_B |
| | | 1JFR_A |
| | Streptomyces griseus | 182439251 |
| | Thermobifida fusca | 72161287 |
| | | 72161286 |
| | Thermobifida fusee | CAH17553.1 |
| | DSM 43793 | CAH17554.1 |

In this embodiment, preferably the oxyanion hole forming residue is M, Q, A, F, L or I.

In one embodiment of the present invention, a lipolytic enzyme may be considered to belong to the abH16 superfamily if the catalytic triad aligns with that of Streptomyces.

Examples of lipolytic enzymes belonging to this family include those indicated in Table 4.

TABLE 4

| | | NCBI accession code |
|---|---|---|
| | | and version number* |
| abH16 | Organism | OR gi number |
| abH16.01 (Streptomyces | Arthrobacter chlorophenolicus | 169176591 |
| lipases) | Arthrobacter sp. FB24 | 116669612 |
| | Corynebacterium diphtheriae | 38232746 |
| | Corynebacterium efficiens | 25026650 |
| | | 25026649 |
| | Corynebacterium efficiens YS-314 | BAC16904.1 |
| | | BAC16903.1 |
| | Corynebacterium glutamicum | 19551331 |
| | | 145294142 |
| | | 19551330 |
| | | 145294141 |
| | Frankia sp. | 158312565 |
| | Frankia sp. EAN1pec | EAN12331.1 |
| | Nocardia farcinica | 54025580 |
| | Nocardioides sp. | 119715399 |
| | Nocardioides sp. JS614 | EA007564.1 |
| | Propionibacterium acnes | 50843543 |
| | | 50843256 |
| | Propionibacterium acnes P-37 | CAA67627.1 |
| | Rhodococcus sp. | 111021394 |
| | | 111024112 |
| | | 111025204 |
| | | 111025876 |
| | | 111022422 |
| | | 111024917 |
| | | 40787231 |
| | Rubrobacter xylanophilus | 108805093 |
| | Rubrobacter xylanophilus DSM 9941 | EAN36909.1 |
| | Streptomyces avermitilis | 29833101 |
| | Streptomyces avermitilis MA-4680 | BAC74270.1 |
| | Streptomyces cinnamoneus | AAB71210.1 |
| | Streptomyces coelicolor | NP606008 |
| | Streptomyces fradiae | 148832709 |
| | Streptomyces griseus | 182439565 |
| | Streptomyces pristinaespiralis | YP002199726 |
| | Streptomyces sp. | 197333608 |
| | Streptomyces sviceus | 197781872 |
| | Synthetic construct | AAO92397.1 |

In this embodiment, preferably the oxyanion hole forming residue is T or Q.

In one embodiment of the present invention, a lipolytic enzyme may be considered to belong to the abH15 superfamily if the catalytic triad aligns with that of a GX Burkholderia lipase.

Examples of lipolytic enzymes belonging to this family include those indicated in Table 5 and LIPOMAX as shown herein as SEQ ID NO: 15.

TABLE 5

| | | NCBI |
|---|---|---|
| | | accession |
| | | code and |
| | | version |
| | | number* OR gi |
| abH15 | Organism | number |
| abH15.02 | Acidovorax avenae | 120612825 |
| (Burkholderia | Acinetobacter baumannii | 169794515 |
| cepacia | | 126643175 |
| lipase like) | | 193078538 |
| | | 158517002 |
| | Acinetobacter calcoaceticus | AAD29441.1 |
| | Acinetobacter schindleri | 158120326 |
| | | 158120327 |
| | Acinetobacter sp. | 50086294 |
| | Acinetobacter sp. SY-01 | AAP44577.1 |
| | Aeromonas hydrophila | 117618653 |
| | Aeromonas salmonicida | 145300587 |
| | Alcanivorax borkumensis | 110834836 |
| | Alcanivorax sp. | 196194968 |
| | | 196193133 |
| | Alteromonas macleodii | 88795738 |
| | Azotobacter vinelandii AvOP | EAM05214.1 |
| | Burkholderia ambifaria | 115358044 |
| | | 118695660 |
| | | 171316092 |
| | | 170702796 |
| | | 171320247 |
| | Burkholderia cenocepacia | 124875244 |
| | | 107026795 |
| | | 118713500 |
| | | 84354072 |
| | | 198038844 |
| | | 190607421 |
| | Burkholderia cenocepacia AU 1054 | EAM08623.1 |
| | Burkholderia cenocepacia HI2424 | EAM18550.1 |
| | Burkholderia cepacia | AAY86757.2 |
| | | 116739150 |
| | | 161406799 |
| | | 1OIL_B |
| | | 1HQD_A |
| | | 4LIP_D |
| | | P22088.2 |
| | | 1OIL_A |
| | | 4LIP_E |
| | | 1YS2_X |
| | Burkholderia cepacia KCTC 2966 | AAT85572.1 |
| | Burkholderia cepacia R1808 | 46319469 |
| | | 46319468 |
| | Burkholderia cepacia R18194 | 46312540 |
| | Burkholderia cepacia ST-200 | BAD13379.1 |
| | Burkholderia dolosa | 84360313 |
| | Burkholderia glumae | 1TAH_A |
| | | 1TAH_C |
| | | 1TAH_B |
| | | 1TAH_D |
| | | 1QGE_E |
| | | 2ES4_A |
| | Burkholderia mallei | 83618505 |
| | | 53715898 |
| | | 83618339 |
| | | 167003692 |
| | Burkholderia mallei 10399 | 67636935 |
| | | 67635666 |
| | Burkholderia mallei FMH | 69987887 |
| | Burkholderia mallei GB8 horse 4 | 67640408 |
| | | 67642620 |
| | Burkholderia mallei JHU | 70001349 |
| | Burkholderia mallei NCTC 10247 | 67645935 |
| | Burkholderia multivorans | 161521210 |
| | | 161525117 |
| | Burkholderia multivorans RG2 | AAW30196.1 |
| | Burkholderia multivorans Uwc 10 | AAZ39650.1 |
| | Burkholderia oklahomensis | 167573565 |
| | | 167568063 |
| | | 167567050 |
| | | 167574127 |
| | Burkholderia pseudomallei | 53722762 |
| | | 126445060 |
| | | 99911132 |
| | | 100126424 |
| | | 167915815 |
| | | 126442397 |
| | | 157806477 |
| | | 134281779 |
| | | 76818459 |
| | | 100231475 |
| | | 99908515 |
| | | 100059930 |
| | | 53723336 |
| | | 100121879 |
| | | 167744369 |
| | | 184212969 |
| | | 167908322 |
| | | 167725450 |
| | Burkholderia pseudomallei 1655 | 67671904 |
| | | 67670022 |
| | Burkholderia pseudomallei 1710a | 67684997 |
| | | 67681352 |
| | Burkholderia pseudomallei 668 | 67735159 |
| | Burkholderia pseudomallei Pasteur | 67755633 |
| | | 67753658 |
| | Burkholderia pseudomallei S13 | 67759470 |
| | Burkholderia sp. 383 | 78063020 |
| | Burkholderia sp. HY-10 | 154091354 |
| | Burkholderia sp. 99-2-1 | AAV34204.1 |
| | Burkholderia sp. MC16-3 | AAV34203.1 |
| | Burkholderia thailandensis | 83717248 |
| | | 167577201 |
| | | 83716483 |
| | | 167579206 |
| | | 167617325 |
| | | 167840423 |
| | Burkholderia ubonensis | 167583926 |
| | Burkholderia vietnamiensis | 134293086 |
| | | 134293087 |
| | Burkholderia vietnamiensis G4 | EAM26790.1 |
| | | 67548784 |
| | | EAM26789.1 |
| | Chromobacterium violaceum | 34498169 |
| | Chromobacterium violaceum ATCC | AAQ60384.1 |
| | 12472 | |
| | Burkholderia glumae | 1CVL_A |
| | Cupriavidus taiwanensis | 194289366 |
| | Dehalococcoides sp. | 163813742 |
| | Gamma proteobacterium | 198262110 |
| | | 198262137 |
| | Hahella chejuensis | 83646958 |
| | Listonella anguillarum | 197313280 |
| | Listonella anguillarum M93Sm | AAY26146.2 |
| | Marinobacter algicola | 149376115 |
| | | 149378244 |
| | Marinomonas sp. | 87119903 |
| | Moritelle sp. | 149908369 |
| | | 149911484 |
| | | 149909327 |
| | Myxococcus xanthus | 108756922 |
| | Oceanobacter sp. | 94500183 |
| | | 94501726 |
| | Photobacterium profundum | 90409701 |
| | | 54303612 |
| | Photobacterium profundum ss9 | CAG23805.1 |
| | Photobacterium sp. | 89072072 |
| | Plesiocystis Pacifica | 149921436 |
| | Proteus mirabilis | 197284877 |
| | Proteus sp. | 184191073 |
| | Proteus vulgaris | AAB01071.1 |
| | Pseudomonas aeruginosa | AAC34733.1 |
| | | P26876.2 |
| | | BAA09135.1 |
| | | AAF64156.1 |
| | | BAA23128.1 |
| | | 1EX9_A |
| | | 107102411 |
| | | 152989672 |
| | | 152983830 |
| | Pseudomonas aeruginosa | AAT85570.1 |
| | KCTC 1637 | |
| | Pseudomonas entomophila | 104783837 |
| | Pseudomonas fluorescens | 77456799 |
| | | 77459293 |
| | | AAC15585.1 |
| | | 70734119 |
| | Pseudomonas fluorescens PfO-1 | 23058245 |
| | | 23061908 |
| | Pseudomonas fragi | CAC07191.1 |
| | | P08658.2 |
| | | AAA25879.1 |
| | Pseudomonas luteola | AAC05510.1 |
| | Pseudomonas mendocina | 146307587 |
| | | 146306794 |
| | | AAM14701.1 |
| | Pseudomonas putida | 167035900 |
| | | 119858840 |
| | | 170723807 |
| | | 26991534 |
| | | 148549934 |
| | Pseudomonas putida KT2440 | AAN70423.1 |
| | Pseudomonas sp. | 4LIP_E |
| | | 189178711 |
| | | 189178713 |
| | Pseudomonas sp. 109 | P26877.1 |
| | Pseudomonas sp. KFCC10818 | AAD22078.1 |
| | Pseudomonas sp. KWI-56 | P25275.1 |
| | Pseudomonas sp. SW-3 | AAG47649.2 |
| | Pseudomonas stutzeri | 146282376 |
| | Pseudomonas wisconsinensis | AAB53647.1 |
| | Psychrobacter cryohalolentis | 93005273 |
| | Psychrobacter cryohalolentis K5 | EAO10600.1 |
| | Psychrobacter sp. | 148652775 |
| | Ralstonia eutropha | 113867341 |
| | Ralstonia metallidurans | 22979988 |
| | Ralstonia pickettii | 153885935 |
| | | 121531370 |
| | Ralstonia sp. M1 | AAR13272.1 |
| | Rhodoferax ferrireducens | 89902127 |
| | Shewanella denitrificans | 91792458 |
| | Shewanella denitrificans OS-217 | 69944965 |
| | Shewanella denitrificans OS217 | EAN69301.1 |
| | Shewanella frigidimarina | 114564999 |
| | Shewanella frigidimarina | EAN74111.1 |
| | NCIMB 400 | |
| | Shewanella woodyi | 118073371 |
| | Sorangium cellulosum | 162451743 |
| | Synthetic construct | AAT51282.1 |
| | | AAT51165.1 |
| | Vibrio alginolyticus | 91225988 |
| | Vibrio angustum | 90580697 |
| | Vibrio campbellii | 163801151 |
| | Vibrio cholerae | P15493.2 |
| | | AAA17487.1 |
| | | 150423294 |
| | | 116219797 |
| | | 153801593 |
| | | 153215150 |
| | | 116214571 |
| | Vibrio cholerae MO10 | 75830993 |
| | Vibrio cholerae RC385 | 75821182 |
| | Vibrio cholerae V51 | 75819240 |
| | Vibrio cholerae V52 | 75816524 |
| | Vibrio harveyi | 156974975 |
| | | 153834178 |
| | Vibrio parahaemolyticus | 28897955 |
| | | 153837472 |
| | Vibrio shilonii | 149187907 |
| | Vibrio sp. | 116184955 |
| | | 86144587 |
| | Vibrio sp. Ex25 | 75855688 |
| | Vibrio splendidus | 84385385 |
| | Vibrio vulnificus | 37680174 |
| | | 27365668 |
| | Vibrio vulnificus CKM-1 | AAQ04476.1 |
| | Vibrio vulnificus CMCP6 | AAO10723.1 |
| | Vibrionales bacterium | 148974047 |
| | Xylella fastidiosa | 22996002 |
| | | 28198381 |
| | Xylella fastidiosa Ann-1 | EAO31309.1 |
| | Xylella fastidiosa Temecula1 | AAO28344.1 |
| | Yersinia enterocolitica | 123442125 |
| | Yersinia mollaretii ATCC 43969 | 77961583 |
| abH15.01 | Ailuropoda metanoleuca | 62511068 |
| (Staphylococcus | Alouatta seniculus | 58339172 |
| aureus lipase | | 58339174 |
| like) | | 58339176 |
| | | 58339178 |
| | | 58339180 |
| | Arabidopsis thaliana | AAF17667.1 |
| | | AAF87012.1 |
| | | D86367 |
| | | 26451003 |
| | | AAD31339.1 |
| | | 42571431 |
| | Ateles geoffroyi | 18462512 |
| | | 18462514 |
| | Bacillus anthracis | 30262592 |
| | Bacillus anthracis Ames | AAP26455.1 |
| | Bacillus cereus | 52142888 |
| | | 42781684 |
| | | 168139359 |
| | | 168134190 |
| | | 167938472 |
| | | 168158861 |
| | | 166993225 |
| | | 196043618 |
| | | 196040277 |
| | Bacillus cereus G9241 | EAL12983.1 |
| | Bacillus sp. 42 | AAV35102.1 |
| | Bacillus sp. L2 | AAW47928.1 |
| | Bacillus sp. TP10A.1 | AAF63229.1 |
| | Bacillus sp. Tosh | AAM21775.1 |
| | Bacillus thuringiensis | 75764133 |
| | | 49477789 |
| | | 118477999 |
| | Bacillus thuringiensis | EAO51633.1 |
| | ATCC 35646 | |
| | Bacillus weihenstephanensis | 163940476 |
| | Balaenoptera borealis | 0812180A |
| | Balaenoptera physalus | 55583872 |
| | | 1104245A |
| | Bos frontalis | 164597876 |
| | | 116256079 |
| | Bos grunniens | 62511051 |
| | | 119675392 |
| | Bos indicus | 2708611 |
| | | 6063098 |
| | | 164597854 |
| | Bos taurus | 83416245 |
| | | 83416247 |
| | | 30794288 |
| | | 134244277 |
| | | 164597862 |
| | | 83416249 |
| | | 59797396 |
| | | 126632213 |
| | Bubalus bubalis | 6063096 |
| | | 83416241 |
| | | 60651145 |
| | | 13431890 |
| | | 296143 |
| | Callicebus moloch | 58339182 |
| | | 58339184 |
| | | 58339188 |
| | Callithrix jacchus | 17368913 |
| | | 21449837 |
| | | 21449839 |
| | Camelus dromedarius | 62511040 |
| | | 126567081 |
| | Canis lupus | 312196 |
| | | 50978904 |
| | Capra hircus | 190683030 |
| | | 83416243 |
| | | 155183991 |
| | | 6063094 |
| | | 1510157A |
| | | 60687495 |
| | | 126632219 |
| | Cavia porcellus | 62511092 |
| | | 7677454 |
| | Cebus albifrons | 116634246 |
| | Cervus elaphus | 3024641 |
| | | 70909960 |
| | Cloning vector | 12584848 |
| | Clostridium botulinum | 153941353 |
| | | 168178255 |
| | | 187932762 |
| | | 168179769 |
| | | 153940345 |
| | | 168185824 |
| | | 170759344 |
| | | 188588446 |
| | | 168186291 |
| | | 170756926 |
| | | 148380018 |
| | | 170758348 |
| | | 168183734 |
| | | 188590654 |
| | | 187935767 |
| | | 188587698 |
| | | 148378855 |
| | | 168184078 |
| | | 170757848 |
| | Clostridium novyi | 118443364 |
| | | 118443211 |
| | Clostridium sporogenes | 187777968 |
| | | 187779336 |
| | Clostridium tetani | 28210658 |
| | Clostridium tetani Massachusetts | AAO35539.1 |
| | Deinococcus radiodurans | C75533 |
| | Delphinus delphis | 62511070 |
| | Elephantidae gen. | 1509285A |
| | Equus caballus | 126352373 |
| | | 1709310A |
| | | 156723467 |
| | | 56786671 |
| | | 168693409 |
| | | 197941001 |
| | | 111606634 |
| | | 111606636 |
| | Felis catus | 57163879 |
| | | 567042 |
| | Galago senegalensis | 17368901 |
| | Geobacillus kaustophilus | 56420521 |
| | Geobacillus sp. (Strain T1) | 67906830 |
| | | JC8061 |
| | Geobacillus sp. T1 | AAO92067.2 |
| | Geobacillus stearothermophilus | AAF40217.1 |
| | | 1JI3_B |
| | | 1JI3_A |
| | | AAL28099.1 |
| | | 117373028 |
| | | JW0068 |
| | | 1KU0_A |
| | | 1KU0_B |
| | | AAX11388.1 |
| | Geobacillus thermocatenulatus | CAA64621.1 |
| | Geobacillus thermoleovorans | AAD30278.1 |
| | | 113431924 |
| | | AAM21774.1 |
| | | 83939852 |
| | Geobacillus thermoleovorans IHI-91 | AAN72417.1 |
| | Geobacillus zalihae | 110265150 |
| | | 2DSN_A |
| | | 2Z5G_A |
| | Giraffa camelopardalis | 62511039 |
| | Hippopotamus amphibius | 62511038 |
| | Homo sapiens | 1AXI_A |
| | | 1HGU_A |
| | | 1KF9_A |
| | | 711074A |
| | | 10334861 |
| | | 4503083 |
| | | 1Z7C_A |
| | | 34784701 |
| | | 181127 |
| | | 731144A |
| | | 36544 |
| | | 12545376 |
| | | 12545381 |
| | | 13027812 |
| | | 1HWG_A |
| | | 119614650 |
| | | 47121568 |
| | | 3HHR_A |
| | | 47121579 |
| | | 1HWH_A |
| | | 1403262B |
| | | 31905 |
| | | 119614648 |
| | | 13027814 |
| | | 1403262A |
| | | 13027816 |
| | | 4503991 |
| | | 49456759 |
| | | 49456803 |
| | | 183177 |
| | | 119614662 |
| | | 13027822 |
| | | 119614661 |
| | | 119614666 |
| | Lactobacillus casei CL96 | AAP02960.1 |
| | Lama pacos | 110338953 |
| | | 586010 |
| | Loxodonta africana | 134706 |
| | Macaca assamensis | 53854158 |
| | | 54124352 |
| | | 53854163 |
| | | 53854165 |
| | Macaca mulatta | 112293303 |
| | | 293111 |
| | | 112293293 |
| | | 68136596 |
| | | 114052777 |
| | | 114052717 |
| | | 114052929 |
| | | 112293289 |
| | | 112293299 |
| | | 68136594 |
| | | 2500855 |
| | | 109116855 |
| | | 109149084 |
| | | 109148991 |
| | Mesocricetus auratus | 586012 |
| | Monodelphis domestica | 74136533 |
| | Mus musculus | 6679997 |
| | | 4096656 |
| | Nannospalax ehrenbergi | 62510957 |
| | Neovison vison | 134709 |
| | | 46849215 |
| | | 164254 |
| | Nomascus leucogenys | 53854131 |
| | | 53854129 |
| | | 53854133 |
| | | 53854135 |
| | | 53854137 |
| | | 53854139 |
| | Nycticebus pygmaeus | 17368910 |
| | Oryctolagus cuniculus | 1174399 |
| | Oryza sativa | 115463847 |
| | | 125552313 |
| | Ovis aries | 94183527 |
| | | 94406690 |
| | | 94183483 |
| | | 94183519 |
| | | 155001235 |
| | | 94183467 |
| | | 1666694 |
| | | 94183402 |
| | | 94183398 |
| | | 94183424 |
| | | 126632207 |
| | | 94183444 |
| | | 1805146A |
| | | 94183426 |
| | | 94183523 |
| | | 1005182A |
| | | 94183400 |
| | | 94183511 |
| | | 94183410 |
| | | 126632211 |
| | | 94183452 |
| | | 165887 |
| | | 116735158 |
| | | 94183438 |
| | | 57527824 |
| | | 94183495 |
| | | 94183507 |
| | | 94183515 |
| | | 94183475 |
| | | 126632209 |
| | | 94183420 |
| | | 94183432 |
| | | 83955026 |
| | | 94183430 |
| | Paenibacillus larvae | 167465325 |
| | Pan troglodytes | 20140016 |
| | | 20140015 |
| | | 114669972 |
| | | 114669970 |
| | | 114669980 |
| | | 114669998 |
| | | 114669984 |
| | | 114669978 |
| | | 114669976 |
| | | 114669996 |
| | | 114669982 |
| | | 114670000 |
| | | 114669918 |
| | | 114669948 |
| | | 114669944 |
| | | 114669938 |
| | | 57113881 |
| | | 114669920 |
| | | 114669930 |
| | | 114669994 |
| | | 114669992 |
| | | 114669990 |
| | | 114670016 |
| | | 114670014 |
| | | 55645705 |
| | | 114669905 |
| | | 114669936 |
| | | 57113891 |
| | | 114669942 |
| | | 114669934 |
| | | 114669940 |
| | | 57113885 |
| | | 28188745 |
| | | 114669915 |
| | | 114669922 |
| | | 114669932 |
| | | 114670004 |
| | Physcomitrella patens | 162691248 |
| | Pithecia pithecia | 58339190 |
| | | 58339192 |
| | | 58339195 |
| | Pygathrix nemaeus | 53854141 |
| | | 54124350 |
| | | 53854146 |
| | | 53854148 |
| | Rattus norvegicus | 134717 |
| | | 77861910 |
| | | 149054569 |
| | | 149054567 |
| | Rhinopithecus roxellana | 53854150 |
| | | 53854152 |
| | | 53854154 |
| | | 53854156 |
| | Saimiri boliviensis | 17368174 |
| | Shuttle vector | 2342750 |
| | Staphylococcus aureus | 153104 |
| | | 88193885 |
| | | 1314205A |
| | | 49482354 |
| | | 57652458 |
| | | 83682315 |
| | | 120864890 |
| | | 83682355 |
| | | 586027 |
| | | 83682335 |
| | | 15923101 |
| | | 154736704 |
| | | 83682395 |
| | | 83682375 |
| | | 83682371 |
| | | 120864986 |
| | | 120865151 |
| | | 83682327 |
| | | 120865143 |
| | | 120864794 |
| | | 120865004 |
| | | 120864887 |
| | | 120865236 |
| | | 46695 |
| | | 82750020 |
| | | 154736702 |
| | | 120865077 |
| | | 83682365 |
| | | 83682377 |
| | | 120865094 |
| | | 120865232 |
| | | 83682345 |
| | | 120865140 |
| | | 83682333 |
| | | 83682369 |
| | | 83682331 |
| | | 83682339 |
| | | 120865030 |
| | | 120864975 |
| | | 120865101 |
| | | 120865021 |
| | | 83682311 |
| | | 151220267 |
| | | 148266538 |
| | | 133853458 |
| | | 83682383 |
| | | 189169989 |
| | | 161508379 |
| | | 120864978 |
| | | 1905280A |
| | | 83682307 |
| | | 21281813 |
| | | 83682309 |
| | | 83682363 |
| | | 83682397 |
| | | 120864800 |
| | | 120865183 |
| | | 120864824 |
| | | 154736696 |
| | | 83682379 |
| | | 120864797 |
| | | 120864834 |
| | | 83682337 |
| | | 120865080 |
| | | 83682389 |
| | | 154736698 |
| | | 154736692 |
| | | 120865123 |
| | | 83682385 |
| | | 83682359 |
| | | 83682351 |
| | | BAB96455.1 |
| | | BAB43769.1 |
| | | S68970 |
| | | AAD52059.1 |
| | | P65289.2 |
| | | 57651062 |
| | | 84028218 |
| | | P10335.1 |
| | | AAK29127.1 |
| | | B89797 |
| | | 87162130 |
| | | 21282026 |
| | | 57651244 |
| | | 148266743 |
| | | 158347635 |
| | | 49484866 |
| | | 84029334 |
| | | 49482552 |
| | | 1480567 |
| | | 82752249 |
| | Staphylococcus aureus MW2 | Q8NYC2.1 |
| | Staphylococcus aureus Mu50 | Q99QX0 |
| | Staphylococcus carnosus | 643453 |
| | | 643451 |
| | Staphylococcus epidermidis | 27467103 |
| | | 193888386 |
| | | Q02510 |
| | | 82654954 |
| | | AAC38597.1 |
| | | AAC67547.1 |
| | | 57865775 |
| | | 57865971 |
| | | 27469321 |
| | | 27467163 |
| | | 57865673 |
| | Staphylococcus epidermidis 9 | AAA19729.1 |
| | Staphylococcus epidermidis ATCC | AAO06046.1 |
| | 12228 | AAO03782.1 |
| | | AAO03878.1 |
| | | AAO03842.1 |
| | Staphylococcus haemolyticus | 70725169 |
| | | AAF21294.1 |
| | Staphylococcus hyicus | 2HIHA_A |
| | | P04635.1 |
| | Staphylococcus saprophyticus | AAT34964.1 |
| | | 73663604 |
| | | 73661811 |
| | Staphylococcus simulans | CAC83747.1 |
| | Staphylococcus warneri | AAG35723.1 |
| | | BAD90561.1 |
| | | BAD90565.1 |
| | | BAD90562.1 |
| | Staphylococcus xylosus | 551988 |
| | | 551987 |
| | | AAG35726.1 |
| | | 52854061 |
| | Streptococcus sp. | 124268 |
| | | 47072 |
| | Sus scrofa | 46361729 |
| | | 164478 |
| | | 166835929 |
| | | 57233311 |
| | | 1608112A |
| | | 1312298A |
| | | 57233313 |
| | | 57233321 |
| | | 47523120 |
| | | 912486 |
| | Synthetic construct | 33341802 |
| | | 6671284 |
| | | 14582904 |
| | | 60810119 |
| | | 61364449 |
| | | 60827412 |
| | | 60815489 |
| | | 30584141 |
| | | 60655785 |
| | | 6671282 |
| | Tragulus javanicus | 12964200 |
| | | 12964198 |
| | Trichosurus vulpecula | 3915004 |
| | Uncultured bacterium | 145965989 |
| | Uncultured bacterium | 145965991 |
| | Vitis vinifera | 157329819 |
| | Vulpes lagopus | 158346762 |
| | | 166343814 |
| | | JS0429 |
| | Vulpes vulpes | 134722 |

Throughout the specification examples of enzymes falling into a particular superfamily and/or homologous family in accordance with the Lipase Engineering Database version 3.0 are provided. In one embodiment of the present invention, the lipolytic enzyme of the present invention may be selected from any one or more of the lipolytic enzymes in these exemplified groups.

In another embodiment, the lipolytic enzyme for use in the present invention may be from one or more of the following genera: Thermomyces (preferably T. lanuginosus), Thermobifida (preferably, T. fusca), Pseudomonas (preferably P. alcaligenes) and Streptomyces (preferably S. pristinaespiralis).

Suitably, the lipolytic enzyme may comprise one of more of the following amino acid sequences:
a) SEQ ID NO: 11;
b) SEQ ID NO: 15;
c) SEQ ID NO: 16;
d) SEQ ID NO: 17;
e) an amino acid sequence having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to any one of the amino acid sequences defined in a) to d); or
f) an amino acid sequence as set forth in any one of a) to d) except for one or several modifications (i.e. deletions, substitutions and/or insertions), such as 2, 3, 4, 5, 6, 7, 8, 9 amino acid modifications, or more amino acid modifications such as 10 and having lipolytic enzyme activity.

Suitably, the lipolytic enzyme may belong to the abH 15 superfamily, preferably the abH 15.01 superfamily.

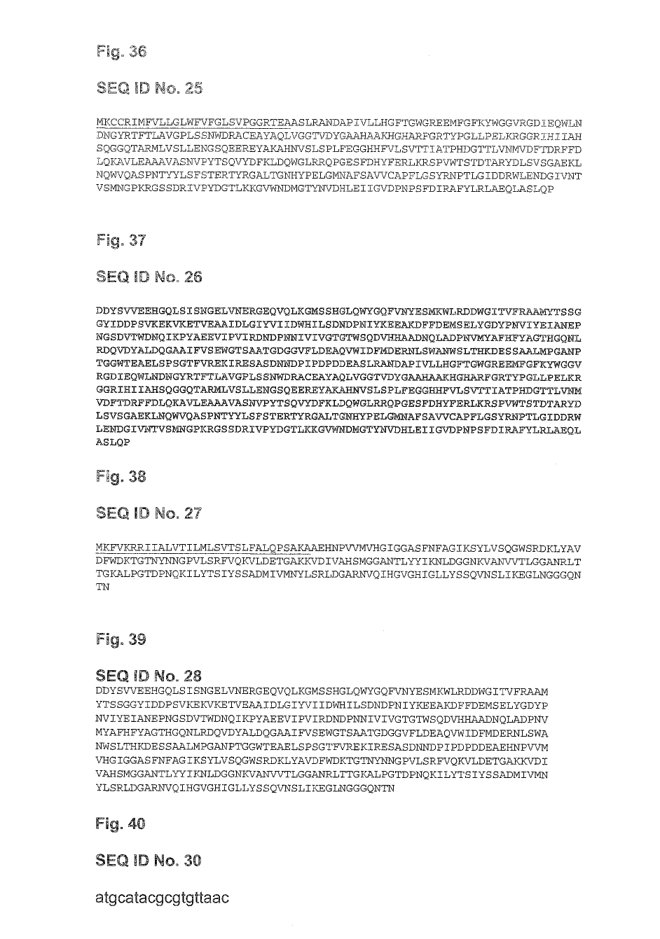

Suitably, the lipolytic enzyme may comprise one of more of the following amino acid sequences
a) SEQ ID NO. 25;
b) SEQ ID NO: 26;
c) SEQ ID NO. 25 lacking the signal peptide as indicated in FIG. 36;
d) an amino acid sequence having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to any one of the amino acid sequences defined in a) to c); or
e) an amino acid sequence as set forth in any one of a) to c) except for one or several modifications (i.e. deletions, substitutions and/or insertions), such as 2, 3, 4, 5, 6, 7, 8, 9 amino acid modifications, or more amino acid modifications such as 10 and having lipolytic enzyme activity.

Suitably, the lipolytic enzyme may comprise a lipase cloned from Geobacillus species, preferably G stearothermophilus strain T1 (GeoT1), such as that shown in SEQ ID NO: 25. In some embodiments the lipolytic enzyme, such as GeoT1, is fused to the carboxy-terminus of the catalytic domain of a bacterial cellulose such as that shown in SEQ ID NO: 26. In some embodiments, the bacterial cellulase is derived from a Bacillus strain deposited as CBS 670.93 (referred to as BCE103) with the Central Bureau voor Schimmelcultures, Baam, The Netherlands. In some embodiments the lipolytic enzyme, such as GeoT1, is connected to the BCE103 cellulase by a cleavable linker. Thus in some embodiments the lipolytic enzyme, such as GeoT1, is not a fusion protein.

Suitably, the lipolytic enzyme may belong to the abH 18 superfamily, preferably the abH 18.01 superfamily.

Suitably, the lipolytic enzyme may comprise one of more of the following amino acid sequences
f) SEQ ID NO: 27;
g) SEQ ID NO: 28;
h) SEQ ID NO: 27 lacking the signal peptide as indicated in FIG. 36;
i) an amino acid sequence having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to any one of the amino acid sequences defined in a) to c); or
j) an amino acid sequence as set forth in any one of a) to c) except for one or several modifications (i.e. deletions, substitutions and/or insertions), such as 2, 3, 4, 5, 6, 7, 8, 9 amino acid modifications, or more amino acid modifications such as 10 and having lipolytic enzyme activity.

Suitably, the lipolytic enzyme may comprise a lipase cloned from Bacillus subtilis, preferably a lipaseA (LipA) from Bacillus subtilis such as that shown in SEQ ID NO: 27. In some embodiments, the lipolytic enzyme, such as LipA, is fused to the carboxy-terminus of the catalytic domain of a bacterial cellulose such as that shown in SEQ ID NO:28. In some embodiments, the bacterial cellulase is derived from a Bacillus strain deposited as CBS 670.93 (referred to as BCE103) with the Central Bureau voor Schimmelcultures, Baam, The Netherlands. In some embodiments the lipolytic enzyme, such as LipA, is connected to the BCE103 cellulase by a cleavable linker. Thus in some embodiments the lipolytic enzyme, such as LipA, is not a fusion protein.

In one aspect, as used herein, a “lipase”, “lipase enzyme”, “lipolytic enzymes”, “lipolytic polypeptides”, or “lipolytic proteins” refers to an enzyme, polypeptide, or protein exhibiting a lipid degrading capability such as a capability of degrading a triglyceride or a phospholipid. The lipolytic enzyme may be, for example, a lipase, a phospholipase, an esterase or a cutinase. As used herein, lipolytic activity may be determined according to any procedure known in the art (see, e.g., Gupta et al., Biotechnol. Appl. Biochem., 2003, 37:63-71; U.S. Pat. No. 5,990,069; and International Publication No. WO 96/18729).

In one aspect, the present invention provides a detergent or cleaning composition comprising:
a) a polypeptide as shown in SEQ ID NO: 17 or a fragment thereof having lipase activity;
b) a polypeptide having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to the amino acid sequence shown as SEQ ID NO: 17 and having lipase activity; or
c) a polypeptide as set forth in SEQ ID NO: 17 except for one or several modifications (i.e. deletions, substitutions and/or insertions), such as 2, 3, 4, 5, 6, 7, 8, 9 amino acid modifications, or more amino acid modifications such as 10 and having lipase activity;
d) a polypeptide encoded by the nucleotide sequence of SEQ ID NO: 23 or by a nucleic acid which is related to the nucleotide sequence of SEQ ID NO: 23 by the degeneration of the genetic code;
e) a polypeptide having lipase activity encoded by a nucleic acid sequence having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to the amino acid sequence shown as SEQ ID NO: 23 or to a nucleic acid which is related to the nucleotide sequence of SEQ ID NO: 23 by the degeneration of the genetic code;
f) a polypeptide having lipase activity encoded by a nucleic acid sequence which hybridizes under stringent conditions to the complement of the nucleic acid sequence of SEQ ID NO: 23; or
g) a polypeptide obtainable (preferably obtained) from Streptomyces (preferably S. pristinaespiralis) having lipase activity.

Suitably, the polypeptide may be present in a concentration of 0.01 to 2 ppm by weight of the total weight of the composition. The composition may further comprise one or more enzymes selected from the group consisting of a protease, an amylase, a glucoamylase, a maltogenic amylase, a non-maltogenic amylase, a lipase, a cutinase, a carbohydrase, a cellulase, a pectinase, a mannanase, an arabinase, a galactanase, a xylanase, an oxidase, a laccase, a peroxidase, and an acyl transferase.

Suitably, the composition may comprise one or more surfactants, such as one or more surfactants selected from the group consisting of non-ionic (including semi-polar), anionic, cationic and zwitterionic.

Suitably, the composition may be in powder form or may be in liquid form.

The present invention further provides a method of removing a lipid-based stain from a surface by contacting the surface with a composition comprising:
a) a polypeptide as shown in SEQ ID NO: 17 or a fragment thereof having lipase activity;
b) a polypeptide having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to the amino acid sequence shown as SEQ ID NO: 17 and having lipase activity; or
c) a polypeptide as set forth in SEQ ID NO: 17 except for one or several modifications (i.e. deletions, substitutions and/or insertions), such as 2, 3, 4, 5, 6, 7, 8, 9 amino acid modifications, or more amino acid modifications such as 10 and having lipase activity;
d) a polypeptide encoded by the nucleotide sequence of SEQ ID NO: 23 or by a nucleic acid which is related to the nucleotide sequence of SEQ ID NO: 23 by the degeneration of the genetic code;
e) a polypeptide having lipase activity encoded by a nucleic acid sequence having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to the amino acid sequence shown as SEQ ID NO: 23 or to a nucleic acid which is related to the nucleotide sequence of SEQ ID NO: 23 by the degeneration of the genetic code;
f) a polypeptide having lipase activity encoded by a nucleic acid sequence which hybridizes under stringent conditions to the complement of the nucleic acid sequence of SEQ ID NO: 23; or
g) a polypeptide obtainable (preferably obtained) from Streptomyces (preferably S. pristinaespiralis) having lipase activity.

In another aspect, the present invention provides the use of a composition comprising:
a) a polypeptide as shown in SEQ ID NO: 17 or a fragment thereof having lipase activity;
b) a polypeptide having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to the amino acid sequence shown as SEQ ID NO: 17 and having lipase activity; or
c) a polypeptide as set forth in SEQ ID NO: 17 except for one or several modifications (i.e. deletions, substitutions and/or insertions), such as 2, 3, 4, 5, 6, 7, 8, 9 amino acid modifications, or more amino acid modifications such as 10 and having lipase activity;
d) a polypeptide encoded by the nucleotide sequence of SEQ ID NO: 23 or by a nucleic acid which is related to the nucleotide sequence of SEQ ID NO: 23 by the degeneration of the genetic code;
e) a polypeptide having lipase activity encoded by a nucleic acid sequence having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to the amino acid sequence shown as SEQ ID NO: 23 or to a nucleic acid which is related to the nucleotide sequence of SEQ ID NO: 23 by the degeneration of the genetic code;
f) a polypeptide having lipase activity encoded by a nucleic acid sequence which hybridizes under stringent conditions to the complement of the nucleic acid sequence of SEQ ID NO: 23; or
g) a polypeptide obtainable (preferably obtained) from Streptomyces (preferably S. pristinaespiralis) having lipase activity,
   in cleaning and/or in a detergent. For example, such use may be to reduce or remove lipid stains from a surface.

In another aspect, the present invention provides a method of cleaning a surface, comprising contacting the surface with a composition comprising:
a) a polypeptide as shown in SEQ ID NO: 17 or a fragment thereof having lipase activity;
b) a polypeptide having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to the amino acid sequence shown as SEQ ID NO: 17 and having lipase activity; or
c) a polypeptide as set forth in SEQ ID NO: 17 except for one or several modifications (i.e. deletions, substitutions and/or insertions), such as 2, 3, 4, 5, 6, 7, 8, 9 amino acid modifications, or more amino acid modifications such as 10 and having lipase activity;
d) a polypeptide encoded by the nucleotide sequence of SEQ ID NO: 23 or by a nucleic acid which is related to the nucleotide sequence of SEQ ID NO: 23 by the degeneration of the genetic code;
e) a polypeptide having lipase activity encoded by a nucleic acid sequence having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to the amino acid sequence shown as SEQ ID NO: 23 or to a nucleic acid which is related to the nucleotide sequence of SEQ ID NO: 23 by the degeneration of the genetic code;
f) a polypeptide having lipase activity encoded by a nucleic acid sequence which hybridizes under stringent conditions to the complement of the nucleic acid sequence of SEQ ID NO: 23; or
g) a polypeptide obtainable (preferably obtained) from Streptomyces (preferably S. pristinaespiralis) having lipase activity.

In a further aspect, the present invention provides a method of cleaning an item, comprising contacting the item with a composition comprising:
a) a polypeptide as shown in SEQ ID NO: 17 or a fragment thereof having lipase activity;
b) a polypeptide having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to the amino acid sequence shown as SEQ ID NO: 17 and having lipase activity; or
c) a polypeptide as set forth in SEQ ID NO: 17 except for one or several modifications (i.e. deletions, substitutions and/or insertions), such as 2, 3, 4, 5, 6, 7, 8, 9 amino acid modifications, or more amino acid modifications such as 10 and having lipase activity;
d) a polypeptide encoded by the nucleotide sequence of SEQ ID NO: 23 or by a nucleic acid which is related to the nucleotide sequence of SEQ ID NO: 23 by the degeneration of the genetic code;
e) a polypeptide having lipase activity encoded by a nucleic acid sequence having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to the amino acid sequence shown as SEQ ID NO: 23 or to a nucleic acid which is related to the nucleotide sequence of SEQ ID NO: 23 by the degeneration of the genetic code;
f) a polypeptide having lipase activity encoded by a nucleic acid sequence which hybridizes under stringent conditions to the complement of the nucleic acid sequence of SEQ ID NO: 23; or
g) a polypeptide obtainable (preferably obtained) from Streptomyces (preferably S. pristinaespiralis) having lipase activity.

Suitably, the item may be a clothing item or a tableware item.

The present invention provides many applications, methods and uses of a composition comprising a lipolytic enzyme and a hydrophobin. For the avoidance of doubt, each of these applications, methods and uses may be applied to a composition comprising:
a) a polypeptide as shown in SEQ ID NO: 17 or a fragment thereof having lipase activity;
b) a polypeptide having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to the amino acid sequence shown as SEQ ID NO: 17 and having lipase activity; or
c) a polypeptide as set forth in SEQ ID NO: 17 except for one or several modifications (i.e. deletions, substitutions and/or insertions), such as 2, 3, 4, 5, 6, 7, 8, 9 amino acid modifications, or more amino acid modifications such as 10 and having lipase activity;
d) a polypeptide encoded by the nucleotide sequence of SEQ ID NO: 23 or by a nucleic acid which is related to the nucleotide sequence of SEQ ID NO: 23 by the degeneration of the genetic code;
e) a polypeptide having lipase activity encoded by a nucleic acid sequence having at least 70%, preferably at least 80%, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, or preferably at least 99% identity to the amino acid sequence shown as SEQ ID NO: 23 or to a nucleic acid which is related to the nucleotide sequence of SEQ ID NO: 23 by the degeneration of the genetic code;
f) a polypeptide having lipase activity encoded by a nucleic acid sequence which hybridizes under stringent conditions to the complement of the nucleic acid sequence of SEQ ID NO: 23; or
g) a polypeptide obtainable (preferably obtained) from Streptomyces (preferably S. pristinaespiralis) having lipase activity.

### Host Cell

The term “host cell”—in relation to the present invention includes any cell that comprises either the nucleotide sequence or an expression vector as described above and which is used in the recombinant production of an enzyme having the specific properties as defined herein.

Thus, a further embodiment of the present invention provides host cells transformed or transfected with a nucleotide sequence that expresses the enzyme of the present invention. The cells will be chosen to be compatible with the said vector and may for example be prokaryotic (for example bacterial), fungal, yeast or plant cells.

Preferably, the host cells are not human cells.

Examples of suitable bacterial host organisms are gram positive or gram negative bacterial species.

Depending on the nature of the nucleotide sequence encoding the enzyme of the present invention, and/or the desirability for further processing of the expressed protein, eukaryotic hosts such as yeasts or other fungi may be preferred. However, some proteins are either poorly secreted from the yeast cell, or in some cases are not processed properly (e.g., hyper-glycosylation in yeast). In these instances, a different fungal host organism should be selected.

The use of suitable host cells—such as yeast, fungal and plant host cells—may provide for post-translational modifications (e.g., myristoylation, glycosylation, truncation, lipidation and tyrosine, serine or threonine phosphorylation, or N-terminal acetylation as may be needed to confer optimal biological activity on recombinant expression products of the present invention.

The host cell may be a protease deficient or protease minus strain.

The genotype of the host cell may be modified to improve expression.

Examples of host cell modifications include protease deficiency, supplementation of rare tRNAs, and modification of the reductive potential in the cytoplasm to enhance disulphide bond formation.

For example, the host cell E. coli may overexpress rare tRNAs to improve expression of heterologous proteins as exemplified/described in Kane (Curr Opin Biotechnol (1995), 6, 494-500 “Effects of rare codon clusters on high-level expression of heterologous proteins in E. coli”). The host cell may be deficient in a number of reducing enzymes thus favouring formation of stable disulphide bonds as exemplified/described in Bessette (Proc Natl Acad Sci USA (1999), 96, 13703-13708 “Efficient folding of proteins with multiple disulphide bonds in the Escherichia coli cytoplasm”).

### Isolated

In one aspect, the enzymes for use in the present invention may be in an isolated form.

The term “isolated” means that the sequence or protein is at least substantially free from at least one other component with which the sequence or protein is naturally associated in nature and as found in nature.

### Purified

In one aspect, the enzymes for use in the present invention may be used in a purified form.

The term “purified” means that the sequence is in a relatively pure state—e.g., at least about 51% pure, or at least about 75%, or at least about 80%, or at least about 90% pure, or at least about 95% pure or at least about 98% pure.

### Cloning a Nucleotide Sequence Encoding a Polypeptide According to the Present Invention

A nucleotide sequence encoding either a polypeptide which has the specific properties as defined herein or a polypeptide which is suitable for modification may be isolated from any cell or organism producing said polypeptide. Various methods are well known within the art for the isolation of nucleotide sequences.

For example, a genomic DNA and/or cDNA library may be constructed using chromosomal DNA or messenger RNA from the organism producing the polypeptide. If the amino acid sequence of the polypeptide is known, labelled oligonucleotide probes may be synthesised and used to identify polypeptide-encoding clones from the genomic library prepared from the organism. Alternatively, a labelled oligonucleotide probe containing sequences homologous to another known polypeptide gene could be used to identify polypeptide-encoding clones. In the latter case, hybridisation and washing conditions of lower stringency are used.

Alternatively, polypeptide-encoding clones could be identified by inserting fragments of genomic DNA into an expression vector, such as a plasmid, transforming enzyme-negative bacteria with the resulting genomic DNA library, and then plating the transformed bacteria onto agar containing an enzyme inhibited by the polypeptide, thereby allowing clones expressing the polypeptide to be identified.

In a yet further alternative, the nucleotide sequence encoding the polypeptide may be prepared synthetically by established standard methods, e.g., the phosphoroamidite method described by Beucage S. L. et al. (1981) Tetrahedron Letters 22, 1859-1869, or the method described by Matthes et al. (1984) EMBO J. 3, 801-805. In the phosphoroamidite method, oligonucleotides are synthesised, e.g., in an automatic DNA synthesiser, purified, annealed, ligated and cloned in appropriate vectors.

The nucleotide sequence may be of mixed genomic and synthetic origin, mixed synthetic and cDNA origin, or mixed genomic and cDNA origin, prepared by ligating fragments of synthetic, genomic or cDNA origin (as appropriate) in accordance with standard techniques. Each ligated fragment corresponds to various parts of the entire nucleotide sequence. The DNA sequence may also be prepared by polymerase chain reaction (PCR) using specific primers, for instance as described in U.S. Pat. No. 4,683,202 or in Saiki R K et al. (Science (1988) 239, 487-491).

### Nucleotide Sequences

The present invention also encompasses nucleotide sequences encoding polypeptides having the specific properties as defined herein. The term “nucleotide sequence” as used herein refers to an oligonucleotide sequence or polynucleotide sequence, and variant, homologues, fragments and derivatives thereof (such as portions thereof). The nucleotide sequence may be of genomic or synthetic or recombinant origin, which may be double-stranded or single-stranded whether representing the sense or antisense strand.

The term “nucleotide sequence” in relation to the present invention includes genomic DNA, cDNA, synthetic DNA, and RNA. Preferably it means DNA, more preferably cDNA for the coding sequence.

In a preferred embodiment, the nucleotide sequence per se encoding a polypeptide having the specific properties as defined herein does not cover the native nucleotide sequence in its natural environment when it is linked to its naturally associated sequence(s) that is/are also in its/their natural environment. For ease of reference, we shall call this preferred embodiment the “non-native nucleotide sequence”. In this regard, the term “native nucleotide sequence” means an entire nucleotide sequence that is in its native environment and when operatively linked to an entire promoter with which it is naturally associated, which promoter is also in its native environment.

However, the amino acid sequence encompassed by scope the present invention can be isolated and/or purified post expression of a nucleotide sequence in its native organism. Preferably, however, the amino acid sequence encompassed by scope of the present invention may be expressed by a nucleotide sequence in its native organism but wherein the nucleotide sequence is not under the control of the promoter with which it is naturally associated within that organism.

Preferably the polypeptide is not a native polypeptide. In this regard, the term “native polypeptide” means an entire polypeptide that is in its native environment and when it has been expressed by its native nucleotide sequence.

Typically, the nucleotide sequence encoding polypeptides having the specific properties as defined herein is prepared using recombinant DNA techniques (i.e., recombinant DNA). However, in an alternative embodiment of the invention, the nucleotide sequence could be synthesised, in whole or in part, using chemical methods well known in the art (see Caruthers M H et al. (1980) Nuc Acids Res Symp Ser 215-23 and Horn T et al. (1980) Nuc Acids Res Symp Ser 225-232).

### Molecular Evolution

Once an enzyme-encoding nucleotide sequence has been isolated, or a putative enzyme-encoding nucleotide sequence has been identified, it may be desirable to modify the selected nucleotide sequence, for example it may be desirable to mutate the sequence in order to prepare an enzyme in accordance with the present invention.

Mutations may be introduced using synthetic oligonucleotides. These oligonucleotides contain nucleotide sequences flanking the desired mutation sites.

A suitable method is disclosed in Morinaga et al. (Biotechnology (1984) 2, 646-649). Another method of introducing mutations into enzyme-encoding nucleotide sequences is described in Nelson and Long (Analytical Biochemistry (1989), 180, 147-151).

Instead of site directed mutagenesis, such as described above, one can introduce mutations randomly for instance using a commercial kit such as the GeneMorph PCR mutagenesis kit from Stratagene, or the Diversify PCR random mutagenesis kit from Clontech. EP 0 583 265 refers to methods of optimising PCR based mutagenesis, which can also be combined with the use of mutagenic DNA analogues such as those described in EP 0 866 796. Error prone PCR technologies are suitable for the production of variants of lipid acyl transferases with preferred characteristics. WO 02/06457 refers to molecular evolution of lipases.

A third method to obtain novel sequences is to fragment non-identical nucleotide sequences, either by using any number of restriction enzymes or an enzyme such as Dnase I, and reassembling full nucleotide sequences coding for functional proteins. Alternatively one can use one or multiple non-identical nucleotide sequences and introduce mutations during the reassembly of the full nucleotide sequence. DNA shuffling and family shuffling technologies are suitable for the production of variants of lipid acyl transferases with preferred characteristics. Suitable methods for performing ‘shuffling’ can be found in EP 0 752 008, EP 1 138 763, EP 1 103 606. Shuffling can also be combined with other forms of DNA mutagenesis as described in U.S. Pat. No. 6,180,406 and WO 01/34835.

Thus, it is possible to produce numerous site directed or random mutations into a nucleotide sequence, either in vivo or in vitro, and to subsequently screen for improved functionality of the encoded polypeptide by various means. Using in silico and exo-mediated recombination methods (see, e.g., WO 00/58517, U.S. Pat. No. 6,344,328, U.S. Pat. No. 6,361,974), for example, molecular evolution can be performed where the variant produced retains very low homology to known enzymes or proteins. Such variants thereby obtained may have significant structural analogy to known transferase enzymes, but have very low amino acid sequence homology.

As a non-limiting example, in addition, mutations or natural variants of a polynucleotide sequence can be recombined with either the wild type or other mutations or natural variants to produce new variants. Such new variants can also be screened for improved functionality of the encoded polypeptide.

The application of the above-mentioned and similar molecular evolution methods allows the identification and selection of variants of the enzymes of the present invention which have preferred characteristics without any prior knowledge of protein structure or function, and allows the production of non-predictable but beneficial mutations or variants. There are numerous examples of the application of molecular evolution in the art for the optimisation or alteration of enzyme activity, such examples include, but are not limited to one or more of the following: optimised expression and/or activity in a host cell or in vitro, increased enzymatic activity, altered substrate and/or product specificity, increased or decreased enzymatic or structural stability, altered enzymatic activity/specificity in preferred environmental conditions, e.g., temperature, pH, substrate.

As will be apparent to a person skilled in the art, using molecular evolution tools an enzyme may be altered to improve the functionality of the enzyme.

Suitably, the nucleotide sequence encoding a lipolytic enzyme used in the invention may encode a variant, i.e., the lipolytic enzyme may contain at least one amino acid substitution, deletion or addition, when compared to a parental enzyme. Variant enzymes retain at least 70%, 80%, 90%, 91%, 92%, 93%, 94%, 95%, 96%, 97%, 99% homology with the parent enzyme.

Variant lipolytic enzymes may have decreased activity on triglycerides, and/or monoglycerides and/or diglycerides compared with the parent enzyme.

Suitably the variant enzyme may have no activity on triglycerides and/or monoglycerides and/or diglycerides.

Alternatively, the variant enzyme may have increased thermostability.

The variant enzyme may have increased activity on one or more of the following, polar lipids, phospholipids, lecithin, phosphatidylcholine, glycolipids, digalactosyl monoglyceride, monogalactosyl monoglyceride.

Variants of lipid acyltransferases are known, and one or more of such variants may be suitable for use in the methods and uses according to the present invention and/or in the enzyme compositions according to the present invention. By way of example only, variants of lipid acyltransferases are described in the following references may be used in accordance with the present invention: Hilton & Buckley J. Biol. Chem. 1991 Jan. 15:266:997-1000; Robertson et al. J. Biol. Chem. 1994 Jan. 21; 269: 2146-50; Brumlik et al. J. Bacteriol. 1996 April; 178: 2060-4; Peelman et al. Protein Sci. 1998 March; 7:587-99.

### Amino Acid Sequences

The present invention also encompasses the use of amino acid sequences encoded by a nucleotide sequence which encodes an enzyme for use in any one of the methods and/or uses of the present invention.

As used herein, the term “amino acid sequence” is synonymous with the term “polypeptide” and/or the term “protein”. In some instances, the term “amino acid sequence” is synonymous with the term “peptide”. In some instances, the term “amino acid sequence” is synonymous with “enzyme”.

The amino acid sequence may be prepared/isolated from a suitable source, or it may be made synthetically or it may be prepared by use of recombinant DNA techniques.

Suitably, the amino acid sequences may be obtained from the isolated polypeptides taught herein by standard techniques.

One suitable method for determining amino acid sequences from isolated polypeptides is as follows:

Purified polypeptide may be freeze-dried and 100 μg of the freeze-dried material may be dissolved in 50 μl of a mixture of 8 M urea and 0.4 M ammonium hydrogen carbonate, pH 8.4. The dissolved protein may be denatured and reduced for 15 minutes at 50° C. following overlay with nitrogen and addition of 5 μl of 45 mM dithiothreitol. After cooling to room temperature, 5 μl of 100 mM iodoacetamide may be added for the cysteine residues to be derivatized for 15 minutes at room temperature in the dark under nitrogen.

135 μl of water and 5 μg of endoproteinase Lys-C in 5 μl of water may be added to the above reaction mixture and the digestion may be carried out at 37° C. under nitrogen for 24 hours.

The resulting peptides may be separated by reverse phase HPLC on a VYDAC C18 column (0.46×15 cm; 10 μm; The Separation Group, California, USA) using solvent A: 0.1% TFA in water and solvent B: 0.1% TFA in acetonitrile. Selected peptides may be re-chromatographed on a Develosil C18 column using the same solvent system, prior to N-terminal sequencing. Sequencing may be done using an Applied Biosystems 476A sequencer using pulsed liquid fast cycles according to the manufacturer's instructions (Life Technologies, California, USA).

### Sequence Identity or Sequence Homology

Here, the term “homologue” means an entity having a certain homology with the subject amino acid sequences and the subject nucleotide sequences. Here, the term “homology” can be equated with “identity”.

The homologous amino acid sequence and/or nucleotide sequence should provide and/or encode a polypeptide which retains the functional activity and/or enhances the activity of the enzyme.

In the present context, a homologous sequence is taken to include an amino acid sequence which may be at least 50%, 55%, 60%, 70%, 71%, 72%, 73%, 74%, 75%, 80%, 85%, 90%, 91%, 92%, 93%, 94%, 95%, 96%, 97%, 98%, or 99% identical, preferably at least 95%, 96%, 97%, 98%, or 99% identical to the subject sequence. Typically, the homologues will comprise the same active sites etc. as the subject amino acid sequence. Although homology can also be considered in terms of similarity (i.e., amino acid residues having similar chemical properties/functions), in the context of the present invention it is preferred to express homology in terms of sequence identity.

In the present context, a homologous sequence is taken to include a nucleotide sequence which may be at least 75, 85 or 90%, 91%, 92%, 93%, 94%, 95%, 96%, 97%, 98%, or 99% identical, preferably at least 95%, 96%, 97%, 98%, or 99% identical to a nucleotide sequence encoding a polypeptide of the present invention (the subject sequence). Typically, the homologues will comprise the same sequences that code for the active sites etc. as the subject sequence. Although homology can also be considered in terms of similarity (i.e., amino acid residues having similar chemical properties/functions), in the context of the present invention it is preferred to express homology in terms of sequence identity.

Homology comparisons can be conducted by eye, or more usually, with the aid of readily available sequence comparison programs. These commercially available computer programs can calculate % homology between two or more sequences.

% homology may be calculated over contiguous sequences, i.e., one sequence is aligned with the other sequence and each amino acid in one sequence is directly compared with the corresponding amino acid in the other sequence, one residue at a time. This is called an “ungapped” alignment. Typically, such ungapped alignments are performed only over a relatively short number of residues.

Although this is a very simple and consistent method, it fails to take into consideration that, for example, in an otherwise identical pair of sequences, one insertion or deletion will cause the following amino acid residues to be put out of alignment, thus potentially resulting in a large reduction in % homology when a global alignment is performed. Consequently, most sequence comparison methods are designed to produce optimal alignments that take into consideration possible insertions and deletions without penalising unduly the overall homology score. This is achieved by inserting “gaps” in the sequence alignment to try to maximise local homology.

However, these more complex methods assign “gap penalties” to each gap that occurs in the alignment so that, for the same number of identical amino acids, a sequence alignment with as few gaps as possible—reflecting higher relatedness between the two compared sequences—will achieve a higher score than one with many gaps. “Affine gap costs” are typically used that charge a relatively high cost for the existence of a gap and a smaller penalty for each subsequent residue in the gap. This is the most commonly used gap scoring system. High gap penalties will of course produce optimised alignments with fewer gaps. Most alignment programs allow the gap penalties to be modified. However, it is preferred to use the default values when using such software for sequence comparisons.

Calculation of maximum % homology therefore firstly requires the production of an optimal alignment, taking into consideration gap penalties. A suitable computer program for carrying out such an alignment is the Vector NTI (Invitrogen Corp.). Examples of other software that can perform sequence comparisons include, but are not limited to, the BLAST package (see Ausubel et al. 1999 Short Protocols in Molecular Biology, 4^{th} Ed—Chapter 18), and FASTA (Altschul et al. 1990 J. Mol. Biol. 403-410). Both BLAST and FASTA are available for offline and online searching (see Ausubel et al. 1999, pages 7-58 to 7-60). However, for some applications, it is preferred to use the Vector NTI program. A new tool, called BLAST 2 Sequences is also available for comparing protein and nucleotide sequence (see FEMS Microbiol Lett 1999 174: 247-50; FEMS Microbiol Lett 1999 177: 187-8 and tatiana@ncbi.nlm.nih.gov).

Although the final % homology can be measured in terms of identity, the alignment process itself is typically not based on an all-or-nothing pair comparison. Instead, a scaled similarity score matrix is generally used that assigns scores to each pairwise comparison based on chemical similarity or evolutionary distance. An example of such a matrix commonly used is the BLOSUM62 matrix—the default matrix for the BLAST suite of programs. Vector NTI programs generally use either the public default values or a custom symbol comparison table if supplied (see user manual for further details). For some applications, it is preferred to use the default values for the Vector NTI ADVANCE™ 10 package.

Alternatively, percentage homologies may be calculated using the multiple alignment feature in Vector NTI ADVANCE™ 10 (Invitrogen Corp.), based on an algorithm, analogous to CLUSTAL (Higgins D G & Sharp P M (1988), Gene 73, 237-244).

Once the software has produced an optimal alignment, it is possible to calculate % homology, preferably % sequence identity. The software typically does this as part of the sequence comparison and generates a numerical result.

Suitably, the degree of identity with regard to a nucleotide sequence is determined over at least 20 contiguous nucleotides, preferably over at least 30 contiguous nucleotides, preferably over at least 40 contiguous nucleotides, preferably over at least 50 contiguous nucleotides, preferably over at least 60 contiguous nucleotides, preferably over at least 100 contiguous nucleotides.

Suitably, the degree of identity with regard to a nucleotide sequence may be determined over the whole sequence.

Should Gap Penalties be used when determining sequence identity, then preferably the default parameters for the programme are used for pairwise alignment. For example, the following parameters are the current default parameters for pairwise alignment for BLAST 2:

| FOR BLAST2 | DNA | PROTEIN |
|---|---|---|
| EXPECT THRESHOLD | 10 | 10 |
| WORD SIZE | 11 | 3 |
| SCORING PARAMETERS | | |
| Match/Mismatch Scores | 2, −3 | n/a |
| Matrix | n/a | BLOSUM62 |
| Gap Costs | Existence: 5 | Existence: 11 |
| | Extension: 2 | Extension: 1 |

In one embodiment, preferably the sequence identity for the nucleotide sequences and/or amino acid sequences may be determined using BLAST2 (blastn) with the scoring parameters set as defined above.

For the purposes of the present invention, the degree of identity is based on the number of sequence elements which are the same. The degree of identity in accordance with the present invention for amino acid sequences may be suitably determined by means of computer programs known in the art such as Vector NTI ADVANCE™ (Invitrogen Corp.). For pairwise alignment the scoring parameters used are preferably BLOSUM62 with Gap existence penalty of 11 and Gap extension penalty of 1.

Suitably, the degree of identity with regard to an amino acid sequence is determined over at least 20 contiguous amino acids, preferably over at least 30 contiguous amino acids, preferably over at least 40 contiguous amino acids, preferably over at least 50 contiguous amino acids, preferably over at least 60 contiguous amino acids, preferably over at least 100 contiguous amino acids.

Suitably, the degree of identity with regard to an amino acid sequence may be determined over the whole sequence.

The sequences may also have deletions, insertions or substitutions of amino acid residues which produce a silent change and result in a functionally equivalent substance. Deliberate amino acid substitutions may be made on the basis of similarity in polarity, charge, solubility, hydrophobicity, hydrophilicity, and/or the amphipathic nature of the residues as long as the secondary binding activity of the substance is retained. For example, negatively charged amino acids include aspartic acid and glutamic acid; positively charged amino acids include lysine and arginine; and amino acids with uncharged polar head groups having similar hydrophilicity values include leucine, isoleucine, valine, glycine, alanine, asparagine, glutamine, serine, threonine, phenylalanine, and tyrosine.

Conservative substitutions may be made, for example according to the Table below. Amino acids in the same block in the second column and preferably in the same line in the third column may be substituted for each other:

| | | |
|---|---|---|
| ALIPHATIC | Non-polar | G A P |
| | | I L V |
| | Polar - uncharged | C S T M |
| | | N Q |
| | Polar - charged | D E |
| | | K R |
| AROMATIC | | H F W Y |

The present invention also encompasses homologous substitution (substitution and replacement are both used herein to mean the interchange of an existing amino acid residue, with an alternative residue) that may occur, i.e., like-for-like substitution such as basic for basic, acidic for acidic, polar for polar etc. Non-homologous substitution may also occur, i.e., from one class of residue to another or alternatively involving the inclusion of unnatural amino acids such as ornithine (hereinafter referred to as Z), diaminobutyric acid ornithine (hereinafter referred to as B), norleucine ornithine (hereinafter referred to as O), pyridylalanine, thienylalanine, naphthylalanine and phenylglycine.

Replacements may also be made by unnatural amino acids.

Variant amino acid sequences may include suitable spacer groups that may be inserted between any two amino acid residues of the sequence including alkyl groups such as methyl, ethyl or propyl groups in addition to amino acid spacers such as glycine or β-alanine residues. A further form of variation, involves the presence of one or more amino acid residues in peptoid form, will be well understood by those skilled in the art. For the avoidance of doubt, “the peptoid form” is used to refer to variant amino acid residues wherein the α-carbon substituent group is on the residue's nitrogen atom rather than the α-carbon. Processes for preparing peptides in the peptoid form are known in the art, for example Simon R J et al., PNAS (1992) 89, 9367-9371 and Horwell D C, Trends Biotechnol. (1995) 13, 132-134.

Nucleotide sequences for use in the present invention or encoding a polypeptide having the specific properties defined herein may include within them synthetic or modified nucleotides. A number of different types of modification to oligonucleotides are known in the art. These include methylphosphonate and phosphorothioate backbones and/or the addition of acridine or polylysine chains at the 3′ and/or 5′ ends of the molecule. For the purposes of the present invention, it is to be understood that the nucleotide sequences described herein may be modified by any method available in the art. Such modifications may be carried out in order to enhance the in vivo activity or life span of nucleotide sequences.

The present invention also encompasses the use of nucleotide sequences that are complementary to the sequences discussed herein, or any derivative, fragment or derivative thereof. If the sequence is complementary to a fragment thereof then that sequence can be used as a probe to identify similar coding sequences in other organisms etc.

Polynucleotides which are not 100% homologous to the sequences of the present invention but fall within the scope of the invention can be obtained in a number of ways. Other variants of the sequences described herein may be obtained for example by probing DNA libraries made from a range of individuals, for example individuals from different populations. In addition, other viral/bacterial, or cellular homologues particularly cellular homologues found in mammalian cells (e.g., rat, mouse, bovine and primate cells), may be obtained and such homologues and fragments thereof in general will be capable of selectively hybridising to the sequences shown in the sequence listing herein. Such sequences may be obtained by probing cDNA libraries made from or genomic DNA libraries from other animal species, and probing such libraries with probes comprising all or part of any one of the sequences in the attached sequence listings under conditions of medium to high stringency. Similar considerations apply to obtaining species homologues and allelic variants of the polypeptide or nucleotide sequences of the invention.

Variants and strain/species homologues may also be obtained using degenerate PCR which will use primers designed to target sequences within the variants and homologues encoding conserved amino acid sequences within the sequences of the present invention. Conserved sequences can be predicted, for example, by aligning the amino acid sequences from several variants/homologues. Sequence alignments can be performed using computer software known in the art. For example the GCG Wisconsin PileUp program is widely used.

The primers used in degenerate PCR will contain one or more degenerate positions and will be used at stringency conditions lower than those used for cloning sequences with single sequence primers against known sequences.

Alternatively, such polynucleotides may be obtained by site directed mutagenesis of characterised sequences. This may be useful where for example silent codon sequence changes are required to optimise codon preferences for a particular host cell in which the polynucleotide sequences are being expressed. Other sequence changes may be desired in order to introduce restriction polypeptide recognition sites, or to alter the property or function of the polypeptides encoded by the polynucleotides.

Polynucleotides (nucleotide sequences) of the invention may be used to produce a primer, e.g., a PCR primer, a primer for an alternative amplification reaction, a probe e.g., labelled with a revealing label by conventional means using radioactive or non-radioactive labels, or the polynucleotides may be cloned into vectors. Such primers, probes and other fragments will be at least 15, preferably at least 20, for example at least 25, 30 or 40 nucleotides in length, and are also encompassed by the term polynucleotides of the invention as used herein.

Polynucleotides such as DNA polynucleotides and probes according to the invention may be produced recombinantly, synthetically, or by any means available to those of skill in the art. They may also be cloned by standard techniques.

In general, primers will be produced by synthetic means, involving a stepwise manufacture of the desired nucleic acid sequence one nucleotide at a time. Techniques for accomplishing this using automated techniques are readily available in the art.

Longer polynucleotides will generally be produced using recombinant means, for example using a PCR (polymerase chain reaction) cloning techniques. This will involve making a pair of primers (e.g., of about 15 to 30 nucleotides) flanking a region of the lipid targeting sequence which it is desired to clone, bringing the primers into contact with mRNA or cDNA obtained from an animal or human cell, performing a polymerase chain reaction under conditions which bring about amplification of the desired region, isolating the amplified fragment (e.g., by purifying the reaction mixture on an agarose gel) and recovering the amplified DNA. The primers may be designed to contain suitable restriction enzyme recognition sites so that the amplified DNA can be cloned into a suitable cloning vector.

### Hybridisation

The present invention also encompasses the use of sequences that are complementary to the sequences of the present invention or sequences that are capable of hybridising either to the sequences of the present invention or to sequences that are complementary thereto.

The term “hybridisation” as used herein shall include “the process by which a strand of nucleic acid joins with a complementary strand through base pairing” as well as the process of amplification as carried out in polymerase chain reaction (PCR) technologies.

The present invention also encompasses the use of nucleotide sequences that are capable of hybridising to the sequences that are complementary to the subject sequences discussed herein, or any derivative, fragment or derivative thereof.

The present invention also encompasses sequences that are complementary to sequences that are capable of hybridising to the nucleotide sequences discussed herein.

Hybridisation conditions are based on the melting temperature (Tm) of the nucleotide binding complex, as taught in Berger and Kimmel (1987, Guide to Molecular Cloning Techniques, Methods in Enzymology, Vol. 152, Academic Press, San Diego Calif.), and confer a defined “stringency” as explained below.

Maximum stringency typically occurs at about Tm-5° C. (5° C. below the Tm of the probe); high stringency at about 5° C. to 10° C. below Tm; intermediate stringency at about 10° C. to 20° C. below Tm; and low stringency at about 20° C. to 25° C. below Tm. As will be understood by those of skill in the art, a maximum stringency hybridisation can be used to identify or detect identical nucleotide sequences while an intermediate (or low) stringency hybridisation can be used to identify or detect similar or related polynucleotide sequences.

Preferably, the present invention encompasses the use of sequences that are complementary to sequences that are capable of hybridising under high stringency conditions or intermediate stringency conditions to nucleotide sequences encoding polypeptides having the specific properties as defined herein.

More preferably, the present invention encompasses the use of sequences that are complementary to sequences that are capable of hybridising under high stringency conditions (e.g., 65° C. and 0.1×SSC {1×SSC=0.15 M NaCl, 0.015 M Na-citrate pH 7.0}) to nucleotide sequences encoding polypeptides having the specific properties as defined herein.

The present invention also relates to the use of nucleotide sequences that can hybridise to the nucleotide sequences discussed herein (including complementary sequences of those discussed herein).

The present invention also relates to the use of nucleotide sequences that are complementary to sequences that can hybridise to the nucleotide sequences discussed herein (including complementary sequences of those discussed herein).

Also included within the scope of the present invention are the use of polynucleotide sequences that are capable of hybridising to the nucleotide sequences discussed herein under conditions of intermediate to maximal stringency.

In a preferred aspect, the present invention covers the use of nucleotide sequences that can hybridise to the nucleotide sequences discussed herein, or the complement thereof, under stringent conditions (e.g., 50° C. and 0.2×SSC).

In a more preferred aspect, the present invention covers the use of nucleotide sequences that can hybridise to the nucleotide sequences discussed herein, or the complement thereof, under high stringency conditions (e.g., 65° C. and 0.1×SSC).

### Biologically Active

Preferably, the variant sequences etc. are at least as biologically active as the sequences presented herein.

As used herein “biologically active” refers to a sequence having a similar structural function (but not necessarily to the same degree), and/or similar regulatory function (but not necessarily to the same degree), and/or similar biochemical function (but not necessarily to the same degree) of the naturally occurring sequence.

### Recombinant

In one aspect the sequence for use in the present invention is a recombinant sequence—i.e., a sequence that has been prepared using recombinant DNA techniques.

These recombinant DNA techniques are within the capabilities of a person of ordinary skill in the art. Such techniques are explained in the literature, for example, J. Sambrook, E. F. Fritsch, and T. Maniatis, 1989, Molecular Cloning: A Laboratory Manual, Second Edition, Books 1-3, Cold Spring Harbor Laboratory Press.

### Synthetic

In one aspect the sequence for use in the present invention is a synthetic sequence—i.e., a sequence that has been prepared by in vitro chemical or enzymatic synthesis. It includes, but is not limited to, sequences made with optimal codon usage for host organisms—such as the methylotrophic yeasts Pichia and Hansenula.

### Expression of Polypeptides

A nucleotide sequence for use in the present invention or for encoding a polypeptide having the specific properties as defined herein can be incorporated into a recombinant replicable vector. The vector may be used to replicate and express the nucleotide sequence, in polypeptide form, in and/or from a compatible host cell. Expression may be controlled using control sequences which include promoters/enhancers and other expression regulation signals. Prokaryotic promoters and promoters functional in eukaryotic cells may be used. Tissue specific or stimuli specific promoters may be used. Chimeric promoters may also be used comprising sequence elements from two or more different promoters described above.

The polypeptide produced by a host recombinant cell by expression of the nucleotide sequence may be secreted or may be contained intracellularly depending on the sequence and/or the vector used. The coding sequences can be designed with signal sequences which direct secretion of the substance coding sequences through a particular prokaryotic or eukaryotic cell membrane.

### Expression Vector

The term “expression vector” means a construct capable of in vivo or in vitro expression.

Preferably, the expression vector is incorporated into the genome of a suitable host organism. The term “incorporated” preferably covers stable incorporation into the genome.

The nucleotide sequence encoding an enzyme for use in the present invention may be present in a vector in which the nucleotide sequence is operably linked to regulatory sequences capable of providing for the expression of the nucleotide sequence by a suitable host organism.

The vectors for use in the present invention may be transformed into a suitable host cell as described below to provide for expression of a polypeptide of the present invention.

The choice of vector e.g., a plasmid, cosmid, or phage vector will often depend on the host cell into which it is to be introduced.

The vectors for use in the present invention may contain one or more selectable marker genes such as a gene which confers antibiotic resistance e.g., ampicillin, kanamycin, chloramphenicol or tetracycline resistance. Alternatively, the selection may be accomplished by co-transformation (as described in WO 91/17243).

Vectors may be used in vitro, for example for the production of RNA or used to transfect, transform, transduce or infect a host cell.

The vector may further comprise a nucleotide sequence enabling the vector to replicate in the host cell in question. Examples of such sequences are the origins of replication of plasmids pUC19, pACYC177, pUB110, pE194, pAMB1 and pIJ702.

### Regulatory Sequences

In some applications, the nucleotide sequence for use in the present invention is operably linked to a regulatory sequence which is capable of providing for the expression of the nucleotide sequence, such as by the chosen host cell. By way of example, the present invention covers a vector comprising the nucleotide sequence of the present invention operably linked to such a regulatory sequence, i.e., the vector is an expression vector.

The term “operably linked” refers to a juxtaposition wherein the components described are in a relationship permitting them to function in their intended manner. A regulatory sequence “operably linked” to a coding sequence is ligated in such a way that expression of the coding sequence is achieved under condition compatible with the control sequences.

The term “regulatory sequences” includes promoters and enhancers and other expression regulation signals.

The term “promoter” is used in the normal sense of the art, e.g. an RNA polymerase binding site.

Enhanced expression of the nucleotide sequence encoding the enzyme of the present invention may also be achieved by the selection of heterologous regulatory regions, e.g., promoter, secretion leader and terminator regions.

Preferably, the nucleotide sequence according to the present invention is operably linked to at least a promoter.

Examples of suitable promoters for directing the transcription of the nucleotide sequence in a bacterial, fungal or yeast host are well known in the art

### Constructs

The term “construct”—which is synonymous with terms such as “conjugate”, “cassette” and “hybrid”—includes a nucleotide sequence encoding a polypeptide having the specific properties as defined herein for use according to the present invention directly or indirectly attached to a promoter. An example of an indirect attachment is the provision of a suitable spacer group such as an intron sequence, such as the Shi-intron or the ADH intron, intermediate the promoter and the nucleotide sequence of the present invention. The same is true for the term “fused” in relation to the present invention which includes direct or indirect attachment. In some cases, the terms do not cover the natural combination of the nucleotide sequence coding for the protein ordinarily associated with the wild type gene promoter and when they are both in their natural environment.

The construct may even contain or express a marker which allows for the selection of the genetic construct.

For some applications, preferably the construct comprises at least a nucleotide sequence of the present invention or a nucleotide sequence encoding a polypeptide having the specific properties as defined herein operably linked to a promoter.

### Organism

The term “organism” in relation to the present invention includes any organism that could comprise a nucleotide sequence according to the present invention or a nucleotide sequence encoding for a polypeptide having the specific properties as defined herein and/or products obtained therefrom.

The term “transgenic organism” in relation to the present invention includes any organism that comprises a nucleotide sequence coding for a polypeptide having the specific properties as defined herein and/or the products obtained therefrom, and/or wherein a promoter can allow expression of the nucleotide sequence coding for a polypeptide having the specific properties as defined herein within the organism. Preferably the nucleotide sequence is incorporated in the genome of the organism.

Suitable organisms include a prokaryote, fungus yeast or a plant.

The term “transgenic organism” does not cover native nucleotide coding sequences in their natural environment when they are under the control of their native promoter which is also in its natural environment.

Therefore, the transgenic organism of the present invention includes an organism comprising any one of, or combinations of, a nucleotide sequence coding for a polypeptide having the specific properties as defined herein, constructs as defined herein, vectors as defined herein, plasmids as defined herein, cells as defined herein, or the products thereof. For example the transgenic organism can also comprise a nucleotide sequence coding for a polypeptide having the specific properties as defined herein under the control of a promoter not associated with a sequence encoding a lipid acyltransferase in nature.

### Transformation of Host Cells/Organism

The host organism can be a prokaryotic or a eukaryotic organism.

Examples of suitable prokaryotic hosts include bacteria such as E. coli and Bacillus licheniformis, preferably B. licheniformis.

Teachings on the transformation of prokaryotic hosts is well documented in the art, for example see Sambrook et al. (Molecular Cloning: A Laboratory Manual, 2nd edition, 1989, Cold Spring Harbor Laboratory Press). If a prokaryotic host is used then the nucleotide sequence may need to be suitably modified before transformation—such as by removal of introns.

In another embodiment the transgenic organism can be a yeast.

Filamentous fungi cells may be transformed using various methods known in the art—such as a process involving protoplast formation and transformation of the protoplasts followed by regeneration of the cell wall in a manner known. The use of Aspergillus as a host microorganism is described in EP 0 238 023. In one embodiment, preferably T. reesei is the host organism.

Another host organism can be a plant. A review of the general techniques used for transforming plants may be found in articles by Potrykus (Annu Rev Plant Physiol Plant Mol Biol (1991) 42:205-225) and Christou (Agro-Food-Industry Hi-Tech March/April 1994 17-27). Further teachings on plant transformation may be found in EP-A-0449375.

General teachings on the transformation of fungi, yeasts and plants are presented in following sections.

### Transformed Fungus

A host organism may be a fungus—such as a filamentous fungus. Examples of suitable such hosts include any member belonging to the genera Fusarium, Thermomyces, Acremonium, Aspergillus, Penicillium, Mucor, Neurospora, Trichoderma and the like. In one embodiment, Trichoderma is the host organism, preferably T. reesei.

Teachings on transforming filamentous fungi are reviewed in U.S. Pat. No. 5,741,665 which states that standard techniques for transformation of filamentous fungi and culturing the fungi are well known in the art. An extensive review of techniques as applied to N. crassa is found, for example in Davis and de Serres, Methods Enzymol (1971) 17A: 79-143.

Further teachings on transforming filamentous fungi are reviewed in U.S. Pat. No. 5,674,707.

In one aspect, the host organism can be of the genus Aspergillus, such as Aspergillus niger.

A transgenic Aspergillus according to the present invention can also be prepared by following, for example, the teachings of Turner G. 1994 (Vectors for genetic manipulation. In: Martinelli S. D., Kinghom J. R. (Editors) Aspergillus: 50 years on. Progress in industrial microbiology vol 29. Elsevier Amsterdam 1994. pp. 641-666).

Gene expression in filamentous fungi has been reviewed in Punt et al. Trends Biotechnol. (2002); 20(5):200-6, Archer & Peberdy Crit. Rev. Biotechnol. (1997) 17:273-306.

### Transformed Yeast

In another embodiment, the transgenic organism can be a yeast.

A review of the principles of heterologous gene expression in yeast are provided in, for example, Methods Mol Biol (1995), 49:341-54, and Curr Opin Biotechnol (1997); 8:554-60.

In this regard, yeast—such as the species Saccharomyces cerevisi or Pichia pastoris or Hansenula polymorpha (see FEMS Microbiol Rev (2000 24:45-66), may be used as a vehicle for heterologous gene expression.

A review of the principles of heterologous gene expression in Saccharomyces cerevisiae and secretion of gene products is given by E Hinchcliffe E Kenny (1993, “Yeast as a vehicle for the expression of heterologous genes”, Yeasts, Vol 5, Anthony H Rose and J. Stuart Harrison, eds, 2nd edition, Academic Press Ltd.).

For the transformation of yeast, several transformation protocols have been developed. For example, a transgenic Saccharomyces according to the present invention can be prepared by following the teachings of Hinnen et al., (1978, Proceedings of the National Academy of Sciences of the USA 75, 1929); Beggs, J D (1978, Nature, London, 275, 104); and Ito, H et al. (1983, J Bacteriology 153, 163-168).

The transformed yeast cells may be selected using various selective markers—such as auxotrophic markers dominant antibiotic resistance markers.

A suitable yeast host organism can be selected from the biotechnologically relevant yeasts species such as, but not limited to, yeast species selected from Pichia spp., Hansenula spp., Kluyveromyces, Yarrowinia spp., Saccharomyces spp., including S. cerevisiae, or Schizosaccharomyce spp., including Schizosaccharomyce pombe.

A strain of the methylotrophic yeast species Pichia pastoris may be used as the host organism.

In one embodiment, the host organism may be a Hansenula species, such as H. polymorpha (as described in WO 01/39544).

### Transformed Plants/Plant Cells

A host organism suitable for the present invention may be a plant. A review of the general techniques may be found in articles by Potrykus (Annu Rev Plant Physiol Plant Mol Biol (1991) 42:205-225) and Christou (Agro-Food-Industry Hi-Tech March/April 1994 17-27), or in WO 01/16308. The transgenic plant may produce enhanced levels of phytosterol esters and phytostanol esters, for example.

### Culturing and Production

Host cells transformed with the nucleotide sequence of the present invention may be cultured under conditions conducive to the production of the encoded enzyme and which facilitate recovery of the enzyme from the cells and/or culture medium.

The medium used to cultivate the cells may be any conventional medium suitable for growing the host cell in questions and obtaining expression of the enzyme.

The protein produced by a recombinant cell may be displayed on the surface of the cell.

The enzyme may be secreted from the host cells and may conveniently be recovered from the culture medium using well-known procedures.

### Secretion

Often, it is desirable for the polypeptide to be secreted from the expression host into the culture medium from where the enzyme may be more easily recovered. According to the present invention, the secretion leader sequence may be selected on the basis of the desired expression host. Hybrid signal sequences may also be used with the context of the present invention.

Typical examples of secretion leader sequences not associated with a nucleotide sequence encoding a lipid acyltransferase in nature are those originating from the fungal amyloglucosidase (AG) gene (glaA—both 18 and 24 amino acid versions e.g., from Aspergillus), the a-factor gene (yeasts e.g., Saccharomyces, Kluyveromyces and Hansenula) or the α-amylase gene (Bacillus).

### Detection

A variety of protocols for detecting and measuring the expression of the amino acid sequence are known in the art. Examples include enzyme-linked immunosorbent assay (ELISA), radioimmunoassay (RIA) and fluorescent activated cell sorting (FACS).

A wide variety of labels and conjugation techniques are known by those skilled in the art and can be used in various nucleic and amino acid assays.

A number of companies such as Pharmacia Biotech (Piscataway, N.J., USA), Promega (Madison, Wis., USA), and US Biochemical Corp (Cleveland, Ohio, USA) supply commercial kits and protocols for these procedures.

Suitable reporter molecules or labels include those radionuclides, enzymes, fluorescent, chemiluminescent, or chromogenic agents as well as substrates, cofactors, inhibitors, magnetic particles and the like. Patents teaching the use of such labels include U.S. Pat. No. 3,817,837; U.S. Pat. No. 3,850,752; U.S. Pat. No. 3,939,350; U.S. Pat. No. 3,996,345; U.S. Pat. No. 4,277,437; U.S. Pat. No. 4,275,149 and U.S. Pat. No. 4,366,241.

Also, recombinant immunoglobulins may be produced as shown in U.S. Pat. No. 4,816,567.

### Fusion Proteins

An enzyme for use in the present invention may be produced as a fusion protein, for example to aid in extraction and purification thereof. Examples of fusion protein partners include glutathione-5-transferase (GST), 6×His, GAL4 (DNA binding and/or transcriptional activation domains) and β-galactosidase. It may also be convenient to include a proteolytic cleavage site between the fusion protein partner and the protein sequence of interest to allow removal of fusion protein sequences. Preferably the fusion protein will not hinder the activity of the protein sequence.

Gene fusion expression systems in E. coli have been reviewed in Curr. Opin. Biotechnol. (1995) 6:501-6.

The amino acid sequence of a polypeptide having the specific properties as defined herein may be ligated to a non-native sequence to encode a fusion protein. For example, for screening of peptide libraries for agents capable of affecting the substance activity, it may be useful to encode a chimeric substance expressing a non-native epitope that is recognised by a commercially available antibody.

### Additional POIs

The sequences for use according to the present invention may also be used in conjunction with one or more additional proteins of interest (POIs) or nucleotide sequences of interest (NOIs).

Non-limiting examples of POIs include: proteins or enzymes involved in starch metabolism, proteins or enzymes involved in glycogen metabolism, acetyl esterases, aminopeptidases, amylases, arabinases, arabinofuranosidases, carboxypeptidases, catalases, cellulases, chitinases, chymosin, cutinase, deoxyribonucleases, epimerases, esterases, α-galactosidases, β-galactosidases, α-glucanases, glucan lysases, endo-β-glucanases, glucoamylases, glucose oxidases, α-glucosidases, β-glucosidases, glucuronidases, hemicellulases, hexose oxidases, hydrolases, invertases, isomerases, laccases, lipases, lyases, mannosidases, oxidases, oxidoreductases, pectate lyases, pectin acetyl esterases, pectin depolymerases, pectin methyl esterases, pectinolytic enzymes, peroxidases, phenoloxidases, phytases, polygalacturonases, proteases, rhamno-galacturonases, ribonucleases, thaumatin, transferases, transport proteins, transglutaminases, xylanases, hexose oxidase (D-hexose: O₂-oxidoreductase, EC 1.1.3.5) or combinations thereof. The NOI may even be an antisense sequence for any of those sequences.

The POI may even be a fusion protein, for example to aid in extraction and purification.

The POI may even be fused to a secretion sequence.

### Detergent

The compositions of the present invention may form a component of a cleaning and/or detergent composition. In particular, certain embodiments of the present invention may additionally include a detergent.

In general, cleaning and detergent compositions are well described in the art and reference is made to WO 96/34946; WO 97/07202; and WO 95/30011 for further description of suitable cleaning and detergent compositions.

The compounds of the invention may for example be formulated as a hand or machine laundry detergent composition, including a laundry additive composition suitable for pretreatment of stained fabrics, and a rinse added fabric softener composition, or be formulated as a detergent composition for use in general household hard surface cleaning operations (including car washing or cleaning compositions), or be formulated for hand or machine dishwashing operations. It may also be formulated for use as a personal hygiene product, including but not limited to hand soaps, shampoos and shower gels.

In one embodiment the laundry composition of the present invention may comprise the lipolytic enzyme, hydrophobin and, optionally, detergent in combination with one or more enzymes, such as a protease, a carboxypeptidase, an aminopeptidase, an amylase, a glucoamylase, a maltogenic amylase, a non-maltogenic amylase, an α-galactosidase, a β-galactosidase, an α-glucosidase, a β-glucosidase, a phospholipase, a glycosyltransferase, a chitinase, a cutinase, a carbohydrase, a cellulase, a pectinase, a mannanase, a mannosidase, an arabinase, a galactanase, a xylanase, an oxidase, a polyesterase, a laccase, a cyclodextrin esterase, a phytase, a catalase, a haloperoxidase, and/or a peroxidase, a pectinolytic enzyme, a peptidoglutaminase, a polyphenoloxidase, a transglutaminase, a deoxyribonuclease, a ribonuclease, and/or combinations thereof. In general the properties of the chosen enzyme(s) should be compatible with the selected detergent, (e.g., pH-optimum, compatibility with other enzymatic and non-enzymatic ingredients, etc.), and the enzyme(s) should be present in effective amounts.

Proteases: suitable proteases include those of animal, vegetable or microbial origin. Chemically modified or protein engineered mutants are also suitable. The protease may be a serine protease or a metalloprotease, e.g., an alkaline microbial protease or a trypsin-like protease. Examples of alkaline proteases are subtilisins, especially those derived from Bacillus sp., e.g., subtilisin Novo, subtilisin Carlsberg, subtilisin 309 (see, e.g., U.S. Pat. No. 6,287,841), subtilisin 147, and subtilisin 168 (see, e.g., WO 89/06279). Examples of trypsin-like proteases are trypsin (e.g., of porcine or bovine origin), and Fusarium proteases (see, e.g., WO 89/06270 and WO 94/25583). Examples of useful proteases also include but are not limited to the variants described in WO 92/19729 and WO 98/20115. Suitable commercially available protease enzymes include ALCALASE®, SAVINASE®, LIQUANASE®, OVOZYME®, POLARZYME®, ESPERASE®, EVERLASE®, and KANNASE® (Novozymes, formerly Novo Nordisk A/S); EXCELLASE™, MAXATASE®, MAXACAL™, MAXAPEM™, PROPERASE®, PROPERASE L®, PURAFECT®, PURAFECT L®, PURAFAST™, OXP™, FN2™, and FN3™ (Genencor—a division of Danisco A/S).

Polyesterases: Suitable polyesterases include, but are not limited to, those described in WO 01/34899 (Genencor) and WO 01/14629 (Genencor), and can be included in any combination with other enzymes discussed herein.

Amylases: The compositions can comprise amylases such as α-amylases (EC 3.2.1.1), G4-forming amylases (EC 3.2.1.60), β-amylases (EC 3.2.1.2) and γ-amylases (EC 3.2.1.3). These can include amylases of bacterial or fungal origin, chemically modified or protein engineered mutants are included. Commercially available amylases, such as, but not limited to, DURAMYL®, TERMAMYL™, FUNGAMYL® and BAN™ (Novozymes, formerly Novo Nordisk A/S), RAPIDASE®, and PURASTAR® (Danisco USA, Inc.), LIQUEZYME™, NATALASE™, SUPRAMYL™, STAINZYME™, FUNGAMYL and BAN™ (Novozymes A/S), RAPIDASE™, PURASTAR™, PURASTAROXAM™ and POWERASE™ (from Danisco USA Inc.), GRINDAMYL™ PowerFresh, POWERFlex™ and GRINDAMYL PowerSoft (from Danisco A/S).

Peroxidases/Oxidases: Suitable peroxidases/oxidases contemplated for use in the compositions include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257. Commercially available peroxidases include GUARDZYME® (Novozymes A/S).

Cellulases: Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307; 5,648,263; 5,691,178; 5,776,757; and WO 89/09259, for example. Exemplary cellulases contemplated for use are those having colour care benefit for the textile. Examples of such cellulases are cellulases described in EP 0495257; EP531372; WO 99/25846 (Genencor International, Inc.), WO 96/34108 (Genencor International, Inc.), WO 96/11262; WO 96/29397; and WO 98/08940, for example. Other examples are cellulase variants, such as those described in WO 94/07998; WO 98/12307; WO 95/24471; WO 99/01544; EP 531 315; U.S. Pat. Nos. 5,457,046; 5,686,593; and 5,763,254. Commercially available cellulases include CELLUZYME®, CAREZYME® and ENDOLASE® (Novozymes, formerly Novo Nordisk A/S); CLAZINASE™ and PURADAX® HA (Genencor); and KAC-500(B)™ (Kao Corporation).

Examples of commercially available mannanases include MANNAWAY™ (Novozymes, Denmark) and MANNASTAR™ (Genencor).

The composition of the invention can be formulated as either a solid or a liquid. Examples of formulations include granulates, pellets, slurries, bars, pastes, foams, gels, strips, etc. Preferred detergent additive formulations are granulates, in particular non-dusting granulates, liquids, in particular stabilized liquids, or slurries. A liquid detergent may be aqueous, typically containing up to 70% water and 0-30% organic solvent, or non-aqueous.

Non-dusting granulates may be produced, e.g., as disclosed in U.S. Pat. Nos. 4,106,991 and 4,661,452 and may optionally be coated by methods known in the art. Examples of waxy coating materials are poly (ethylene oxide) products (polyethylene glycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP-A-238216.

The detergent composition may also comprise one or more further surfactants, which may be non-ionic including semi-polar and/or anionic and/or cationic and/or zwitterionic. The surfactants are typically present at a level of from 0.1% to 60% by weight.

When included therein the detergent will usually contain from about 1% to about 40% of an anionic surfactant such as linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap.

When included therein the detergent will usually contain from about 0.2% to about 40% of a non-ionic surfactant such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or other N-acyl or N-alkyl derivatives of glucosamine.

The detergent may contain 0-65% of a detergent builder or complexing agent such as zeolite, diphosphate, triphosphate, phosphonate, carbonate, citrate, nitrilotriacetic acid, ethylenediaminetetraacetic acid, diethylenetriaminepentaacetic acid, alkyl- or alkenylsuccinic acid, soluble silicates or layered silicates (e.g. SKS-6 from Hoechst).

The detergent may comprise one or more polymers. Examples are carboxymethylcellulose, poly (vinylpyrrolidone), poly (ethylene glycol), poly (vinyl alcohol), poly (vinylpyridine-N-oxide), poly (vinylimidazole), polycarboxylates such as polyacrylates, maleic/acrylic acid copolymers and lauryl methacrylate/acrylic acid copolymers.

The detergent may contain a bleaching system which may comprise a hydrogen peroxide source such as perborate or percarbonate which may be combined with a peracid-forming bleach activator such as tetraacetylethylenediamine or nonanoyloxybenzenesulfonate. Alternatively, the bleaching system may comprise peroxyacids of e.g., the amide, imide, or sulfone type.

The enzyme(s) of the detergent composition of the invention may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g., WO 92/19709 and WO 92/19708.

The detergent may also contain other conventional detergent ingredients such as fabric conditioners including clays, foam boosters, suds suppressors, anti-corrosion agents, soil-suspending agents, anti-soil redeposition agents, dyes, bactericides, optical brighteners, hydrotropes, tarnish inhibitors, or perfumes.

### Dosage

In the compositions of the present invention, the hydrophobin may be present in any concentration sufficient to enable it to exhibit the effects described herein. Suitably, the hydrophobin is present in a concentration of between 0.001% and 5%, preferably 0.002% to 2.5%, more preferably 0.005% to 1%, even more preferably 0.01% to 0.5% by weight of the total weight of the composition. In particularly preferred examples, the hydrophobin is present in a concentration of 0.01, 0.05, 0.1, 0.25 or 0.4% by weight of the total weight of the composition.

In the compositions of the present invention, the lipolytic enzyme may be present in any concentration sufficient to enable it to exhibit the effects described herein.

Suitably, the lipolytic enzyme is present in a concentration of 0.001 to 400 ppm, preferably 0.002 to 200 ppm, more preferably 0.005 to 100 ppm, even more preferably 0.01 to 50 ppm, still more preferably 0.02 to 25 ppm, of pure enzyme protein by weight of the total weight of the composition.

Suitably, the lipolytic enzyme is present in a concentration of 0.025 to 25, preferably 0.05 to 10, more preferably 0.1 to 5, units of enzyme activity per g of the composition. The activity is measured according to the trioctanoate assay described below, wherein 1 unit of activity represents 1 μmol of the free fatty acid produced by 1 g of enzyme solution in 1 minute.

Where the compositions of the present invention include a detergent, the detergent may be present in any concentration sufficient to enable it to exhibit the effects described herein. Suitably, the detergent is present in a concentration of between 0.001 and 20 g/L, preferably 0.01 to 10 g/L, more preferably 0.05 to 5 g/L, even more preferably 0.1 to 2 5 g/L by Do the litres refer to the volume of the washing solution In particularly preferred examples, the detergent is present in a concentration of 0.01, 0.05, 0.1, 0.25 or 0.4 g/L of the washing solution.

### Trioctanoate Assay

Reaction emulsions of trioctanoate in the compositions was prepared from 0.4% trioctanoate pre-suspended in ethanol (5%), in one of two buffers: 0.05M 4-(2-hydroxyethyl)-1-piperazineethanesulfonic acid (HEPES) adjusted to pH 8.2, or 0.05M N-cyclohexyl-3-aminopropanesulfonic acid (CAPS) adjusted to pH 10. For both buffers water hardness adjusted to 240 ppm. The final assay mixtures contained varying amounts of detergents, to aid in the emulsification of the triglyceride.

The reaction emulsions were made by applying high shear mixing for 2 minutes (24000 m⁻¹, Ultra Turrax T25, Janke & Kunkel), and then transferring 150 μL to 96-well microtiter plate wells already containing 30 μL enzyme samples. Free fatty acid generation was measured using an in vitro enzymatic colorimetric assay for the quantitative determination of non-esterified fatty acids (NEFA). This method is specific for free fatty acids, and relies upon the acylation of coenzyme A (CoA) by the fatty acids in the presence of added acyl-CoA synthetase. The acyl-CoA thus produced is oxidized by added acyl-CoA oxidase with generation of hydrogen peroxide, in the presence of peroxidase. This permits the oxidative condensation of 3-methyl-N-ethyl-N(β-hydroxyethyl)-aniline with 4-aminoantipyrine to form a purple colored adduct which can be measured colorimetrically. The amount of free fatty acids generated after a 6 minute incubation at 30° C. was determined using the materials in a NEFA HR(2) kit (Wako Chemicals GmbH, Germany) by transferring 30 μL of the hydrolysis solution to 96-well microtiter plate wells already containing 120 μL NEFA A solution. Incubation for 3 min at 30° C. was followed by addition of 60 μL NEFA B solution. After incubation for 4.5 min at 30° C. OD at 520 nm was measured.

### Laundry Compositions

The hydrophobins used in the present invention may be generated in situ in a laundry composition, for example by hydrolysis of hydrophobin precursor (such as a hydrophobin fusion protein) in the laundry composition.

The hydrophobin precursor (such as a hydrophobin fusion protein) is required in order to generate in situ the hydrophobins used in the present invention. It may be present as an initial component of the laundry composition. Alternatively, if no or insufficient hydrophobin precursor is initially present, this component can be added to the composition.

If required, a catalyst (particularly an enzyme, especially a protease enzyme) may be present. It may be present as an initial component of the laundry composition. Alternatively, if no or insufficient catalyst is initially present, this component can be added to the composition.

The laundry composition may further comprise a stain, which may be a lipid (in particular, a triglyceride and/or a diglyceride and/or a monoglyceride). The stain may be on a surface, for example a fabric. The laundry composition of the present invention may therefore comprise a surface for example a fabric.

Converting a hydrophobin precursor into a hydrophobin used in the present invention may help remove a stain comprising a lipid from a fabric.

### Cleaning Methods

The present invention further comprises a method of removing a lipid-based stain from a surface by contacting the surface with a composition according to the invention. In addition, the present invention comprises a method of cleaning a surface, comprising contacting the surface with a composition according to the invention. Furthermore, the present invention comprises a method of cleaning an item (particularly although not exclusively a clothing item or a tableware item), comprising contacting the item with a composition according to the invention.

In another aspect, methods for removing oily stains from fabrics are provided. The methods generally involve identifying fabrics having oily stains, contacting the fabrics with a composition of the invention, and rinsing the fabric to remove the oily stain from the fabrics.

In some embodiments, the lipolytic enzyme, the hydrophobin and, optionally, the detergent are present together in a single composition. In some embodiments, the lipolytic enzyme, the hydrophobin and, optionally, the detergent are separate in different compositions that are combined prior to contacting the fabric, or mixed together on the fabric. Therefore, application of the lipase and the adjuvant may be simultaneous of sequential. In some embodiments, the contacting occurs in a wash pretreatment step, i.e., prior to hand or machine-washing a fabric. In some embodiments, the contacting occurs at the time of hand or machine-washing the fabric. The contacting may occur as a result of mixing the present compositions with wash water, spraying, pouring, or dripping the composition on the fabric, or applying the composition using an applicator.

The methods are effective for removing a variety of oil stains, or portions of oily stains, which typically include esters of fatty acids, such as triglycerides.

It will be appreciated that rinsing may occur some time after the washing, and that in some aspects the present method of cleaning is essentially complete following the contacting of the fabric with the composition.

### Foodstuff

The compositions of the present invention may be used as a component of a foodstuff. The term “foodstuff” as used herein means a substance which is suitable for human and/or animal consumption.

Suitably, the term “foodstuff” as used herein may mean a foodstuff in a form which is ready for consumption. Alternatively or in addition, however, the term foodstuff as used herein may mean one or more food materials which are used in the preparation of a foodstuff. By way of example only, the term foodstuff encompasses both baked goods produced from dough as well as the dough used in the preparation of said baked goods.

The foodstuff may be in the form of a solution or as a solid—depending on the use and/or the mode of application and/or the mode of administration.

When used as—or in the preparation of—a food—such as functional food—the composition of the present invention may be used in conjunction with one or more of: a nutritionally acceptable carrier, a nutritionally acceptable diluent, a nutritionally acceptable excipient, a nutritionally acceptable adjuvant, a nutritionally active ingredient.

In a preferred aspect the present invention provides a foodstuff as defined above wherein the foodstuff is selected from one or more of the following: eggs, egg-based products, including but not limited to mayonnaise, salad dressings, sauces, ice creams, egg powder, modified egg yolk and products made therefrom; baked goods, including breads, cakes, sweet dough products, laminated doughs, liquid batters, muffins, doughnuts, biscuits, crackers and cookies; confectionery, including chocolate, candies, caramels, halawa, gums, including sugar free and sugar sweetened gums, bubble gum, soft bubble gum, chewing gum and puddings; frozen products including sorbets, preferably frozen dairy products, including ice cream and ice milk; dairy products, including cheese, butter, milk, coffee cream, whipped cream, custard cream, milk drinks and yoghurts; mousses, whipped vegetable creams, meat products, including processed meat products; edible oils and fats, aerated and non-aerated whipped products, oil-in-water emulsions, water-in-oil emulsions, margarine, shortening and spreads including low fat and very low fat spreads; dressings, mayonnaise, dips, cream based sauces, cream based soups, beverages, spice emulsions and sauces.

Suitably the foodstuff in accordance with the present invention may be a “fine food”, including cakes, pastry, confectionery, chocolates, fudge and the like.

In one aspect the foodstuff in accordance with the present invention may be a dough product or a baked product, such as bread, a fried product, a snack, cakes, pies, brownies, cookies, noodles, snack items such as crackers, graham crackers, pretzels, and potato chips, and pasta.

In another aspect the foodstuff in accordance with the present invention may be a convenience food, such as a part-baked or part-cooked product. Examples of such part-baked or part-cooked product include part-baked versions of the dough and baked products described above.

In a further aspect, the foodstuff in accordance with the present invention may be a plant derived food product such as flours, pre-mixes, oils, fats, cocoa butter, coffee whitener, salad dressings, margarine, spreads, peanut butter, shortenings, ice cream, cooking oils.

In another aspect, the foodstuff in accordance with the present invention may be a dairy product, including butter, milk, cream, cheese such as natural, processed, and imitation cheeses in a variety of forms (including shredded, block, slices or grated), cream cheese, ice cream, frozen desserts, yoghurt, yoghurt drinks, butter fat, anhydrous milk fat, other dairy products. The enzyme according to the present invention may improve fat stability in dairy products.

In another aspect, the foodstuff in accordance with the present invention may be a food product containing animal derived ingredients, such as processed meat products, cooking oils, shortenings.

In a further aspect, the foodstuff in accordance with the present invention may be a beverage, a fruit, mixed fruit, a vegetable, a marinade or wine.

In one aspect, the foodstuff in accordance with the present invention is a plant derived oil (i.e. a vegetable oil), such as olive oil, sunflower oil, peanut oil or rapeseed oil. The oil may be a degummed oil.

### EXAMPLES

### Example 1

The following experiments were carried out to test whether the cleaning performance of a lipase is enhanced by adding hydrophobin in the presence or absence of commercially available heat inactivated detergent.

The lipases used were as follows (each dosed in a single dose):

LIPEX™ (abH23.1, fungal) (SEQ ID NO: 11) (commercially available from Novozymes A/S), 1.25 mg in 1 mL
LIPOMAX™ (abH15.2, family I-1) (SEQ ID NO: 15) (commercially available from Danisco A/S), 6 mg in 1 mL
SprLip2 (abH16, family 1-7) (SEQ ID NO: 17), 258 μL in 1 mL
TfuLip2 (abH25.1, family III) (SEQ ID NO: 16), 30.8 μL in 1 mL

The hydrophobin used was hydrophobin HFBII (SEQ ID NO: 2; obtainable from the fungus Trichoderma reesei). 26.6 g HFBII (containing 150 mg/g hydrophobin protein) was dissolved in 100 mL water to give a solution containing 40 g/L hydrophobin protein. The solution was diluted as appropriate to give a hydrophobin dose of 0.01, 0.05, 0.1, 0.25 and 0.40% by weight of the total weight of the composition.

The detergents used were heat inactivated liquid detergent (ARIEL™ colour liquid) and heat inactivated powder detergent (ARIEL™ colour powder). These are commercially available from Procter & Gamble. The detergents were diluted as appropriate to give a dose of 0, 0.1, 0.25 and 0.4 g/L.

The detergents were heat-inactivated as follows: the liquid detergents were placed in a water bath at 95° C. for 2 hours, while 0.1 g/mL preparations in water of the powder detergents were boiled on a hot plate for 1 hour. Heat treatments inactivate the enzymatic activity of any protein components in commercial detergent formulas, while retaining the properties of the nonenzymatic detergent components. Following heating, the detergents are diluted and assayed for lipase enzyme activity.

Cleaning performance of lipase and hydrophobin on stained fabrics was tested in a microswatch assay format. Stain removal experiments were carried out using a lipid-containing technical stain (CS-61 swatches: cotton, beef fat with colorant, purchased from Center for Testmaterials, Netherlands) set in a 24-well plate format (Nunc, Denmark). Each assay well was set to contain a pre-cut 13 mm piece of CS-61 swatch. Swatches were pre-read using a scanner (MiCrotek Scan Maker 900) and placed in the 24-well plate.

The buffers used were 20 mM 4-(2-hydroxyethyl)-1-piperazineethanesulfonic acid (HEPES) (0.2M, pH 8.2) for testing liquid detergents, and 20 mM N-cyclohexyl-3-aminopropanesulfonic acid (CAPS) (0.2M, pH 10.0) for testing powder detergents. Water hardness was adjusted to 24 degrees French (FH—one degree French is defined as 10 milligrams of calcium carbonate per litre of water) using 15000 ppm 2/1 Ca²⁺/Mg²⁺ diluted to 2400 ppm (dilution factor 6.25) for both buffers.

A 24 well plate was used, each well containing 1 ml solution. The hydrophobin concentration in each row was as follows: zero; 0.01%; 0.05%; 0.1%; 0.25%; and 0.4% by weight of the total weight of the composition. The detergent concentration in each column was as follows: zero; 0.1 g/L; 0.25 g/L; and 0.4 g/L.

900 μL of the appropriate buffer described above was added to each swatch-containing well of the 24-well plate. 100 μL hydrophobin solution was added into each well. To initiate the reaction, enzyme samples were added at a volume of 100 μL into each well. The plates were shaken for 30 minutes at 200 rpm at 37° C. After incubation, the reaction buffer was removed and the fabric in each well was rinsed with 1 mL distilled water three times. After removing the rinse the swatches were dried at 50° C. for 4 hours and reflectance was measured. Cleaning performance was quantified after a single wash cycle. Stain removal was calculated as the difference of the post- and pre-cleaning RGB colour measurements for each swatch. RGB measurements were taken with a scanner (MiCrotek Scan Maker 900).

The difference in Stain Removal Index (ΔSRI) values of the washed fabric were calculated in relation to the unwashed fabrics using the formula:

$$\% Soil {Removal}_{( RGB )} = ( Soil removal Δ {E}_{( RGB )} / Initial soil Δ {E}_{( RGB )} ) \times 100 \%$$

$$Where \text{:}$$

$$Soil removal Δ {E}_{( RGB )} = \sqrt{( {( {R}_{after} - {R}_{before} )}^{2} + {( {G}_{after} - {G}_{before} )}^{2} + {( {B}_{after} - {B}_{before} )}^{2} )}$$

$$And \text{:}$$

$$Initial soil Δ {E}_{( RGB )} = \sqrt{( {( {R}_{ref} - {R}_{before} )}^{2} + {( {G}_{ref} - {G}_{before} )}^{2} + {( {B}_{ref} - {B}_{before} )}^{2} )}$$

RGB_{ref} values are the values of the unsoiled cotton (white).

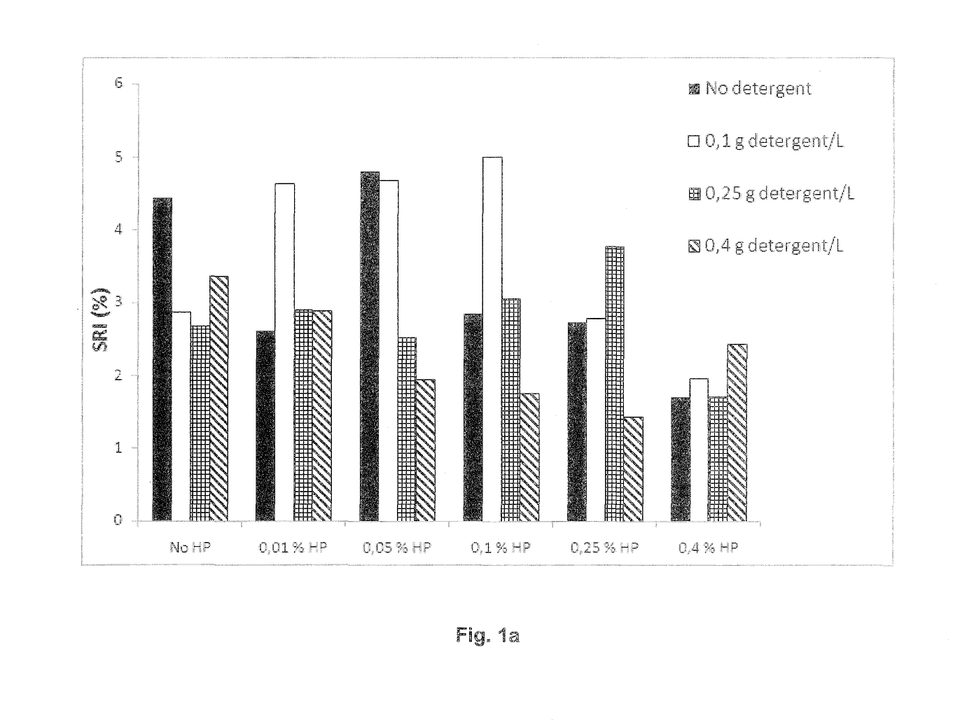

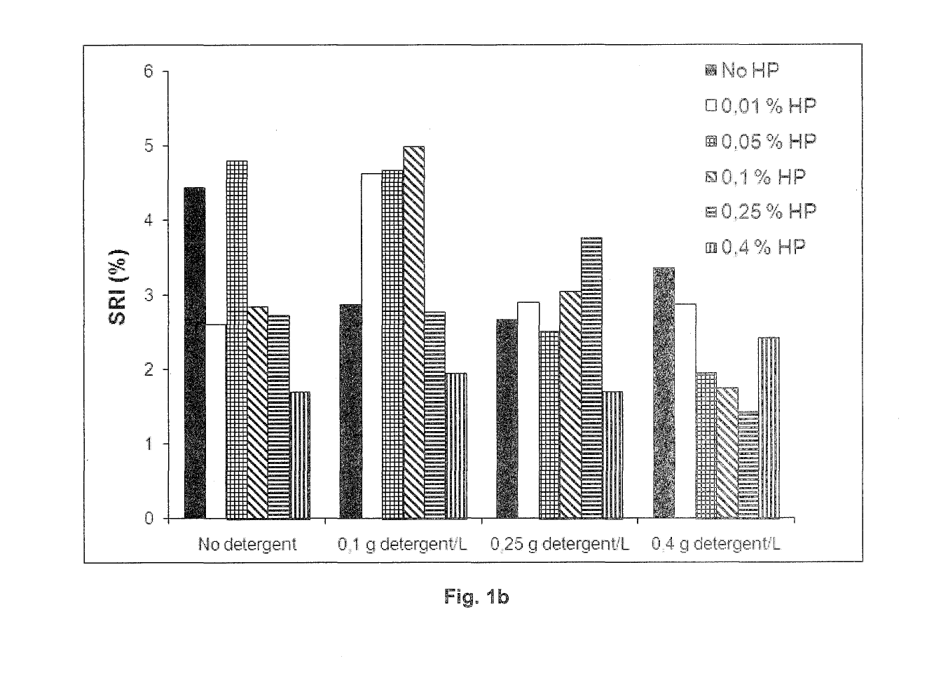

The results are shown in FIG. 1a through 5e, as follows:

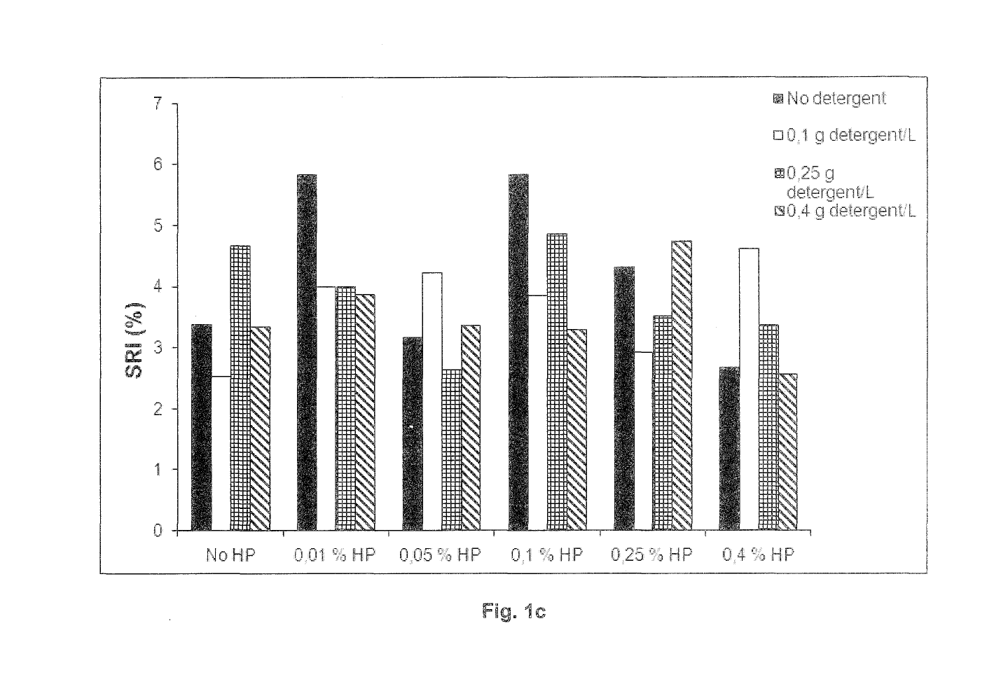

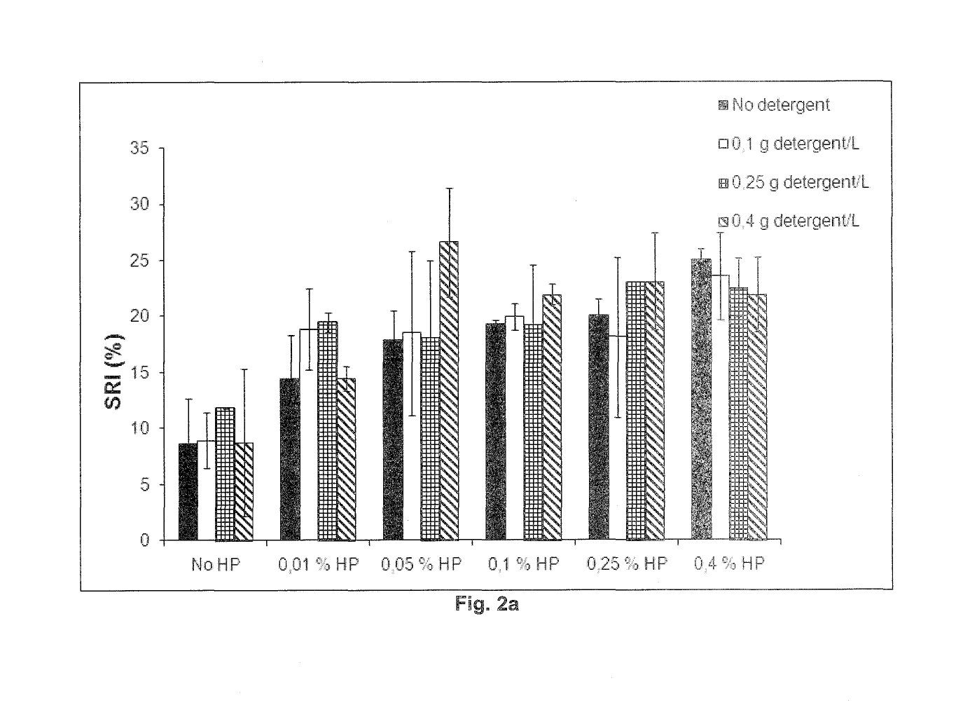

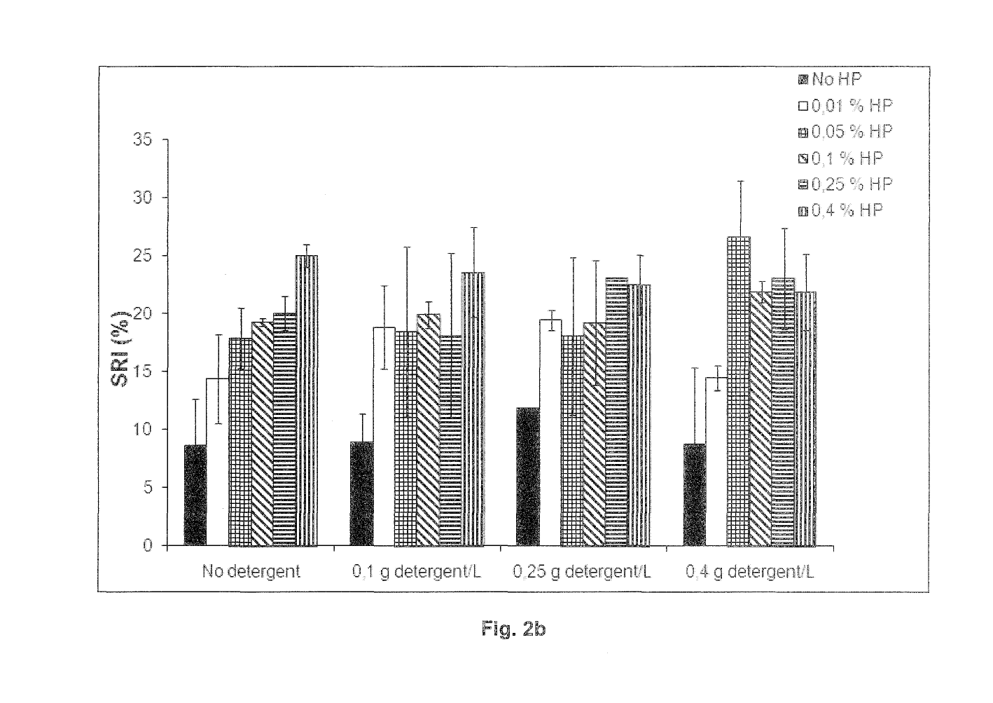

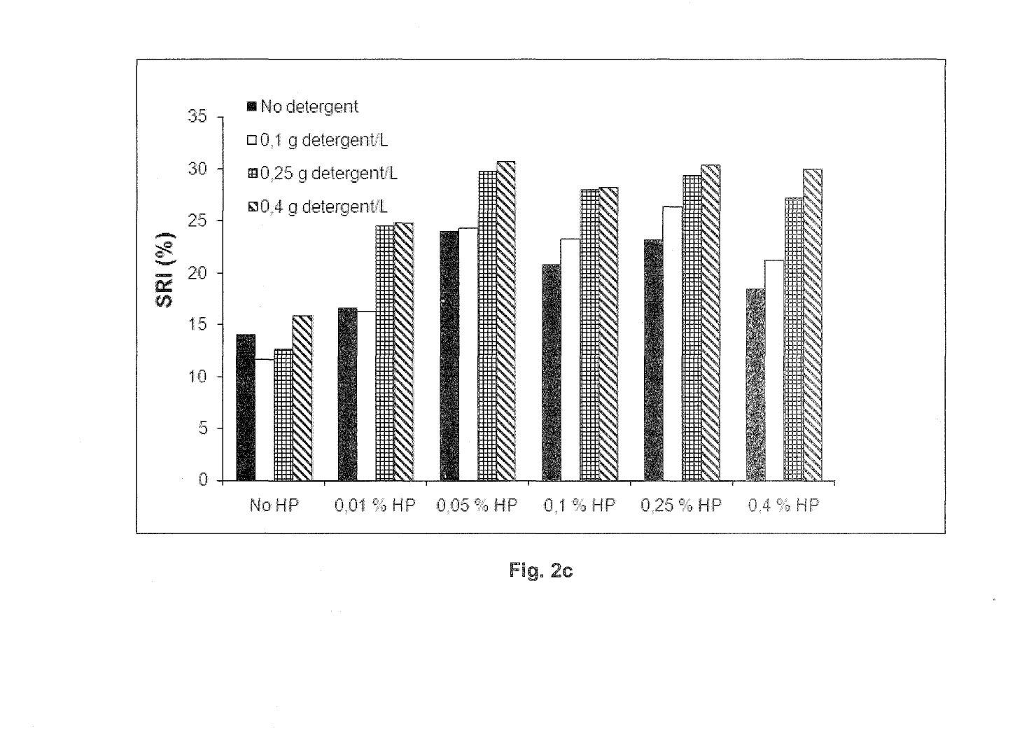

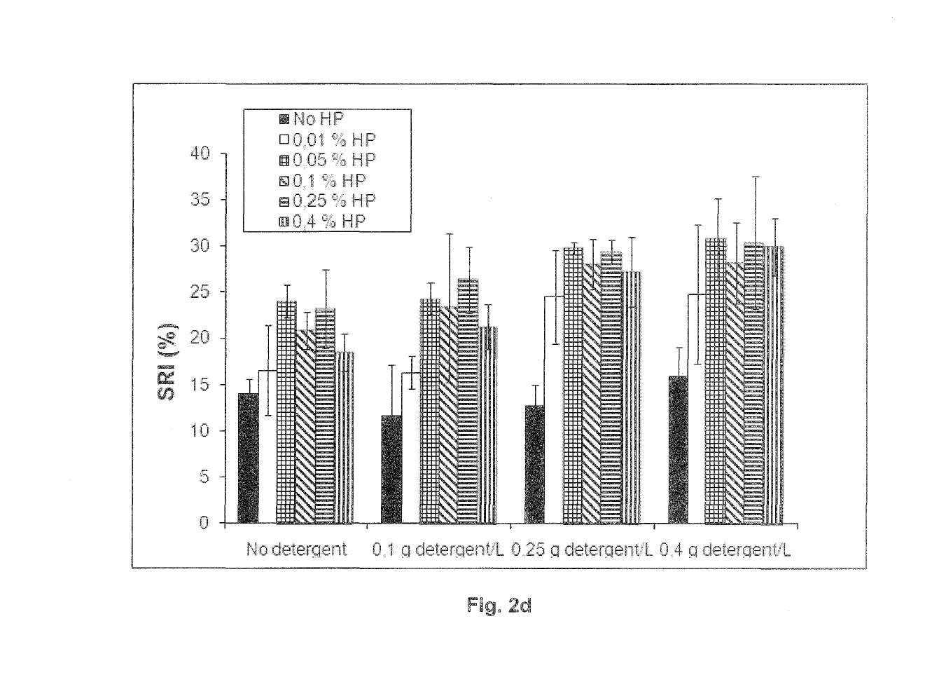

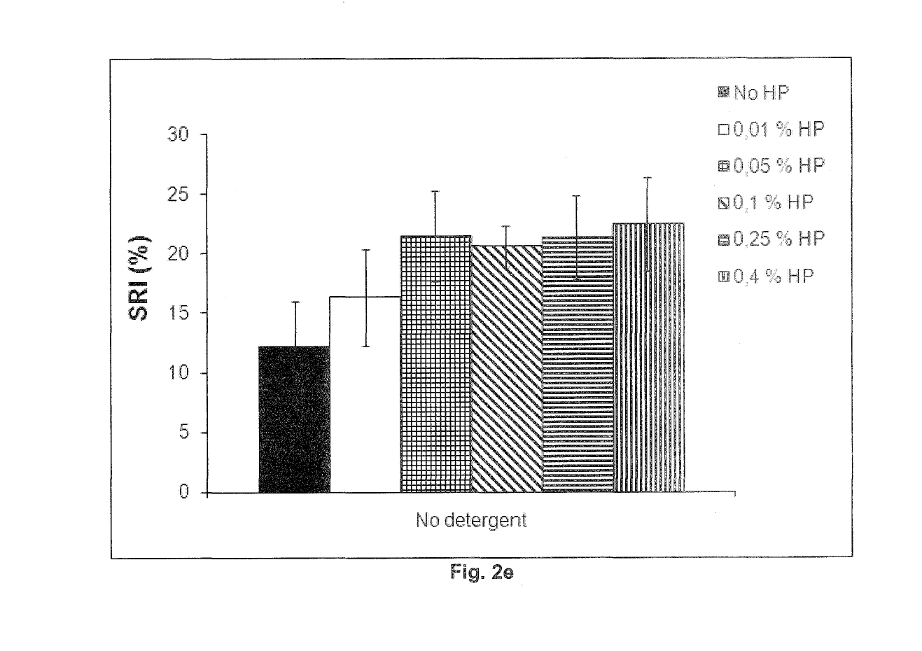

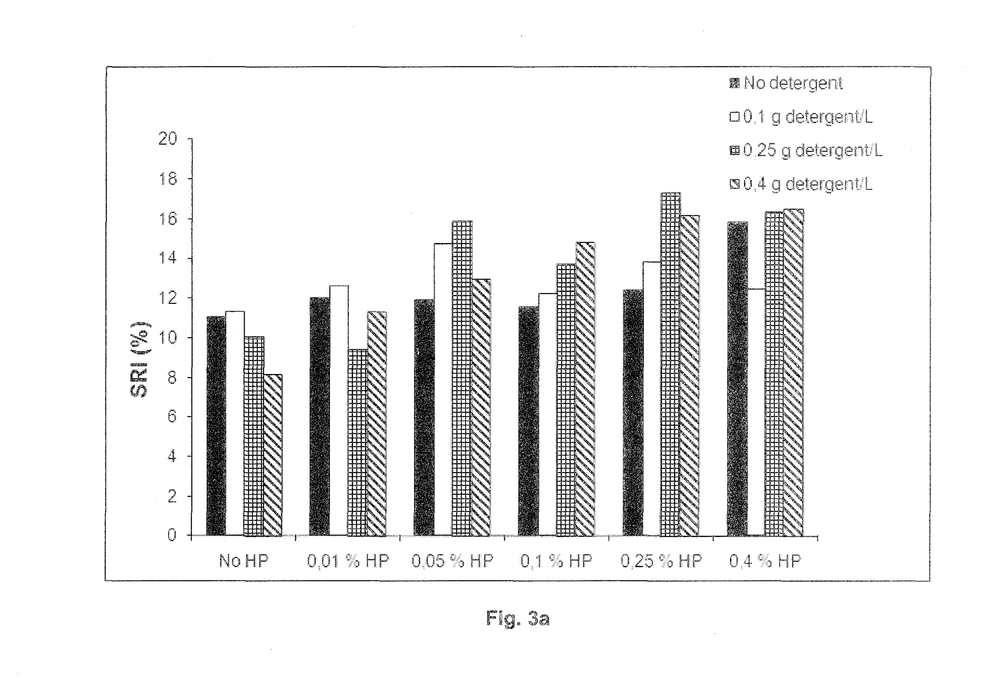

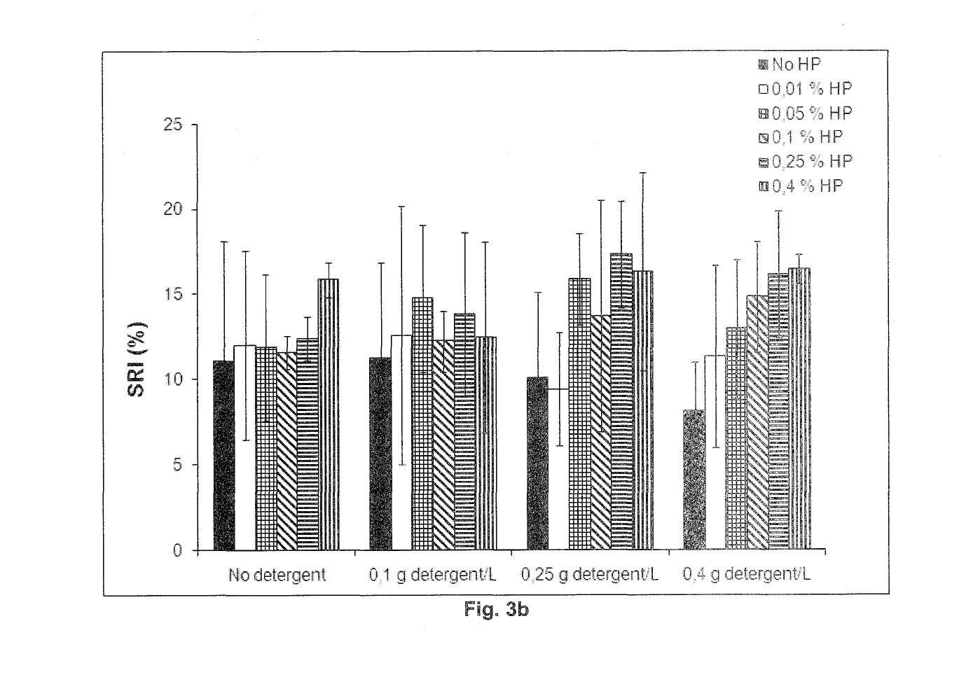

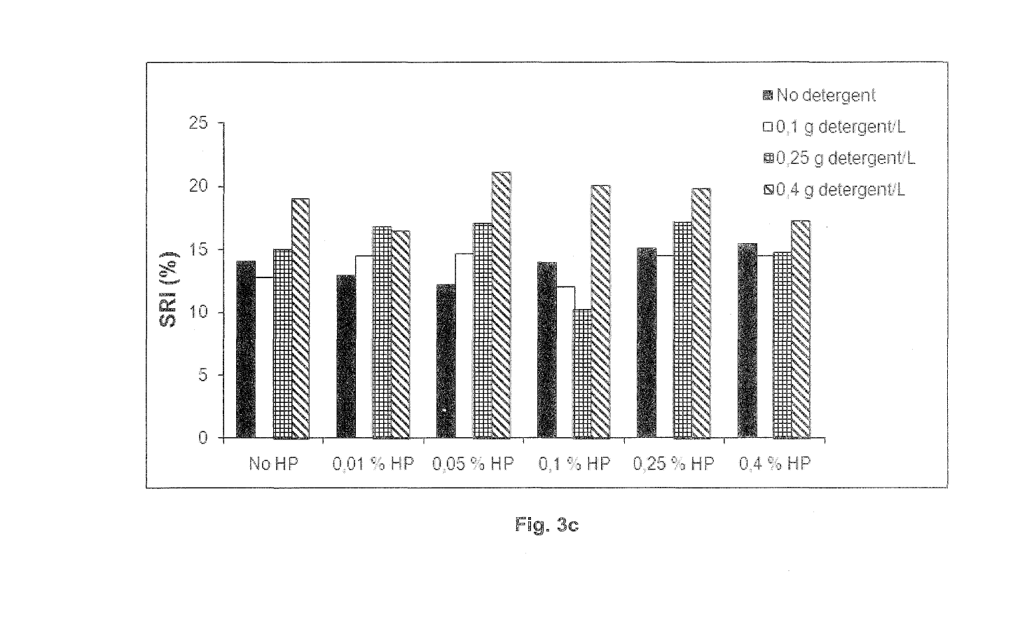

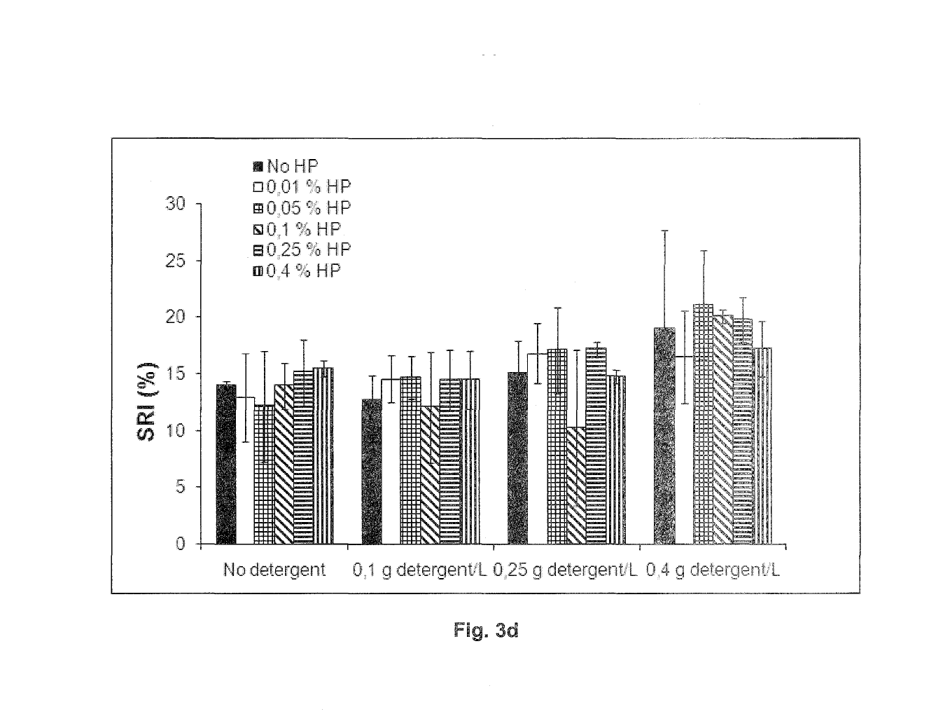

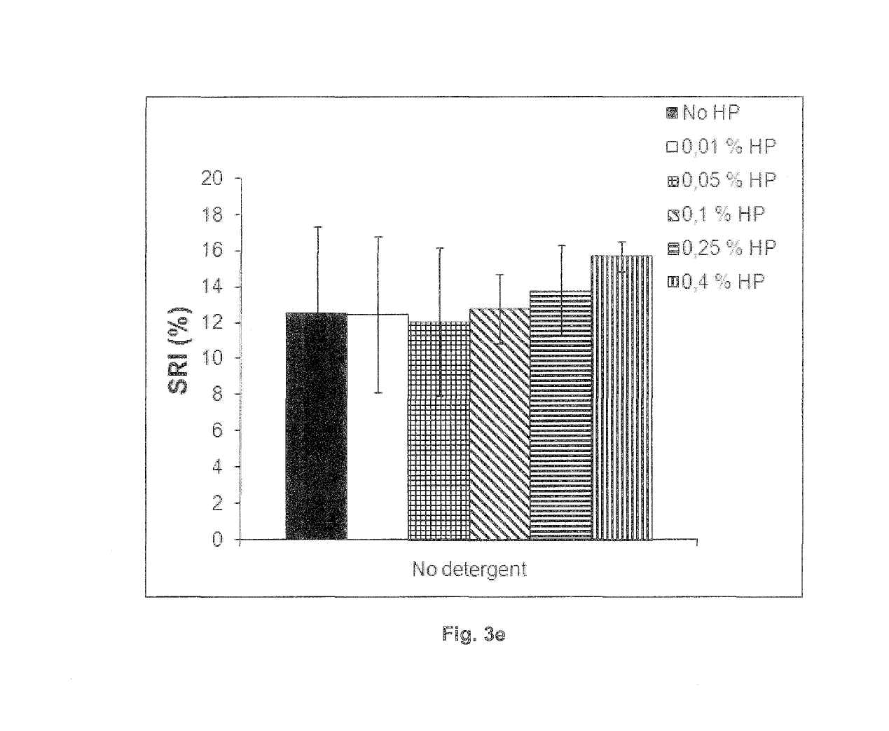

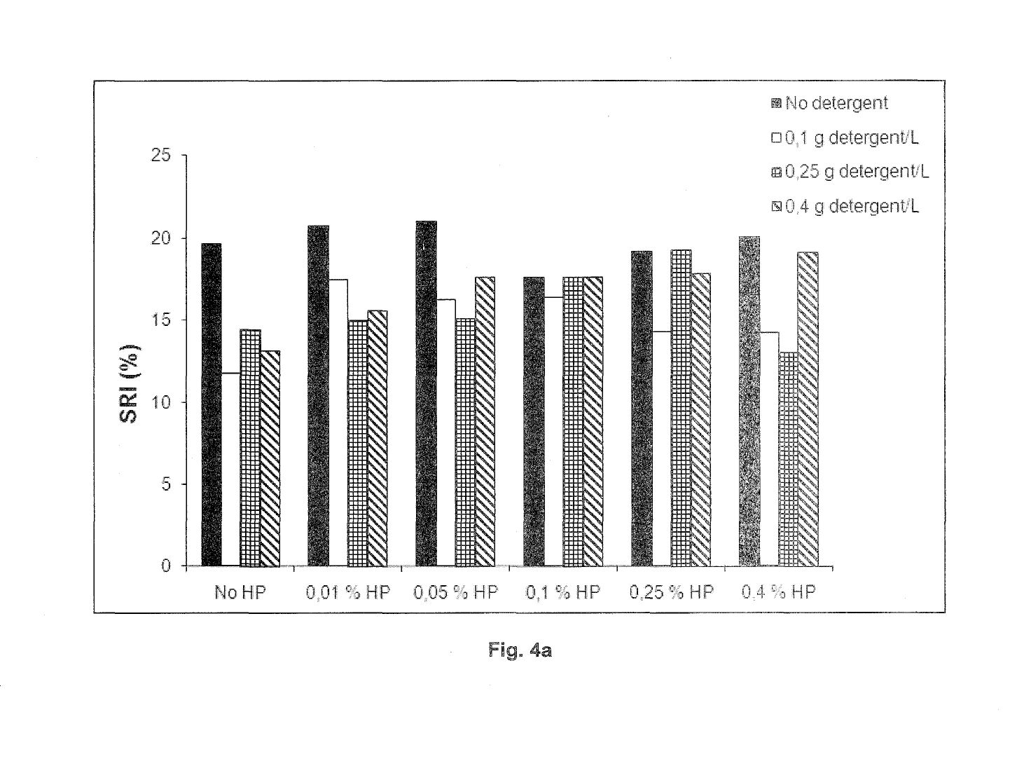

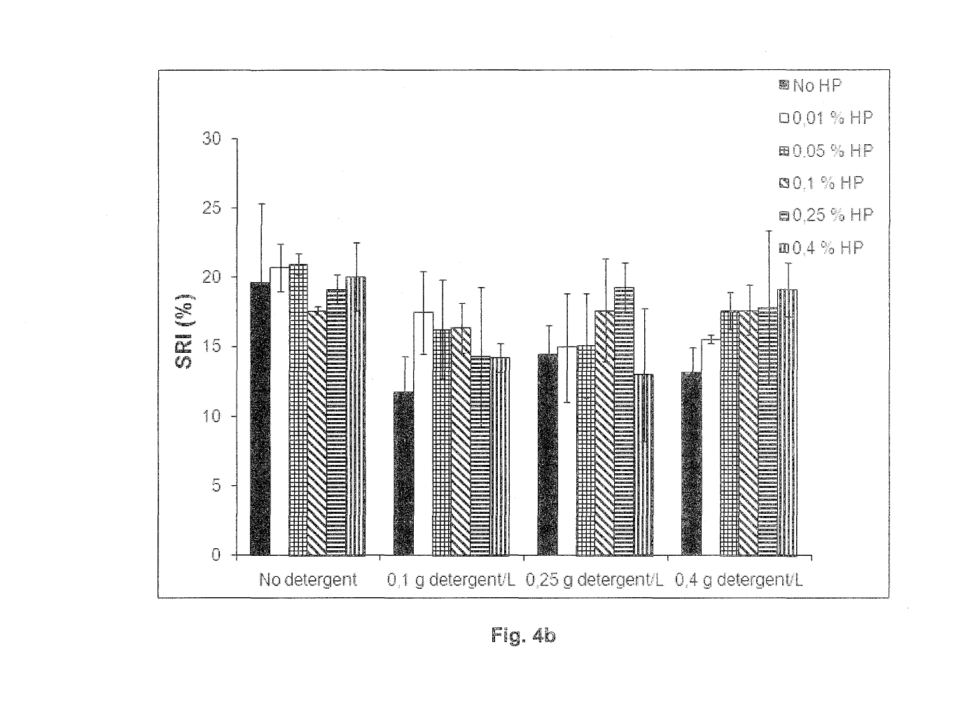

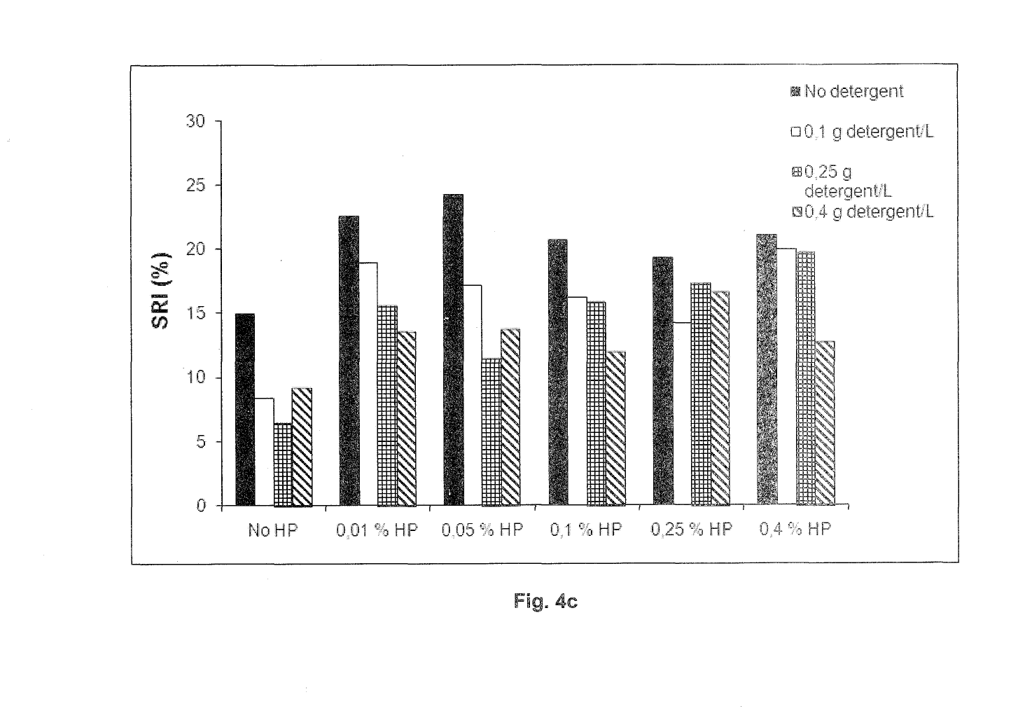

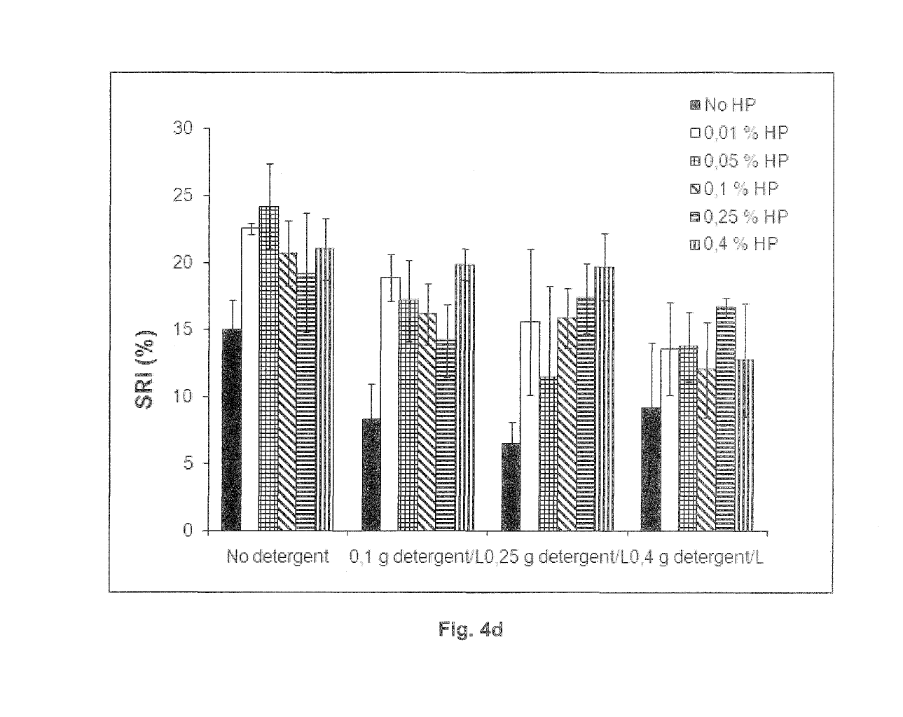

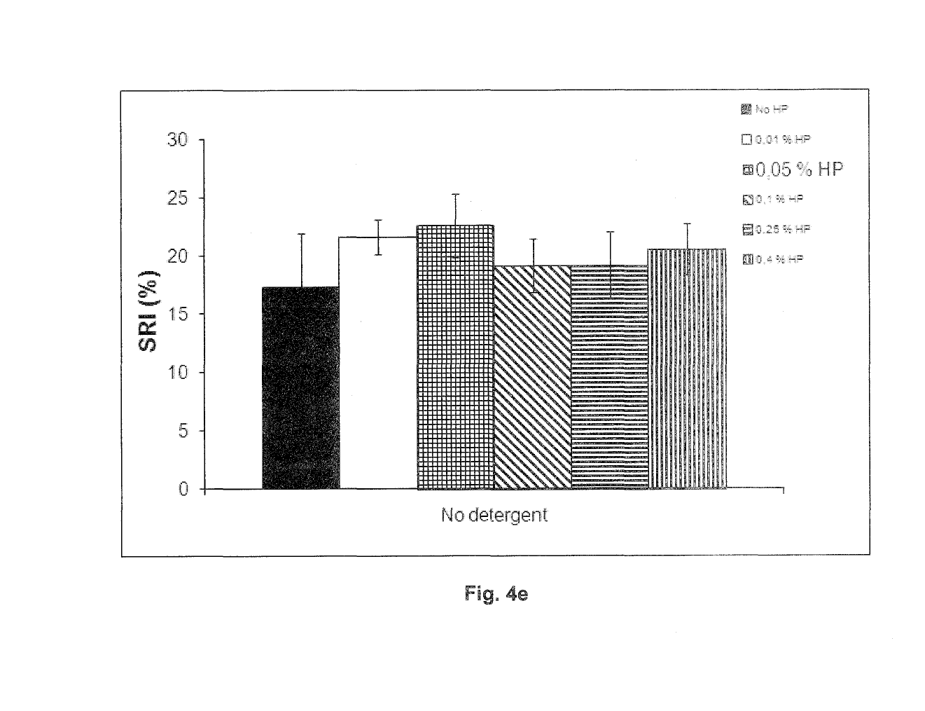

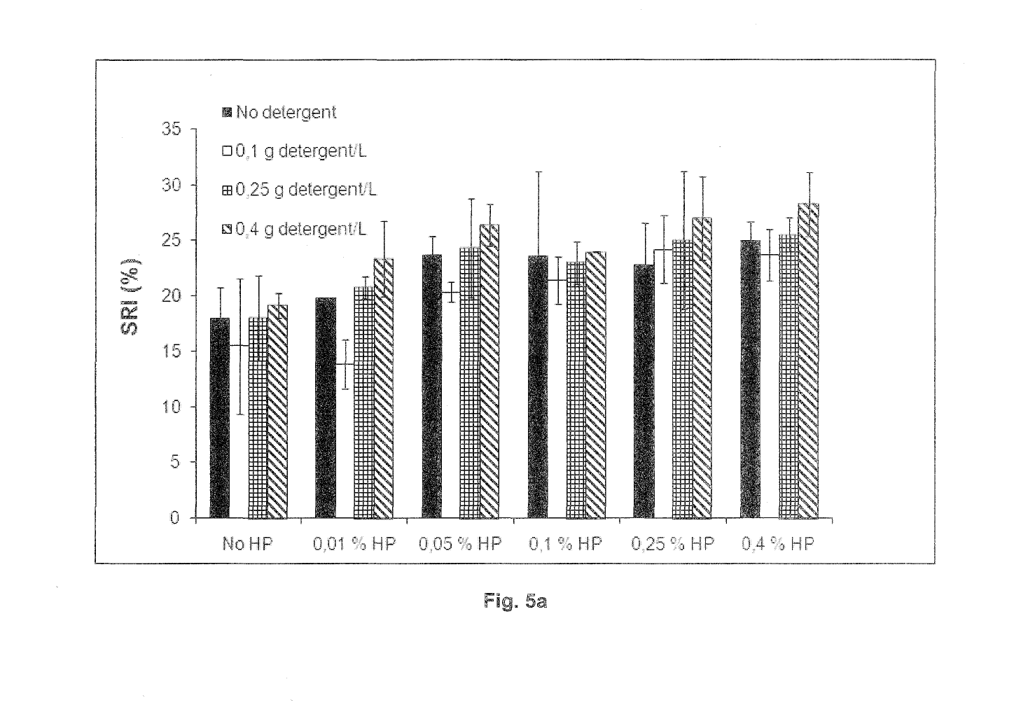

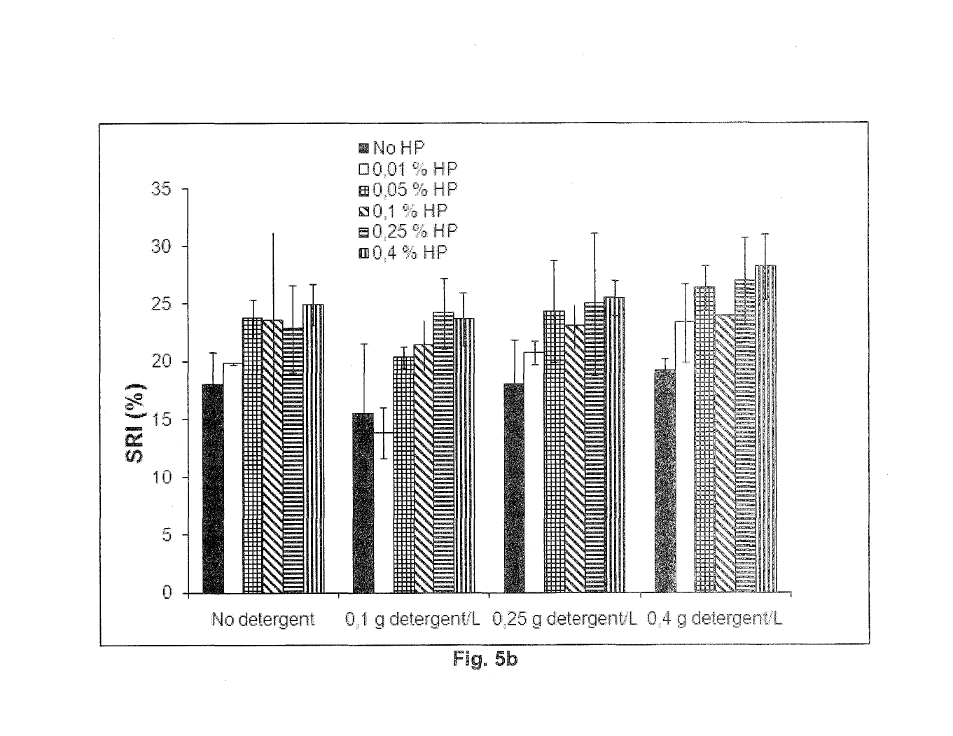

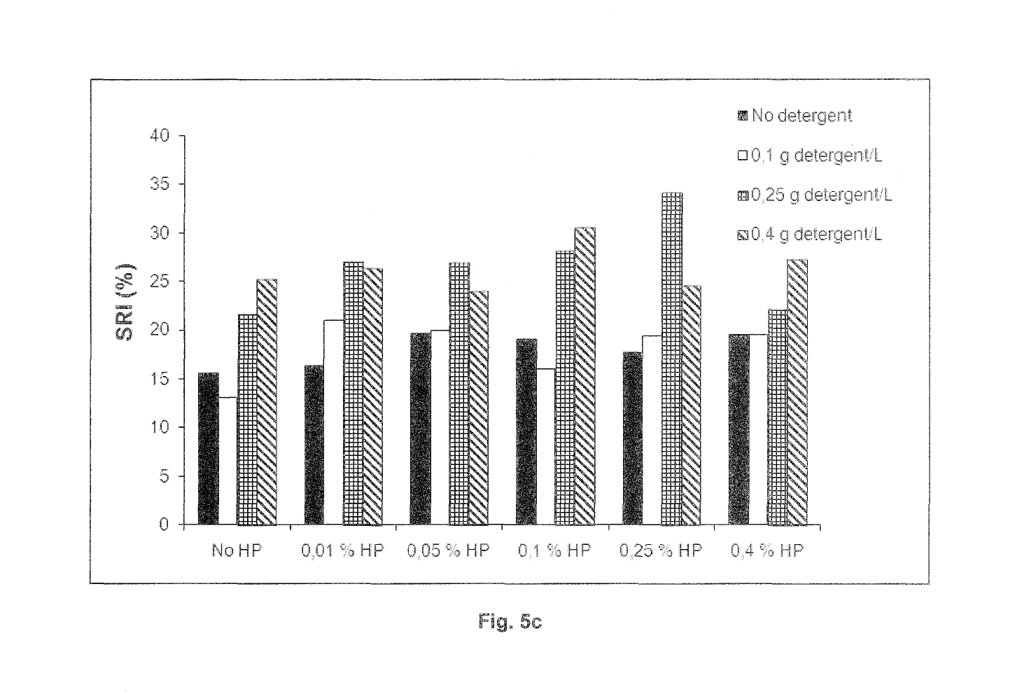

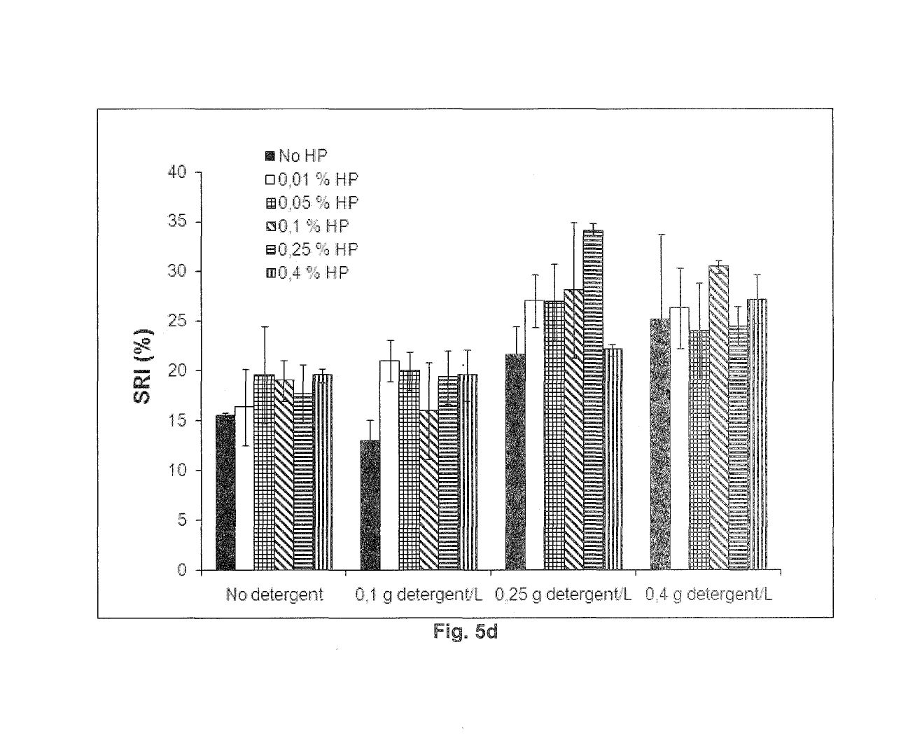

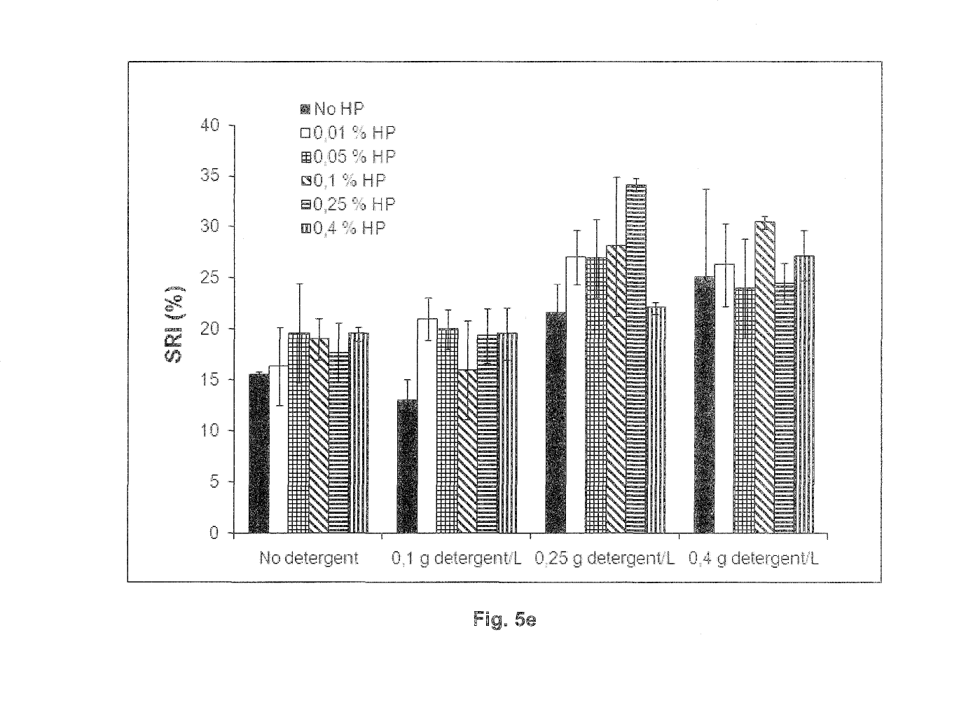

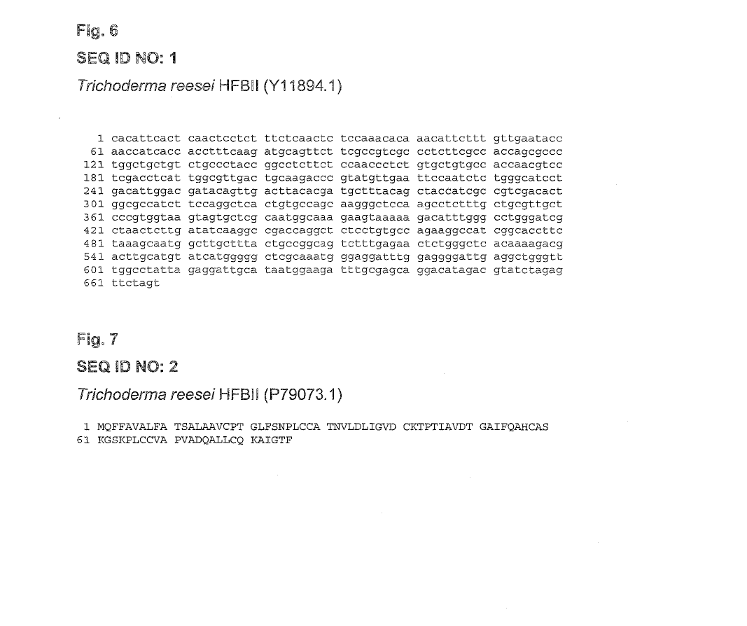

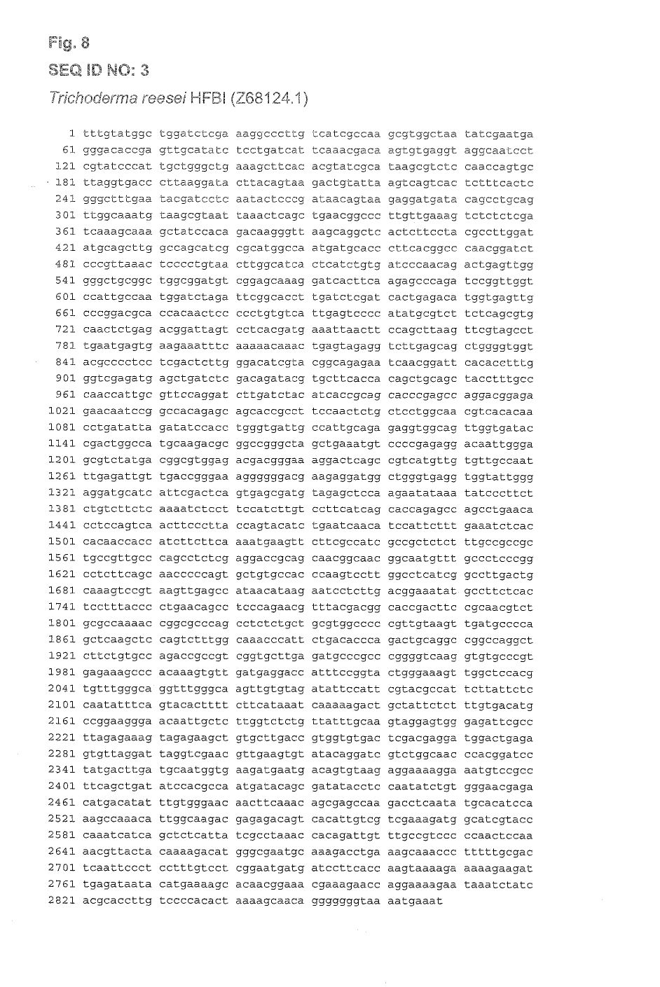

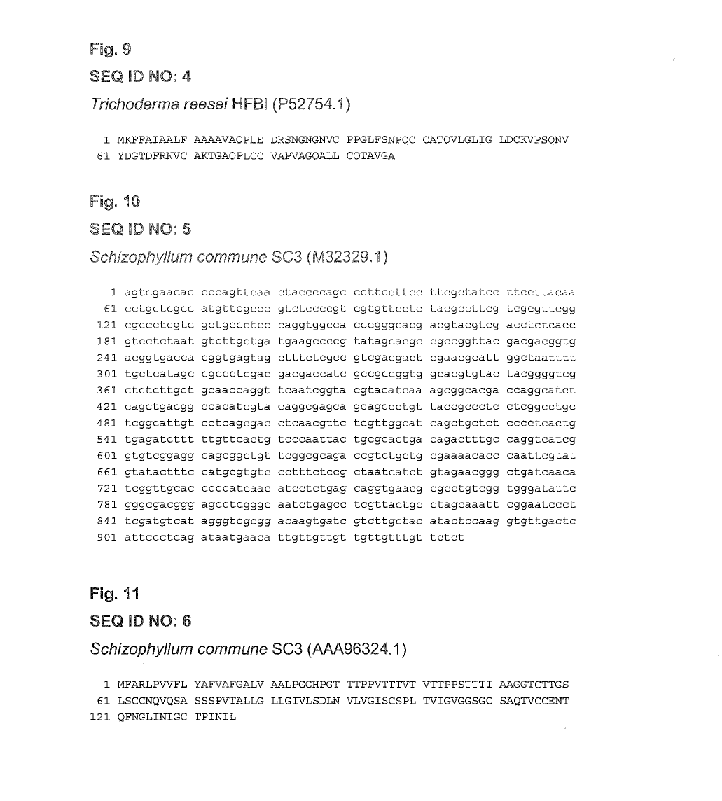

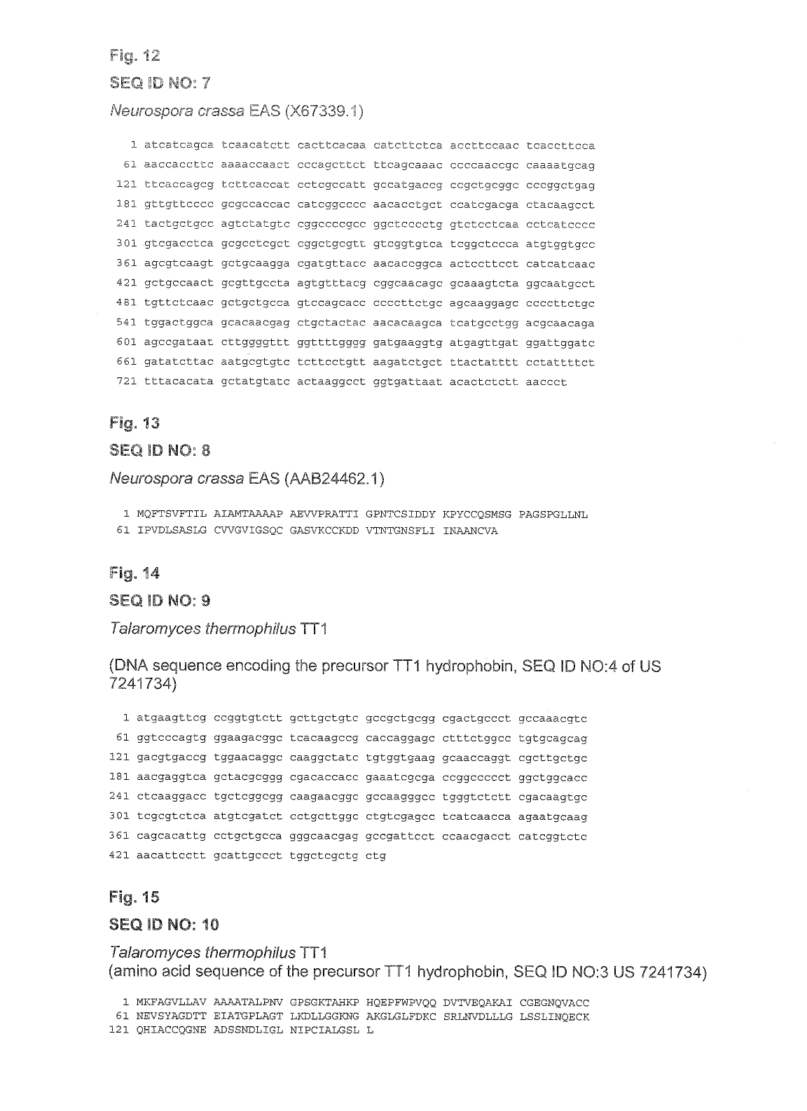

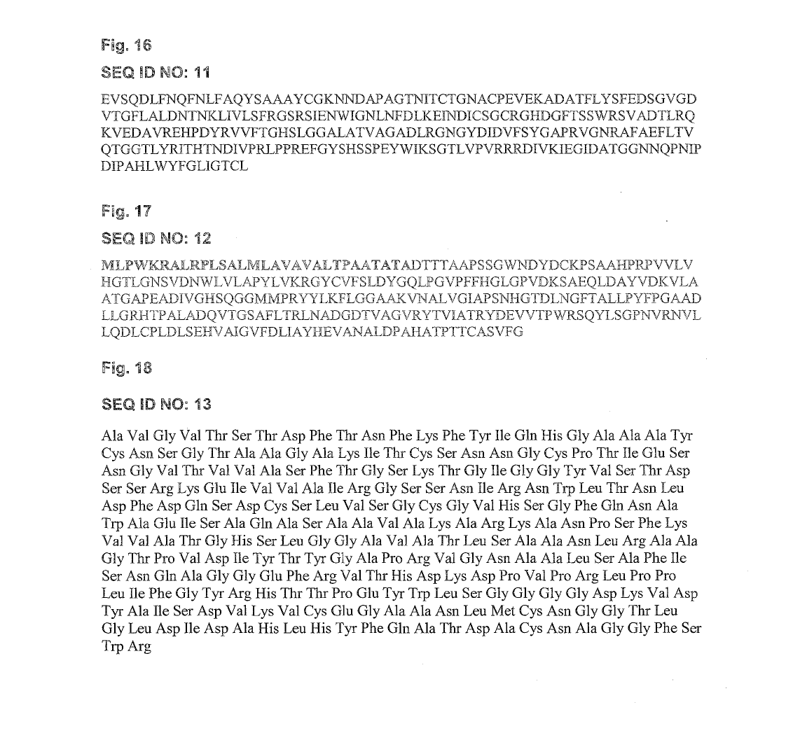

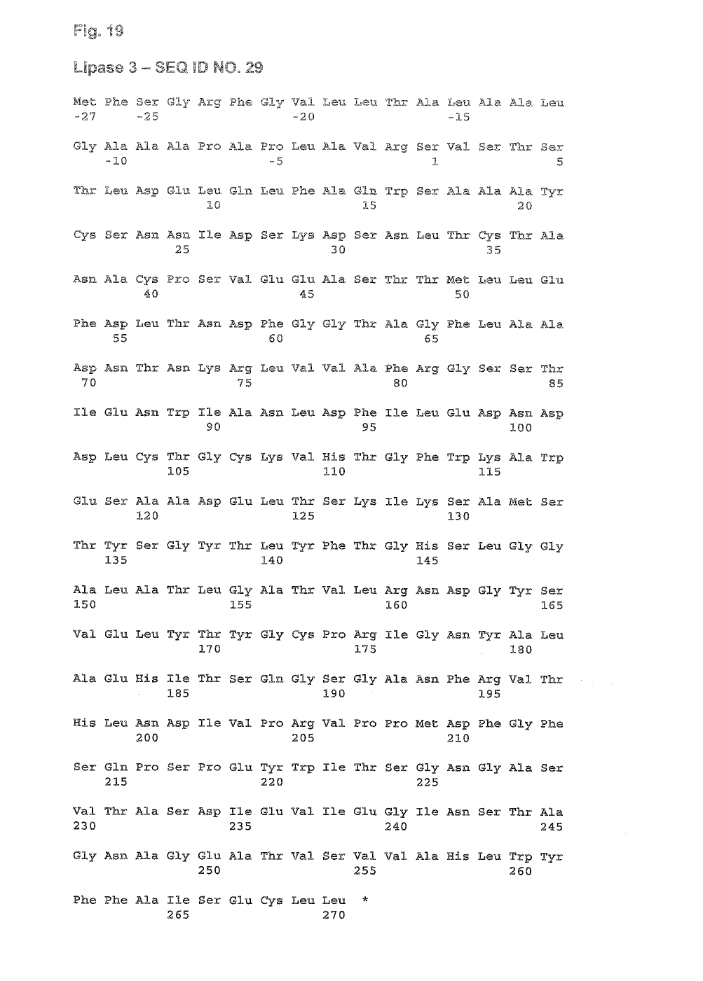

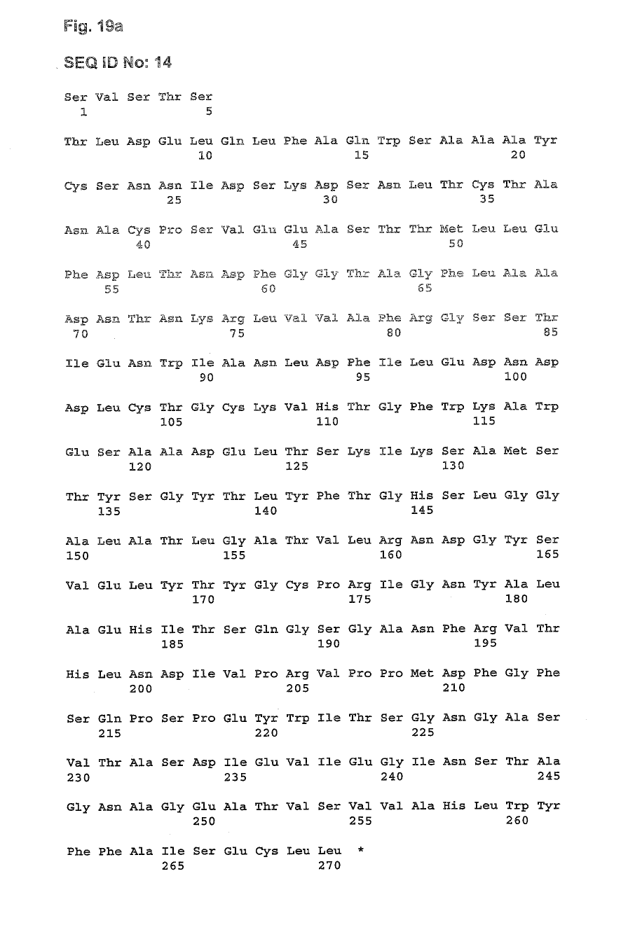

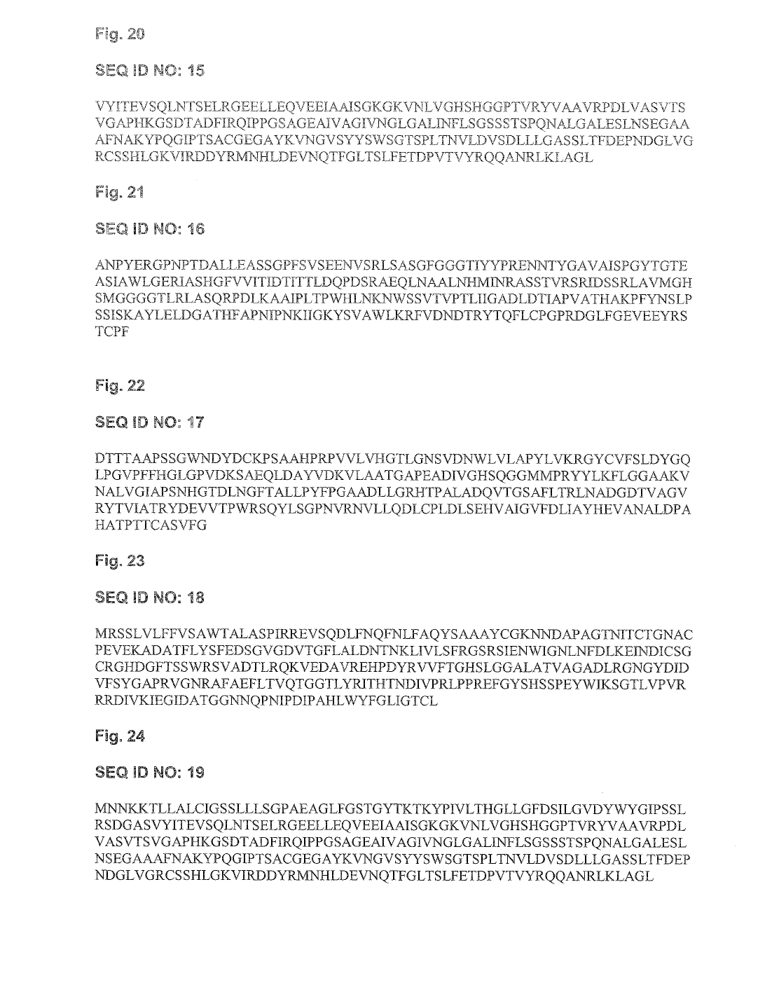

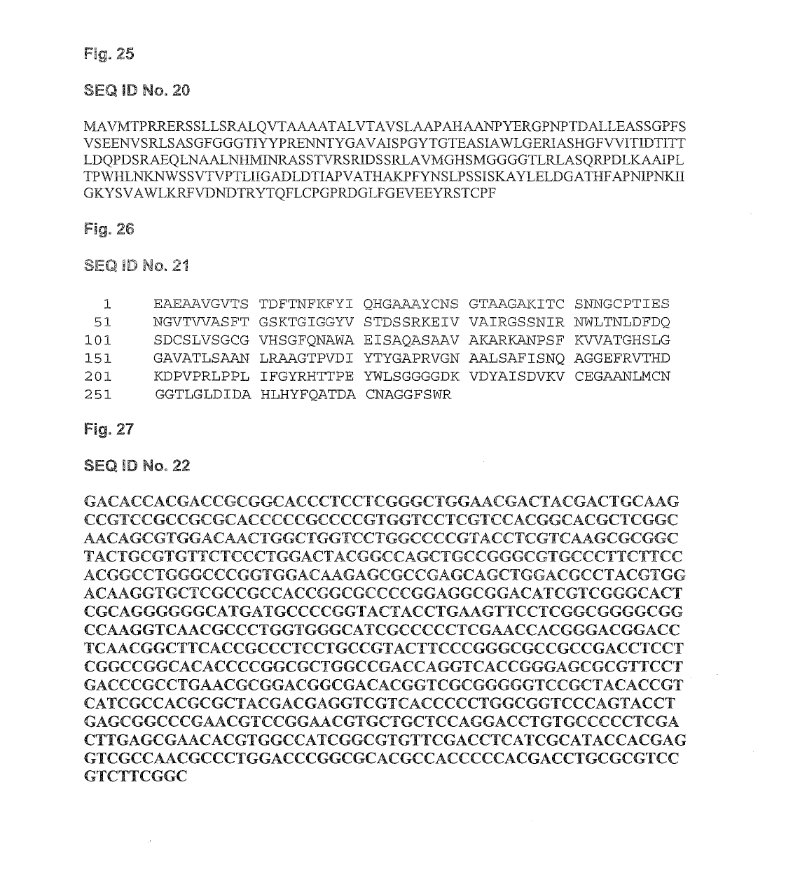

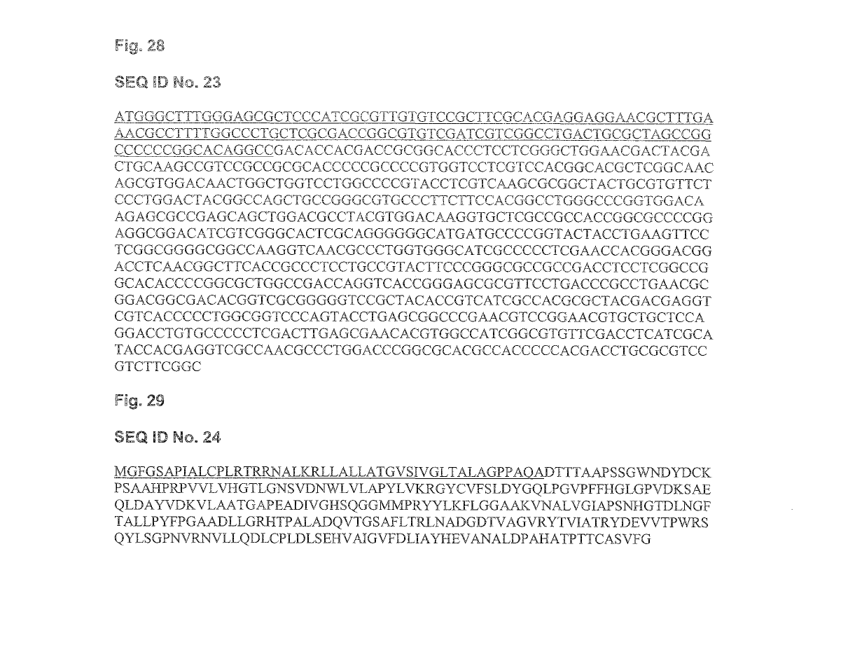

FIGS. 1a through 1c: no lipolytic enzyme (control)
FIGS. 2a through 2e: the lipolytic enzyme LIPEX™ (abH23.1)
FIGS. 3a through 3e: the lipolytic enzyme LIPOMAX™ (abH15.2)
FIGS. 4a through 4e: the lipolytic enzyme SprLip2 (abH16)
FIGS. 5a through 5e: the lipolytic enzyme TfuLip2 (abH25.1)

In particular, FIGS. 2e, 4e and 5e illustrate the effects of hydrophobin on the presence of lipases in the system in the absence of a detergent. These Figures show that, for these lipases at least, a synergistic effect superior to the additive effect of each component when used individually can be observed.

In addition, FIG. 2b illustrates that, when a combination of hydrophobin, the lipase LIPEX® and the detergent ARIEL® Color Liquid is used, as the concentration of the detergent increases, the system reaches a performance plateau at lower concentrations of hydrophobin (0.05% instead of 0.4%) compared with when no detergent is used. Furthermore, FIG. 5b shows that, using a combination of hydrophobin, the lipase TfuLip2 and the detergent ARIEL® Color Liquid, by increasing the concentration of detergent and the concentration of hydrophobin, an improved washing effect can be achieved (in particular with 0.4 g/L detergent and 0.4% hydrophobin).

In addition, FIG. 2d illustrates that, when a combination of hydrophobin, the lipase LIPEX® and the detergent ARIEL® Color Powder is used, the performance pattern is not affected by lower levels of detergent (the system reaches plateau at 0.05% hydrophobin). However, at higher concentrations of the detergent, the higher SRI value can be reached (30% at 0.4 g/L detergent). Furthermore, FIG. 5d illustrates that, when a combination of hydrophobin, the lipase TfuLip2 and the detergent ARIEL® Color Powder is used, the overall performance of the system improves with increase of the concentration of detergent in the system.

Finally, FIG. 1b shows that, when a combination of hydrophobin and the detergent ARIEL® Color Liquid is used in the absence of lipases, there is a small synergistic effect at low concentrations of hydrophobin (0.01-0.1%) and detergent (below 0.25 g/L).

### Example 2

### Cloning and Expression of Streptomyces pristinaespiralis ATCC 2548 Lipase (SprLip2)

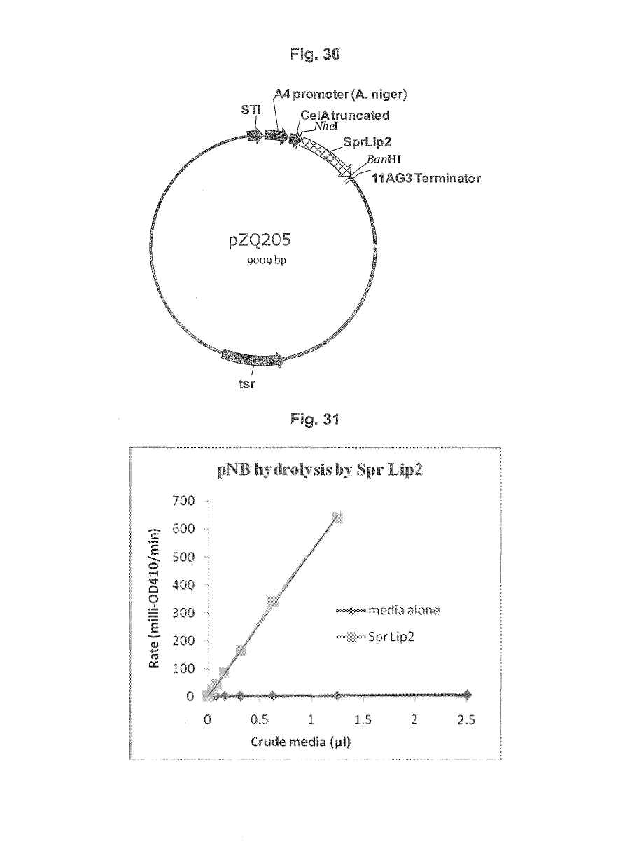

The SprLip2 gene was synthesized by GeneRay (Shanghai, China). The SprLip2 synthetic gene was cloned into expression plasmid pKB128 by NheI/BamHI double digestion and ligation. Plasmid pKB128 is a derivative of plasmid pKB105 (described in U.S. Patent Application Publication No. 2006/0154843) and is the source of the A4 promoter-CelA signal sequence. Plasmid pKB128 contains the Nsil-Mlul-Hpal restriction sites (atgcatacgcgtgttaac; SEQ ID No 30) before the BamHI site. The A. niger A4 promoter and the CelA truncated signal sequences were at the 5′ end of the SprLip2 gene sequence (corresponding to the predicted mature protein), and the 11AG3 terminator sequence was fused to the 3′ end of the SprLip2 gene sequence. The pZQ205 expression vector (FIG. 30) was constructed by ligation of pKB128 after digestion with the restriction enzymes NheI and BamHI, to a similarly digested SprLip2 synthetic gene, followed by transformation of E. coli cells. The correct sequence of SprLip2 gene was confirmed by DNA sequencing.

Plasmid DNA of pZQ205 was transformed into host Streptomyes lividans TK23 protoplast cells (described in U.S. Patent Application Publication No. 2006/0154843). Three transformants were picked and transferred into a seed shake flask (15 ml of TSG medium containing 50 ug/ml of thiostrepton in dimethyl sufoxide), grown for 2 days at 30° C. with shaking at 200 rpm. 3 ml of the two-day culture from seed shake flask were transferred to 30 ml of Streptomyces modified production medium II for protein production. The production cultures were grown for 2 days at 30° C. with shaking at 200 rpm. The protein was secreted into the extracellular medium and filtered culture medium was used to perform the cleaning assay and for biochemical characterization experiments. The dosing was based on total protein determined by a Bradford type assay using the Biorad protein assay (500-0006EDU) and corrected for purity determined by SDS-PAGE using a Criterion stain free system from Bio-Rad.

### Example 3

### Biochemical Characterization of SprLip2

The lipase/esterase activity of SprLip2 was tested using para-nitrophenyl butyrate ester (pNB) and para-nitrophenyl palmitate (pNPP) as substrates. A 20 mM stock solution of each substrate (p-nitrophenyl butyrate, pNB, Sigma, CAS 2635-84-9, catalog number N9876) dissolved in dimethyl sulfoxide (Pierce, 20688, Water content <0.2%) and p-nitrophenyl palmitate, pNPP; Sigma, CAS1492-30-4, catalog number N2752 dissolved in dimethyl sulfoxide) was prepared and stored at −80° C. for long term storage. Filtered culture supernatant from SprLip2 expressing cells was serially diluted in assay buffer [50 mM HEPES pH 8.2, containing 0.75 mM CaCl₂ and 0.25 mM MgCl₂) containing 2% Polyvinyl Alcohol (PVA) (Sigma)] in 96-well microtiter plates and equilibrated at 25° C. 100 μl of 1:20 diluted substrate (in assay buffer) was added to another microtiter plate. The plate was equilibrated to 25° C. for 10 minutes with shaking at 300 rpm. 10 μl of enzyme solution from dilution plate was added to the substrate containing plate to initiate reaction. The plate was immediately transferred to a spectrophotometer capable of kinetic measurements equilibrated at 25° C. The absorbance change in kinetic mode was read for 5 minutes at 410 nm. The background rate (with no enzyme) was subtracted from the rate of the test samples.

Sample concentration was determined as:

Sample concentration=(unknown Rate×standard concentration)/standard rate

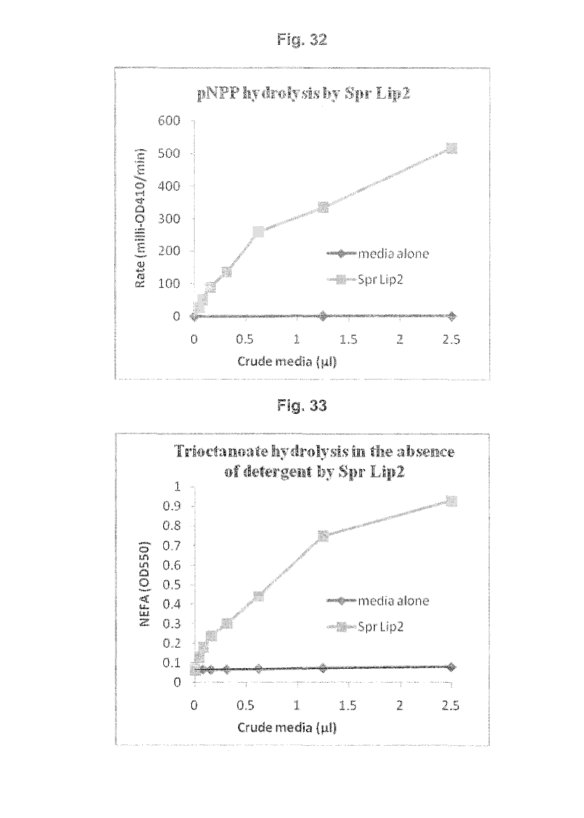

Results are shown in FIG. 32 (pNB hydrolysis) and 33 (pNPP hydrolysis). (relative rates of hydrolysis.).]

### Example 4

### Triglyceride Hydrolysis by SprLip2

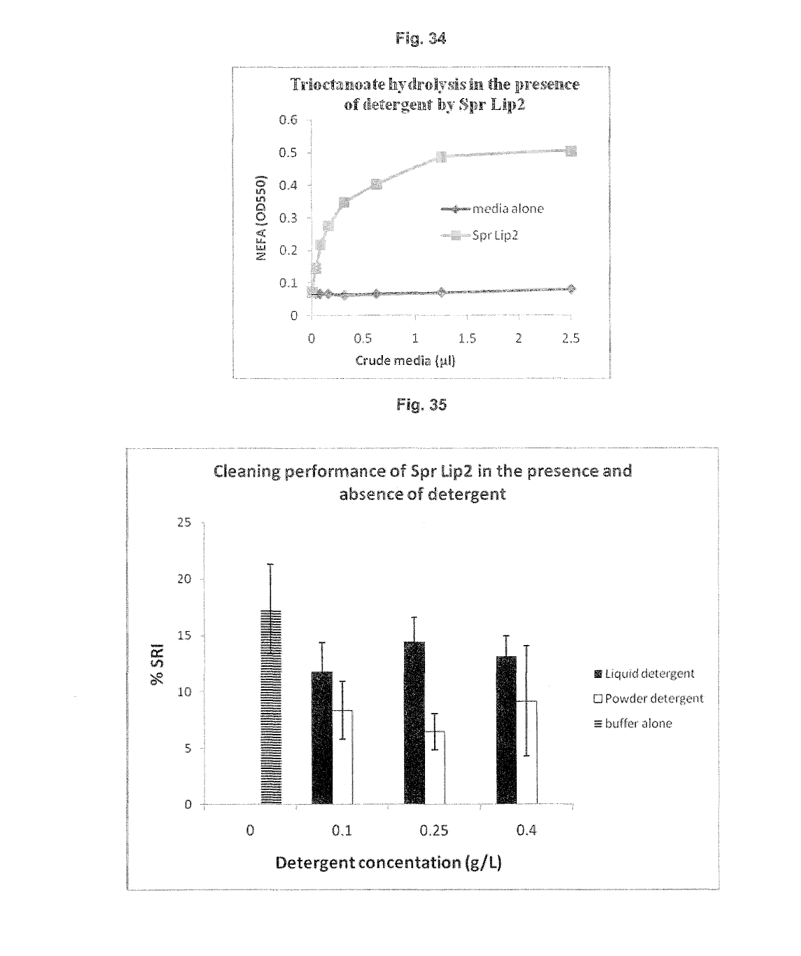

This assay was designed to measure release of fatty acids from triglyceride substrate by lipases. The assay consists of a hydrolysis reaction where incubation of lipase with a triglyceride emulsion results in liberation of fatty acids and thus a reduction in the turbidity of the emulsified substrate. The triglyceride substrate used for the assay was glyceryl trioctanoate (Sigma, CAS 538-23-8, catalog number T9126-100 mL). Emulsified trioctanoate (0.75% (v/v or w/v)) was prepared by mixing 50 ml of the gum arabic (Sigma, CAS 9000-01-5, catalog number G9752; 10 mg/ml gum arabic solution made in 50 mM HEPES pH8.2) or detergent solution (0.1% heat inactivated Tide Cold Water detergent, Procter & Gamble, Cincinnati, Ohio, USA, (containing 0.75 mM CaCl₂ and 0.25 mM MgCl₂) in 50 mM HEPES pH8.2) with 375 μl of triglyceride. The solutions were mixed and sonicated for at least 2 minutes to prepare a stable emulsion. 200 μl of emulsified substrate was added to a 96-well microtiter plate. 20 μl of serially diluted enzyme sample (filtered culture supernatant from cells expressing SprLip2) were added to the substrate containing plate. The plate was covered with a plate sealer and incubated at 20° C. for 20 minutes. After incubation, the presence of fatty acids in solution was detected as increase in absorbance at 550 nm using the HR Series NEFA-HR (2) NEFA kit (Wako Chemicals GmbH, Germany) as indicated by the manufacturer. Results are shown in FIG. 34 (no detergent) and 35 (with detergent).

### Example 5

### Cleaning Performance of SprLip2

The cleaning performance of SprLip2 was tested in the presence and absence of commercially available heat inactivated detergents. Stock solution of lipase was prepared by diluting 258 μl of the enzyme into 1 ml by distilled water. The detergents used were heat inactivated liquid detergent (ARIEL™ color liquid) and heat inactivated powder detergent (ARIEL™ color powder) from Procter & Gamble, Cincinnati, Ohio, USA.

Stain removal experiments were carried out using a lipid-containing technical stain (CS-61 swatches: cotton, beef fat with colorant, purchased from Center for Testmaterials, Netherlands) in a 24-well plate format (Nunc, Denmark). Each assay well was set to contain a pre-cut 13 mm piece of CS-61 swatch. Swatches were pre-read using a scanner (MiCrotek Scan Maker 900) and placed in the 24-well plate. The buffers used were 20 mM HEPES pH 8.2 for liquid detergent and 20 mM CAPS pH 10.0 for powder detergent. Water hardness was adjusted to 24 degrees French using 15000 ppm 2/1 Ca²⁺/Mg²⁺ diluted to 2400 ppm for both buffers. The detergents were tested at a concentration of zero; 0.1 g/L; 0.25 g/L; and 0.4 g/L. 1 ml of the appropriate buffer described above was added to each swatch-containing well of the 24-well plate. To initiate the reaction, enzyme samples were added at a volume of 100 μL into each well. The plates were shaken for 30 minutes at 200 rpm at 37° C. After incubation, the reaction buffer was removed and the fabric in each well was rinsed three times with 1 mL distilled water. The rinsed swatches were dried at 50° C. for 4 hours and their reflectance was measured. Cleaning performance was quantified after a single wash cycle. Stain removal was calculated as the difference of the post- and pre-cleaning RGB measurements for each swatch. RGB measurements were taken with a scanner (MiCrotek Scan Maker 900). Stain Removal Index values (SRI) of the washed fabric were calculated in relation to the unwashed fabrics using the formula:

$$\% Soil {Removal}_{( RGB )} = ( Soil removal Δ {E}_{( RGB )} / Initial soil Δ {E}_{( RGB )} ) \times 100 \%$$

$$Where \text{:}$$

$$Soil removal Δ {E}_{( RGB )} = \sqrt{( {( {R}_{after} - {R}_{before} )}^{2} + {( {G}_{after} - {G}_{before} )}^{2} + {( {B}_{after} - {B}_{before} )}^{2} )}$$

$$And \text{:}$$

$$Initial soil Δ {E}_{( RGB )} = \sqrt{( {( {R}_{ref} - {R}_{before} )}^{2} + {( {G}_{ref} - {G}_{before} )}^{2} + {( {B}_{ref} - {B}_{before} )}^{2} )}$$

RGB_{ref} values are the values of the unsoiled cotton (white).
Results are shown in FIG. 36.

All publications mentioned in the above specification are herein incorporated by reference. Various modifications and variations of the described methods and system of the present invention will be apparent to those skilled in the art without departing from the scope and spirit of the present invention. Although the present invention has been described in connection with specific preferred embodiments, it should be understood that the invention as claimed should not be unduly limited to such specific embodiments. Indeed, various modifications of the described modes for carrying out the invention which are obvious to those skilled in chemistry, biochemistry and biotechnology or related fields are intended to be within the scope of the following claims.

1. A composition comprising:
(a) a lipolytic enzyme; and
(b) a hydrophobin having the general formula (I):
(Y₁)ₙ-B₁-(X₁)ₐ-B₂-(X₂)_{b}-B₃-(X₃)_{c}-B₄-(X₄)_{d}-B₅-(X₅)ₑ-B₆-(X₆)_{f}-B₇-(X₇)_{g}-B₈-(Y₂)ₘ (I)
wherein:
m and n are independently 0 to 2000;
B₁, B₂, B₃, B₄, B₅, B₆, B₇ and B₈ are each independently amino acids selected from Cys, Leu, Ala, Pro, Ser, Thr, Met or Gly, at least 6 of the residues B₁ through B₈ being Cys;
X₁, X₂, X₃, X₄, X₅, X₆, X₇, Y₁ and Y₂ independently represent any amino acid;
a is 1 to 50;
b is 0 to 5;
c is 1 to 100;
d is 1 to 100;
e is 1 to 50;
f is 0 to 5; and
g is 1 to 100.

2. A composition according to claim 1, wherein the lipolytic enzyme has triacylglycerol hydrolysing activity (E.C. 3.1.1.3).

3. A composition according to claim 1, wherein the lipolytic enzyme is a GX lipolytic enzyme, wherein G is glycine and X is an oxyanion hole-forming amino acid residue, wherein the GX lipolytic enzyme belongs to an alpha/beta hydrolase superfamily selected from the group consisting of abH23, abH25, and abH15.

4. A detergent composition comprising the composition of claim 1.

5-6. (canceled)

7. A composition according to claim 3, wherein the GX lipolytic enzyme belongs to an alpha/beta hydrolase superfamily selected from the group consisting of abH23.01, abH 25.01, abH16.01 and abH15.02.

8. A composition according to claim 3, wherein the oxyanion hole forming residue X is selected from the group consisting of M, Q, F, S, T, A, L and I.

9. (canceled)

10. A composition according to claim 3, wherein the GX lipolytic enzyme is obtained or obtainable from a filamentous fungus.

11-13. (canceled)

14. A composition according to claim 3, wherein the lipolytic enzyme is present in a concentration of 0.001 to 20 ppm by weight of the total weight of the composition.

15-21. (canceled)

22. A composition according to claim 1, wherein the hydrophobin is obtained or obtainable from a fungus of genus selected from the group consisting of Cladosporium, Ophistoma, Cryphonectria, Trichoderma, Gibberella, Neurospora, Maganaporthe, Hypocrea, Xanthoria, Emericella, Aspergillus, Paracoccioides, Metarhizium, Pleurotus, Coprinus, Dicotyonema, Flammulina, Schizophyllum, Agaricus, Pisolithus, Tricholoma, Pholioka, Talaromyces and Agrocybe.

23-25. (canceled)

26. A composition according to claim 1, wherein the hydrophobin is a Class II hydrophobin.

27-30. (canceled)

31. A composition according to claim 1, wherein the hydrophobin is present in a concentration of 0.001% to 5% by weight of the total weight of the composition.

32. (canceled)

33. A composition according to claim 4, wherein the detergent is present in a concentration of between 0.001 and 5 g/L.

34. (canceled)

35. A composition according to claim 4, additionally containing one or more enzymes selected from the group consisting of a protease, an amylase, a glucoamylase, a maltogenic amylase, a non-maltogenic amylase, a lipase, a cutinase, a carbohydrase, a cellulase, a pectinase, a mannanase, an arabinase, a galactanase, a xylanase, an oxidase, a laccase, and a peroxidase.

36. A composition according to claim 4, wherein the detergent comprises one or more surfactants.

37. A composition according to claim 36, wherein the surfactants are selected from the group consisting of non-ionic (including semi-polar), anionic, cationic and zwitterionic.

38. A composition according to claim 4, in powder form.

39. A composition according to claim 4, in liquid form.

40. A method of removing a lipid-based stain from a surface by contacting the surface with a composition according to claim 4.

41. The use of composition according to claim 4 to reduce or remove lipid stains from a surface.

42-45. (canceled)
